(19) United States
(12) Patent Application Publication
(10) Pub. No.: US 2014/0201004 A1
(43) Pub. Date: Jul. 17, 2014

(54) Managing Interactive In-Vehicle Advertisements

(71) Applicant: TOYOTA JIDOSHA KABUSHIKI KAISHA, Toyota-shi (JP)

(72) Inventors: Rahul Parundekar, Sunnyvale, CA (US); Kentaro Oguchi, Menlo Park, CA (US); Hideaki Imaizumi, Mountain View, CA (US); Trinell Ball, New York, NY (US)

(73) Assignee: TOYOTA JIDOSHA KABUSHIKI KAISHA, Toyota-shi (JP)

(21) Appl. No.: 14/091,253

(22) Filed: Nov. 26, 2013

Related U.S. Application Data
(60) Provisional application No. 61/752,354, filed on Jan. 14, 2013.

(51) Int. Cl. G06Q 30/02

(52) U.S. Cl. CPC G06Q 30/0265
USPC 705/14.62

(57) ABSTRACT

The disclosure includes technology for managing interactive advertisements for users. The technology includes an example system including a processor and a memory storing instructions that when executed cause the system to: determine user data associated with a user; determine contextual data associated with the user; determine an interactive advertisement for presentation to the user in a vehicle based on the user data and the contextual data; and present the interactive advertisement to the user in the vehicle.

### CROSS REFERENCE TO RELATED APPLICATIONS

This application claims priority under 35 USC §119(e) to U.S. Application No. 61/752,354, entitled “System and Method for Providing Advertisements for a Transportation Device” and filed Jan. 14, 2013, the entirety of which is herein incorporated by reference.

### BACKGROUND

The specification relates to providing advertisements, and more particularly, the specification relates to managing interactive in-vehicle advertisements.

An in-vehicle infotainment system may include various hardware and software systems that provide various services and functionality to a user in a vehicle. These systems may include a music system for playing music, a navigation system for finding and mapping various places of interest, a hands-free phone system for making and receive phone calls, etc.

More recently, with wireless connectivity to the Internet, some in-vehicle entertainment systems can provide access to Internet-based media content including streaming radio programs, music, television programs, etc. However, production and provision of this type of media content can be costly and content providers generally require content distributors and end users to pay subscription and license fees to access this type of content. As with FM and satellite radio programs, to offset the costs of the license fees and access fees, content distributors often include banner advertisements between various segments of the media content to display to the users. These types of advertisements are generally ignored or quickly forgotten by drivers of vehicles who are focused on their primary task of operating the vehicle.

Even if a driver is interested in a particular advertisement that is presented (audibly, as a banner ad on a screen of a head unit of the vehicle, both, etc.), existing systems generally lack convenient dedicated voice and/or touch-activated controls or buttons that allow users interact with advertisements presented to users in the vehicle. As a result, the driver is left to remember the details about the advertisement as it is generally impractical for a driver to take a hand off the steering wheel and note the details about the advertisement without risking his or her safety, and the user is unable to access and listen to the advertisement at a later time using these systems. In addition, these advertisements are less-effective as they are generally not targeted to the user or the user's physical context, and thus do not achieve the same effect as targeted ads.

Some vehicles include Bluetooth® connectivity and can couple to a user's handheld device (e.g., smartphone) and receive and playback a digital media stream from that device using the vehicle's in-dash entertainment system. The digital media stream can include ads that have been inserted by the content server at various points in the stream (e.g., between radio segments, songs, etc.). However, these ads are often less effective as they are generally catered to playback on the handheld device and are not aware of or targeted to the user's traveling environment, such as the context of the vehicle, where the vehicle is headed, who else is on board, etc.

### SUMMARY

According to one innovative aspect of the subject matter described in this disclosure, a system for managing interactive advertisements for users includes a processor and a memory storing instructions that, when executed, cause the system to determine user data associated with a user; determine contextual data associated with the user; determine an interactive advertisement for presentation to the user in a vehicle based on the user data and the contextual data; and present the interactive advertisement to the user in the vehicle.

In general, another innovative aspect of the subject matter described in this disclosure may be embodied in methods that include determining user data associated with a user; determining contextual data associated with the user; determining an interactive advertisement for presentation to the user in a vehicle based on the user data and the contextual data; and presenting the interactive advertisement to the user in the vehicle.

Other aspects include corresponding methods, systems, apparatus, and computer program products for these and other innovative aspects.

These and other implementations may each optionally include one or more of the following features. For instance, the operations include receiving a request requesting to bookmark the interactive advertisement; bookmarking the interactive advertisement for the user; receiving a request requesting to retrieve the bookmarked advertisement; retrieving the bookmarked advertisement for the user; receiving a request requesting to perform an action associated with the interactive advertisement; and performing the action responsive to receiving the request.

For instance, the features include the contextual data including trip data describing a trip taken by the user; identifying a place associated with the trip; identifying, based on the user data and the contextual data, the interactive advertisement associated with the place from an advertisement inventory; identifying advertisement textual data based on the user data and the contextual data; retrieving an advertisement synthesis template; creating the interactive advertisement based on the advertisement textual data and the advertisement synthesis template; identifying a place associated with the trip; identifying the advertisement textual data associated with the place based on the user data and the contextual data; the advertisement synthesis template including an audio advertisement synthesis template or a visual advertisement synthesis template; retrieving advertisement content from a content buffer; determining the interactive advertisement to be bookmarked from the advertisement content; generating advertisement identification data that identifies the interactive advertisement; associating the advertisement identification data with a user identifier identifying the user; retrieving the interactive advertisement to be bookmarked from an advertisement inventory using the ad identification data; bookmarking the interactive advertisement by associating an identifier of the interactive advertisement with the user identifier; receiving sensor data from one or more sensors; generating a timestamp based on the sensor data; determining a location associated with the user based on the sensor data; receiving tuner data from a radio tuner; determining a radio station based on the tuner data and the location; determining program data for the radio station, the program data describing a radio program matching the timestamp; identifying the interactive advertisement associated with the program data; associating the identified advertisement with a user identifier identifying the user; generating a bookmark that describes an association between the identified advertisement and the user identifier; generating an advertisement retrieval request; querying an advertisement inventory using the advertisement retrieval request; and retrieving the bookmarked advertisement that matches the advertisement retrieval request from the advertisement inventory.

The technology described in this disclosure is particularly advantageous in a number of respects. For example, the technology can provide in-vehicle ads to a user and enable the user to interact with the ads in a safe and convenient way. The technology can determine ads relevant to the user and the context of the user and/or the user's vehicle and present the ads to the user in the vehicle. The technology can bookmark ads upon request from the driver of the vehicle and allow the driver to access the bookmarked ads at a later time, which allows the driver to remain focused on operating the vehicle. For example, while the user is driving, he or she can bookmark an ad by pressing a steering wheel button and, at a later time, can access the ad using the infotainment system of the vehicle or a separate computing device (e.g., phone, tablet, laptop, etc.). The technology can retrieve ads bookmarked by the user based on the user's location and/or query data provided by the user. The technology can facilitate performance of actions associated with the ads using the in-vehicle or other computing device applications. It should be understood that the foregoing advantages are provided by way of example and the technology may have numerous other advantages and benefits.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for managing interactive in-vehicle advertisements.

FIG. 2 is a block diagram illustrating an example computing device.

FIGS. 3A-3C are block diagrams illustrating various interactions between an example advertisement determination module and other components of the example system.

FIGS. 4A and 4B are block diagrams illustrating various interactions between an example bookmark module and other components of the example system.

FIG. 5 is a block diagram illustrating various interactions between an example bookmark server module, an example bookmark retriever module and other components of the example system.

FIG. 6 is a block diagram illustrating various interactions between an example action module and other components of the example system.

FIG. 7 is a flowchart of an example method for delivering an interactive advertisement to a user in a vehicle.

FIG. 8 is a flowchart of an example method for interacting with an interactive advertisement.

FIG. 9 is a flowchart of an example method for determining an advertisement for a user.

FIG. 10 is a flowchart of an example method for determining an advertisement for a user.

FIG. 11 is a flowchart of an example method for bookmarking an advertisement for a user.

FIGS. 12A and 12B are flowcharts of an example method for bookmarking an advertisement for a user.

FIGS. 13A and 13B are flowcharts of an example method for accessing an advertisement bookmarked by a user.

FIG. 14 is a flowchart of an example method for facilitating performance of an action associated with an advertisement.

FIGS. 15A-15C are graphic representations illustrating various example user interfaces presented to users.

FIGS. 16A-16H, 17A-17H, 18A-18F, and 19A-19F are graphic representations depicting various example user interfaces illustrating various example use cases.

FIGS. 20A-20C are flowcharts of an example method for providing a targeted advertisement impression in a vehicle.

### DETAILED DESCRIPTION

### Overview

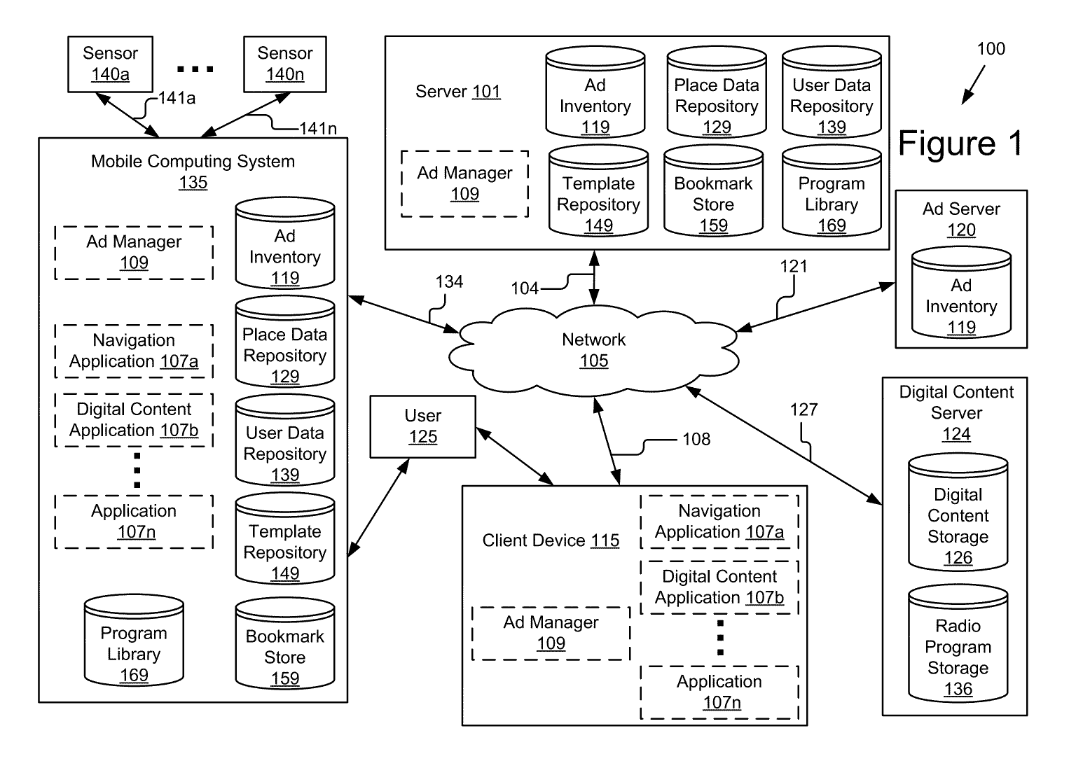

FIG. 1 is block diagram of an example system 100 for managing interactive in-vehicle advertisements according to some embodiments. The illustrated system 100 includes a server 101, a mobile computing system 135, a client device 115, an advertisement (ad) server 120, and a digital content server 124. The entities of the system 100 are communicatively coupled via a network 105. While FIG. 1 depicts the server 101, the ad server 120 and the digital content server 124 as monolithic entities, in further embodiments, various structure, acts, and/or functionality of these entities may be combined and/or integrated into the same computing device and/or system.

The network 105 can be a conventional type, wired or wireless, and may have numerous different configurations including a star configuration, token ring configuration, or other configurations. The network 105 may include one or more networks or network types. For instance, the network 105 may include one or more local area networks (LAN), wide area networks (WAN) (e.g., the Internet), public networks, private networks, virtual networks, telecommunication networks, near-field networks, peer-to-peer networks, and/or other interconnected data paths across which multiple devices may communicate. The network 105 may exchange data in a variety of different standard and/or proprietary communication protocols, such as HTTP, HTTPS, SSH, FTP, SFTP, WebSocket, SMS, MMS, WAP, VOIP, email protocols, direct data connection, WAP, various email protocols, etc.

The server 101, the ad server 120, and/or the digital content server 124 may include one or more hardware and/or virtual servers and/or storage devices. These servers 101, 120, and 124 are capable of processing, storing data, and sending and receiving data. These servers 101, 120, and 124 may include one or more processors, memories, and physical and/or virtual network communication devices. As depicted in FIG. 1, the server 101, the ad server 120, and the digital content server 124 may be respectively electronically communicatively coupled to the network 105 via signal lines 104, 121, and 127, for data communication and virtual interaction with one another and the other components of the system 100, such as the vehicle computing system 135 and the client device 115. It should be understood that more than one instance of the servers 101, 120, and/or 124, the vehicle computing system 135, and the client device 115, may be included in the system 100 in various embodiments.

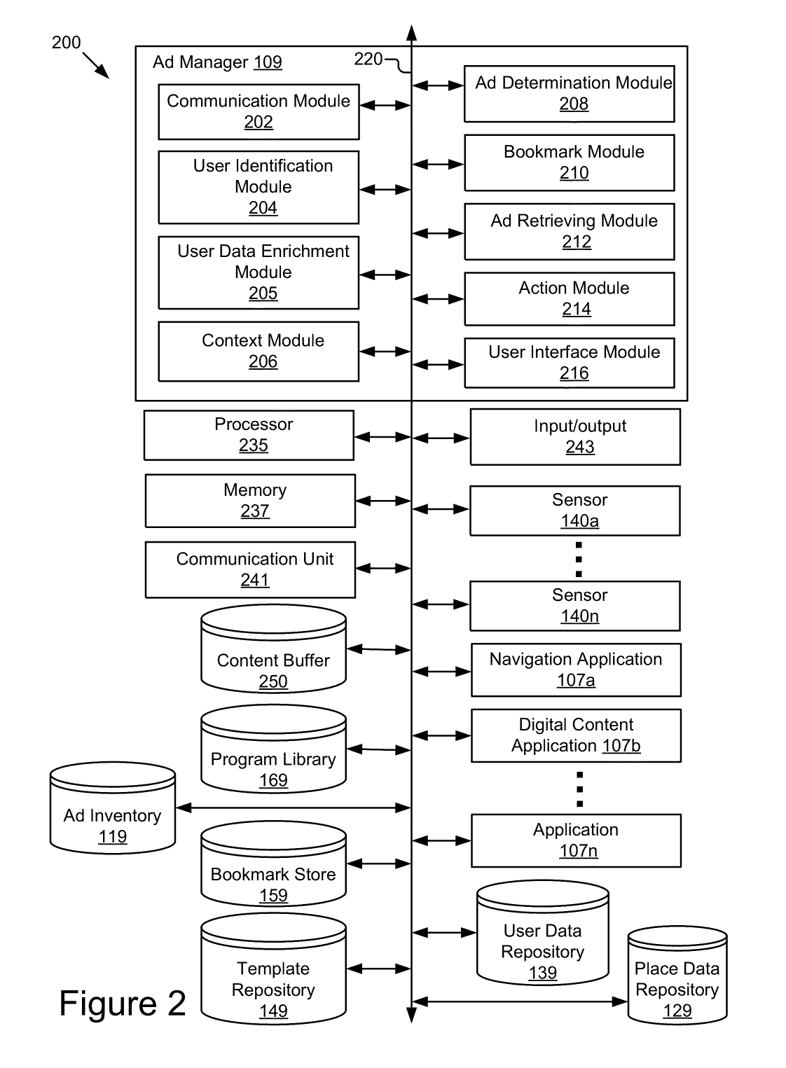

The mobile computing system 135 may be a computing system associated with a vehicle. The mobile computing system 135 may be incorporated with the vehicle or otherwise electronically communicatively coupled to the vehicle via a wired and/or wireless connection. The mobile computing system 135 may be electronically communicatively coupled to the network 105 via signal line 134 for data communication and virtual interaction with one another and the other components of the system 100, such as the server 101, the client device 115, the ad server 120, and/or the digital content server 124. The vehicle can include any type of transportation device, such as, but not limited to, an automobile, motorcycle, bicycle, aircraft, watercraft, etc. The mobile computing system 135 may include non-transitory computer electronics (e.g., processor(s), a memor(ies), communication unit(s), etc.), as described in further detail with reference to FIG. 2. In some embodiments, the mobile computing system 135 can include or represent an infotainment system of the vehicle.

The mobile computing system may include the ad manager 109 and/or portions thereof. The ad manager 109 can include software and/or logic for managing in-vehicle ads. The ad manager 109, or portions thereof, may be stored and/or executable by the mobile computing system 135. In some embodiments, the ad manager 109 may be a distributed application with various modules residing and operable on disparate computing devices distributed across a combination of the devices and servers coupled to the network 105. For instance, the ad manager 109 can include client-side components that may be stored on and operable by one or more computing devices or systems of the system 100 (e.g., the mobile computing system 135 and/or the client device 115) and server-side components that may be stored on and operable by one or more other computing devices or systems of the system 100 (e.g., the server 101, the ad server 120, the digital server 124, the mobile computing system 135, etc.), and configured to exchange data with the client-side components. In some embodiments, the ad manager 109 and its components may reside on a single computing device or system, such as the mobile computing system 135, server 101, and/or client device 115.

In various embodiments, the ad manager 109 can be implemented using hardware including a field-programmable gate array (FPGA), an application-specific integrated circuit (ASIC), software executable by one or more computer processors, a combination of hardware and software, etc. The ad manager 109 is described below in more detail with reference to at least FIGS. 2-14 and 20A-20C.

In some instances, a first instance of the ad manager 109 included in the client device 115 of a user may be companion application that corresponds to an instance of the ad manager 109 included in mobile computing system 135 of that user's vehicle. The user can use the instance of the ad manger 109 on the client device 115 to access bookmarks and other ad-related information generated by the instance of the ad manger 109 on mobile computing system 135. In this example, the instances of the ad manager 109 may include complimentary software and/or logic but may not necessarily have the same composition.

An ad provided to a user in the vehicle by the ad manger 109 can be an interactive ad. The system 100 can tailor the ad to the user's context and/or the context of the user's vehicle and/or client device. The interactive ad may include and/or be associated with one or more interactive features with which a user may interact (e.g., actions a user may take corresponding to the ad). In some embodiments, the user may conveniently access these features using dedicated controls. Example actions/features may include, but are not limited to, replaying, pausing, scrubbing, skipping, etc., the interactive ad; electronically linking to supplemental content about the goods or services being advertised; setting up a call (e.g., calling a place, calling a contact, etc.); triggering an executable process such as another application configured to carry out operations that correspond to the ad and/or the goods and/or services advertised by the ad (e.g., setting a location as a new destination in the navigation application 107a; mapping a location that offers the goods or services for sale via the navigation application 107a, endorsing the goods or services on a social network, sending an electronic message about the goods or services to one or more electronic addresses, purchasing a product, etc.); conducting a search (e.g., searching for restaurants, hotels, gas stations, charging stations, etc.); bookmarking the ad for later access; etc.

The dedicated controls may include, but are not limited to, a voice command via a voice system of the vehicle, a steering wheel button on a steering wheel of the vehicle, a console button of the vehicle, or a soft button on a touch screen of the vehicle, etc. Access of a feature via a corresponding control may signal the ad manager 109 to carry out a corresponding action associated with the feature, as discussed in further detail herein.

The mobile computing system 135 may include and/or be associated with one or more sensors 140a . . . 140n configured to measure various physical and/or dynamic parameters of the vehicle and/or the mobile computing system 135. The sensors 140 can be sensors installed in and/or electronically coupled to the vehicle. Example sensors may include, but are not limited to automotive sensors, acoustic sensors, chemical sensors, actuators, on-board diagnostics (OBD) systems, controllers (e.g., ECU, ECM, PCM, etc.), biometric sensors, location sensors (e.g., GPS, compass, etc.), cameras, etc. Example measurement parameters may include, but are not limited to, current gas mileage, engine on or off, key presence and/or proximity, parking brake on or off, time and date, location (e.g., a latitude, longitude and altitude of the location), system safety parameters related to a vehicle (e.g., an airbag system, an anti-lock braking system, etc.), distance from the vehicle to other objects (e.g., other vehicles, roadside structure, traffic lights, pedestrians, etc.), speed, acceleration, direction of travel, fuel tank level, battery charge level, temperature, humidity, photographs and/or video of vehicle surroundings, etc. As depicted in FIG. 1, the sensors 140a . . . 140n may be respectively communicatively coupled to the mobile computing system 135 via signal lines 141a . . . 141n.

The mobile computing system may include and/or may be communicatively coupled to an ad inventory 119, a place data repository 129, a user data repository 139, a template repository 149, a bookmark store 159, and a program library 169. In some embodiments, the mobile computing system 135 may include a digital content storage 126 for storing digital content (e.g., videos, music, podcasts, images, etc.) in the mobile computing system 135. While FIG. 1 depicts the ad inventory 119, the place data repository 129, the user data repository 139, the template repository 149, the bookmark store 159 and the program library 169 as monolithic entities, in further embodiments, various structure, acts, and/or functionality of one or more of these entities may be combined and/or integrated into the same storage repository.

The ad inventory 119, the place data repository 129, the user data repository 139, the template repository 149, the bookmark store 159, and the program library 169 are data stores for storing and providing access to data. The data forming the ad inventory 119, the place data repository 129, the user data repository 139, the template repository 149, the bookmark store 159, and/or the program library 169 may be stored in the memory 235 and/or another non-transitory storage device or system distinct therefrom. In some implementations, the ad inventory 119, the place data repository 129, the user data repository 139, the template repository 149, the bookmark store 159, and/or the program library 169 may include and/or be accessible using a file system, a distributed data store, a database management system (DBMS), etc. In various embodiments, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

As depicted in FIG. 1, one or more of the data stores 119, 129, 139, 149, 159, and/or 169 may reside in different locations in the system 100, such as the mobile computing system 135, the server, and the ad server 120, depending on the embodiment. In some embodiments, one or more of the data stores may be replicated, at least in part, on more than one computing device of the system 100 to provide faster and/or off-line access to the data stored in those data stores. In these embodiments, the data may be pushed or pulled by the computing devices of the system at various intervals and/or based on various triggers.

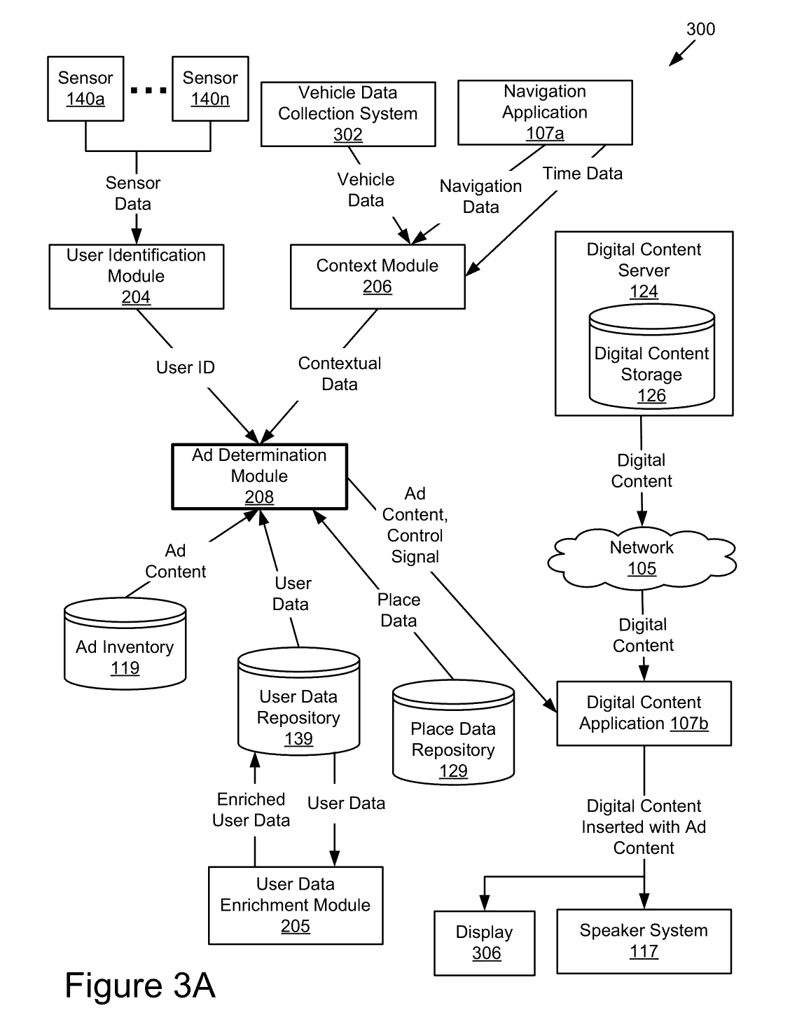

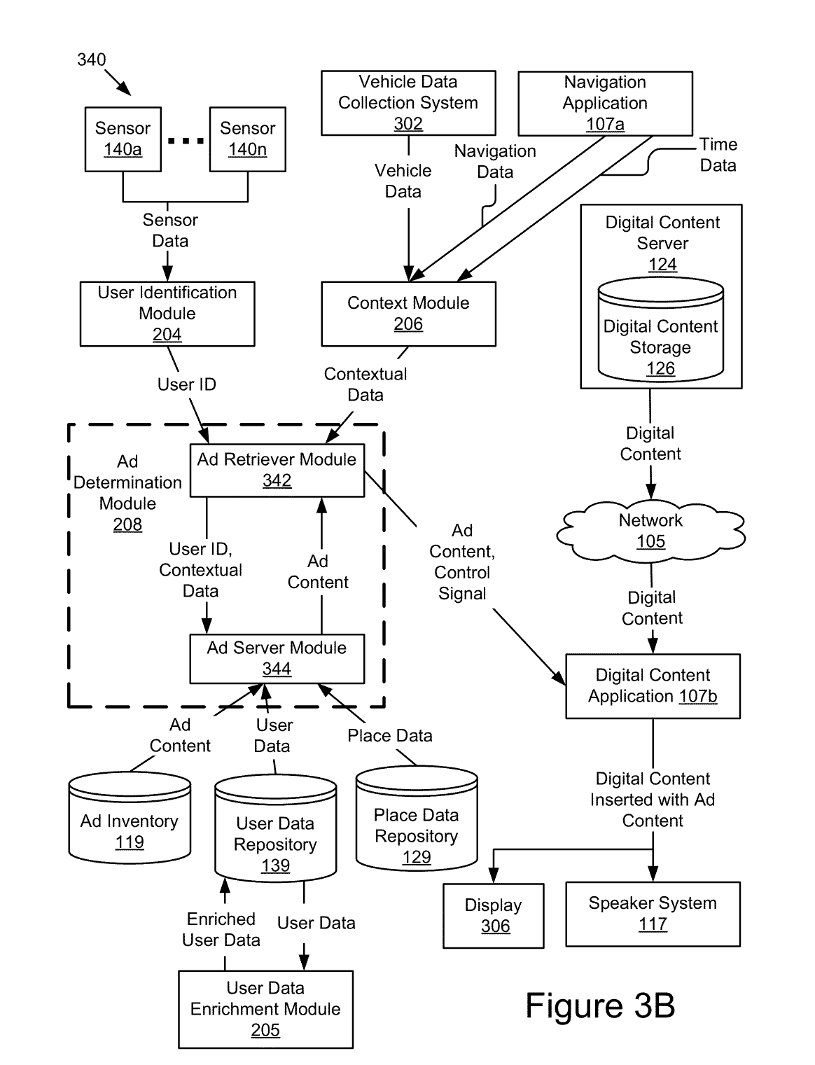

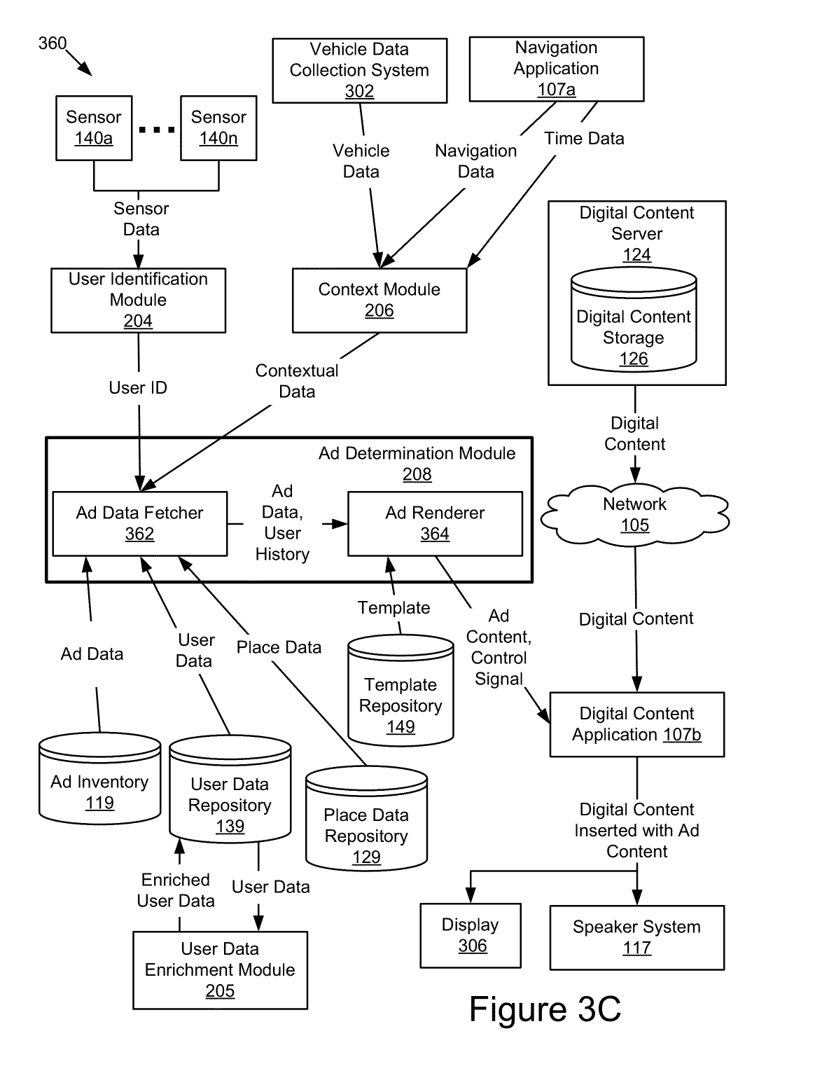

The ad inventory may store and provide access to ad content to one or more components of the system, such as the ad manager 109. The ad content may include interactive audio and/or visual ads. The ads may include advertisements for physical and/or virtual goods, services offered by retailers (brick and mortal, virtual, etc.), public service announcements by various organizations (e.g., governmental agencies, non-profits, etc.), etc. A set of ad content may represent an ad. The set of ad content may include metadata, textual, audio, and/or visual data. The metadata may describe when the ad was created, who created it, when it expires, any limitations or exclusions, legal information, the ad size (file size, dimensions, etc.), the ad format, etc. In some embodiments, the set of ad content may be pre-generated and accessible (e.g., as an object) from the ad inventory for immediate presentation. In some embodiments, the ads may be generated real-time and the ad content may be raw content or semi-generated content used to generate ads, as described herein with reference to at least FIG. 3C. As discussed elsewhere herein, an ad may include one or more interactive features (e.g., actions), that when selected, may provide additional information about the item(s) being advertised (e.g., play or display additional information) and/or provide supplemental resources (e.g., redirect the user to a corresponding website, place a phone call, provide turn-by-turn directions to a location, play certain music, tune radio to certain station, etc.). In various embodiments, the ad inventory 119 can be included in and distributed across a combination of the mobile computing system 135, the server 101 and the ad server 120, or may be included in one of them.

The place data repository 129 may store and provide access to place data. The place data may describe various locations and the attractions, goods, services, people, and/or other items and/or information at those locations. The location may be a virtual, physical location, or both. A virtual location may include an electronic address of a virtual place (e.g., a website, a referral to an app downloadable from an electronic marketplace, etc.) and/or information describing that entity. A physical location may include an address of a physical place and/or information describing that place. For example, the place data repository 129 can store place data describing a restaurant, a hotel, a store, etc., that may be located at or near a particular location. In further example, the place data repository 129 can store place data describing various stores located in a mall. Location items may include, but are not limited to, a landmark, a tourist attraction, a restaurant, a hotel, a retail store, a department store, and/or other points of interest (POI). In some instances, a virtual and physic place may correspond. In various embodiments, the place data repository 129 can be included in and distributed across a combination of the mobile computing system 135 and the server 101, or may be included in one of them. In some embodiments, various places described by the place data stored in the place data repository 129 may be correlated with corresponding ads stored in the ad inventory.

The user data repository 139 can store and provide access to user data associated with the users of the system. Example users include, but are not limited to, drivers and passengers of the vehicles of the system 100 configured with a mobile computing system 135. Example user data may include a user profile containing demographics data (e.g., gender, age, race, education, profession, work experience, etc.), contact information (e.g., physical addresses, electronic addresses, phone numbers, etc.), websites, user names, preferred applications, interests, hobbies, likes, dislikes, historical location (e.g., mapping and navigation) data (e.g., places visited, travel habits, etc.), personal preferences, content (e.g., music, video, radio, etc.) preferences, ad viewing history, deal use history, ad and/or deal preferences and/or inclinations, etc. The ad viewing history may describe various ads viewed by the user. The deal use history may describe various deals and/or coupons used by the user. In some examples, the user data can include data describing restaurants, stores, hotels, and/or other places visited by the user. In some examples, the user data may include data describing videos viewed by the user, web sites visited by the user and/or social network data associated with the user (e.g., posts, comments, sharings, acknowledgements, etc., published by the user in a social network, etc.), etc. Other example user data is possible. In some embodiments, the user data repository 139 can be included in and distributed across a combination of the mobile computing system 135 and the server 101, or in one of the devices or servers.

In some embodiments, the user data may include raw user data collected from various sensors 140, the mobile computing system 135, the client device 115, the ad server 120, the digital content server 124, and/or other entities of the system, such as a social network application (e.g., Facebook, Twitter, Google+, etc.) operable by a third party server (not shown) coupled to the network 105. In some embodiments, the third party server may include a computer architecture substantially similar to that of the computing device 200. In some cases, the user data may be retrieved by the ad manger 109 or other entities of the system using APIs, may be processed and/or enriched thereby, and/or stored in the user data repository 139. It should be understood that the user data repository 139 may store other user data associated with users.

The template repository 149 can store and provide access to ad synthesis templates. An ad synthesis template can be a template for synthesizing an ad. For example, an ad synthesis template includes various fields that can be filled with a product name, a price for the product, a discount for the product, a source of the ad (e.g., a uniform resource locator (URL) of a video), text description for the ad, an image for the ad and/or other description for describing the ad, etc. In some embodiments, the template repository 149 can be included in and distributed across a combination of the mobile computing system 135 and the server 101, or in one of the devices or servers.

The ad synthesis templates may include audio ad synthesis templates and/or visual ad synthesis templates. An audio ad synthesis template can be a template for synthesizing an audio ad. For example, an ad renderer 364 depicted in FIG. 3C can fill various fields of an audio ad synthesis template using ad textual data to generate an ad narration, and then convert the ad narration to an audio ad for presentation to a user. A visual ad synthesis template can be a template for synthesizing a visual ad. For example, the ad renderer 364 can fill various fields of a visual ad synthesis template using ad textual data to generate an ad narration, and then convert the ad narration to a visual ad for presentation to a user.

The bookmark store 159 can store and provide access to various bookmarks associated with various ads for a user. A bookmark can be an indicator indicating an ad is bookmarked by a user. A bookmark can describe an association between a bookmarked ad and a user. For example, a bookmark can include ad identification data for identifying the bookmarked ad and a user ID for identifying the user. In some embodiments, the bookmark store 159 can be included in and distributed across a combination of the mobile computing system 135 and the server 101, or in one of the devices or servers.

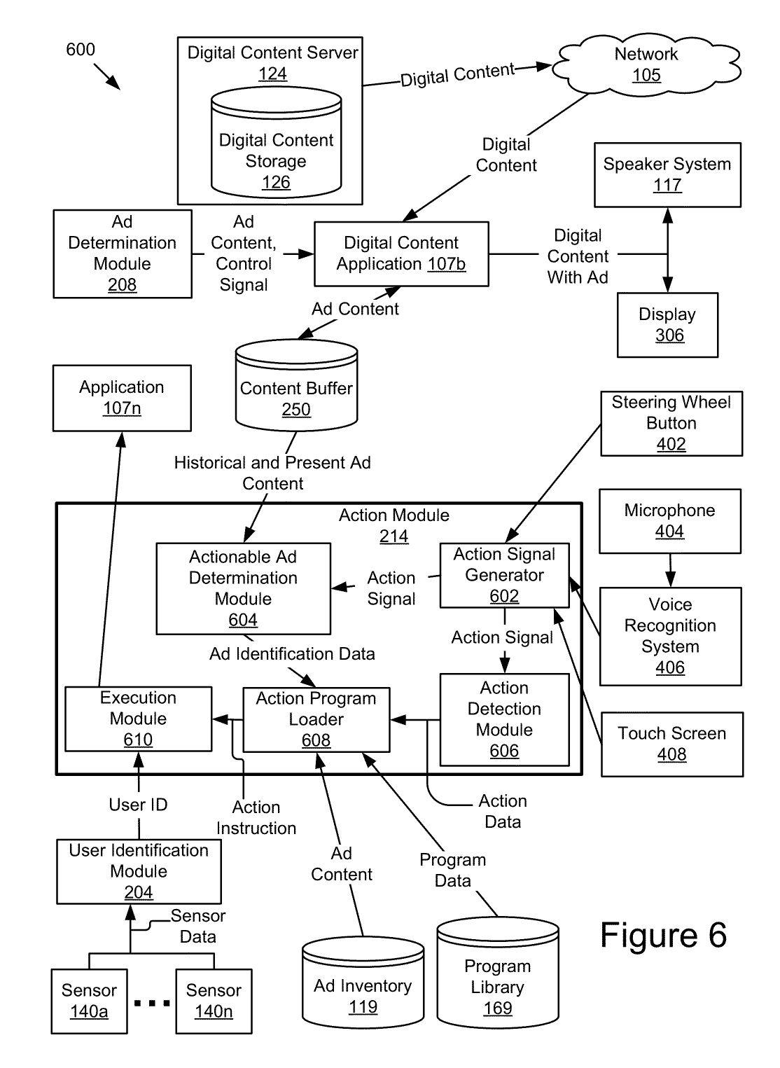

The program library 169 can store and provide access to program data for matching actions to executable programs. The program library 169 is described in more detail with reference to FIG. 6. In some embodiments, the program library 169 can be included in and distributed across a combination of the mobile computing system 135 and the server 101, or in one of the devices or servers.

In some embodiments, the mobile computing system 135 and/or the client device 115 can include various application 107 (e.g., 107a . . . 107n) including, but not limited to a navigation application 107a and a digital content application 107b. The navigation application 107a may include software and/or logic for provide a navigation/mapping service to a user. In some embodiments, the navigation application 107a can provide turn-by-turn instructions to a user for navigating to a destination, allow a user to find and map various locations, allow a user to search for and receive directions to various points of interest, retain and provide a travel history for the device it is operable on, etc. As a further example, the navigation application 107a can provide a travel route, traffic data related to the travel route (e.g., congestion, heavy traffic, light traffic, etc.), a current time of the day and/or an estimated time of arrival at the destination, etc., to the user.

The digital content application 107b may include software and/or logic for presenting digital content and interactive ads to users. In some embodiments, the digital content application 107b can output audio and/or visual components of the digital content and/or ads using corresponding hardware included in the mobile computing system 135 and/or client device 115, such as an audio reproduction system for reproducing audio components of the ad and/or video display for presenting textual and graphical components of the ad. Example audio digital content can include, but is not limited to, podcasts, voice recordings, tape recordings, CDs, music, audio tracks for ads, audio radio programs, video soundtracks, and/or other audio content, etc. Example visual digital content can include, but is not limited to, maps, animations, images, videos, video tracks, and/or images for ads (e.g., ad text, ad banners, ad videos, etc.) and/or other visual files, etc. As a further example, the digital content application 107b may play radio programs, such as, but not limited to FM radio programs, AM radio programs, high definition (HD) radio programs, satellite radio programs, Internet radio programs, podcasts, etc.

The mobile computing system 135 and the client device 115 may each include any number of other applications 107, some of which may be unique to each. Example applications 107 can include, but are not limited to, a social network application for providing a social network to the user, a call application for making a phone call for the user, an email application for sending, receiving, and viewing emails, a text messaging application for sending, receiving and viewing text messages, a chat application for providing a text and/or video chat services to the user, a news application for providing news to the user, an audio and/or video application for listening, purchasing, rating, and/or sharing audio and/or video, a business search application (e.g., an application for finding, reviewing, and/or rating places such as hotels, restaurants, stores, banks, etc.), a navigation/mapping application, a deal application for providing deals and/or coupons to the user, etc.

The ad server 120 can serve ad content describing one or more ads to the server 101, the digital content server 124, the mobile computing system 135, the client device 115, and/or other components of the system 100. The ad server 120 can include an ad inventory 119 for storing the ad content. For example, the ad server 120 can receive ad identification data such as an ad ID from the server 101, the mobile computing system 135 and/or the client device 115, retrieve an ad matching the ad identification data from the ad inventory 119, and send the ad to the server 101, the mobile computing system 135 and/or the client device 115.

The client device 115 may include a computing device having a memory and a processor. Example client devices 115 may include, but are not limited to, a laptop computer, a desktop computer, a tablet computer, a mobile telephone, a personal digital assistant (PDA), a mobile email device, or any other electronic device capable of processing information and accessing a network 105. In some embodiments, the user 125 can interact with the client device 115. In some embodiments, the client device 115 may include various applications 107 such as a navigation application 107a and a digital content application 107b. Although FIG. 1 illustrates one client device 115, the system 100 can include one or more client devices 115.

The digital content server 124 can receive and send data to and from one or more of the server 101, the client device 115, the ad server 120, the mobile computing system 135, and/or other components of the system 100. For example, the digital content server 124 can serve digital content to the mobile computing system 135 and/or the client device 115 upon request. In a further example, the digital content server 124 can provide radio programs, TV programs, videos, maps, and/or other digital content to the digital content application 107b for presentation to users on the mobile computing system 135 and/or the client device 115.

The digital content server 124 can include a digital content storage 126 and/or a radio program storage 136, which may be data stores for storing and providing access to data. In particular, the digital content storage 126 can store and provide access to digital content, such as audio and/or visual digital content as described herein. The radio program storage 136 can store and provide access to radio programs such as including FM radio programs, podcasts, AM radio programs, satellite radio programs, and/or Internet radio programs, etc. The data forming the digital content storage 126 and/or the radio program storage 136 may be stored in the memory 235 (see FIG. 2) and/or another non-transitory storage device or system distinct therefrom. In some implementations, the digital content storage 126 and/or the radio program storage 136 may include and/or be accessible using a file system, a distributed data store, a database management system (DBMS), etc. In various embodiments, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

### Example Ad Manager

Referring now to FIG. 2, a block diagram of an example computing device 200 is shown. The computing device 200 may include different components depending on the specific device or system it represents. In various embodiments, the computing device 200 may include a processor 235, a memory 237, a communication unit 241, and an input/output device 243, and one or more of sensors 140a . . . 140n, various applications 107 (e.g., a navigation application 107a, a digital content application 107b . . . and/or other applications 107n), a content buffer 250, an ad inventory 119, a place data repository 129, a user data repository 139, a template repository 149, a bookmark store 159 and a program library 169. The components of the computing device 200 are communicatively coupled by a bus 220. The bus 220 can be any type of conventional communication bus for transferring data between components of a computing device, or between computing devices. In various embodiments, the computing device 200 may be a server 101, a client device 115, or a mobile computing system 135.

The processor 235 can include one or more processing units, such as an arithmetic logic unit, a microprocessor, a general purpose controller, or some other processor array to perform computations and provide electronic display signals to a display device. The processor 235 can process data signals and may include various computing architectures including a complex instruction set computer (CISC) architecture, a reduced instruction set computer (RISC) architecture, or an architecture implementing a combination of instruction sets. Although FIG. 2 includes a single processor 235, multiple processors 235 may be included. Other processors, operating systems, sensors, displays and physical configurations are possible.

The memory 237 can include one or more non-transitory computer-readable mediums for storing instructions and/or data that can be executed by the processor 235 and/or retrieved and provided to other components of the computing device 200. The instructions and/or data may include code for performing the techniques described herein, such as one or more of the ad manger 109, the communication module 202, the user identification module 204, the user data enrichment module 205, the context module 206, the ad determination module 208, the bookmark module 210, the ad retrieving module 212, the action module 214, the user interface module 216, an operating system, device drivers, applications 107, data forming the content buffer 250, the data stores 119, 129, 139, 149, 159, and/or 169, etc. The memory 237 may include one or more storage devices of the same or different types, such as but not limited to, a dynamic random access memory (DRAM) device, a static random access memory (SRAM) device, embedded memory, flash memory, non-volatile memory or similar permanent storage device and media including a mechanical hard disk drive, a floppy disk drive, a CD-ROM device, a DVD-ROM device, a DVD-RAM device, a DVD-RW device, an SSD, etc.

The communication unit 241 can transmit and receive data to and from one or more of the server 101, the mobile computing system 135, and the client device 115 depending upon where the ad manager 109 may be stored. The communication unit 241 may be coupled (wiredly, wirelessly, etc.) to the network 105 to communicate with other entities forming the network 105. In some embodiments, the communication unit 241 may include one or more ports for direct physical connection to the network 105 or to another communication channel. For example, the communication unit 241 may include a USB, SD, CAT-5 or similar port for wired communication with the client device 115. In some embodiments, the communication unit 241 may include a wireless transceiver for exchanging data with the client device 115 or other communication channels using one or more wireless communication methods, including IEEE 802.11, IEEE 802.16, BLUETOOTH®, dedicated short-range communications (DSRC) or another suitable wireless communication method.

In some embodiments, the communication unit 241 can include a cellular communications transceiver for sending and receiving data over a cellular communications network including via short messaging service (SMS), multimedia messaging service (MMS), hypertext transfer protocol (HTTP), direct data connection, WAP, e-mail or another suitable type of electronic communication. In some embodiments, the communication unit 241 can include a wired port and a wireless transceiver. The communication unit 241 can also provide other conventional connections to the network 105 for distribution of files and/or media objects using standard network protocols including TCP/IP, HTTP, HTTPS, and SMTP, etc.

The content buffer 250 can buffer data for retrieval by one or more components of the computing device 200, such as the ad manager 109 and/or the digital content application 107b. In some embodiments, the content buffer 250 can store ad content that may include historical ad content describing one or more ads being played recently and/or current ad content describing an ad currently being played. The content buffer may be included in the memory 237 or a separate non-transitory computer-readable medium having a structure the same as or substantially similar to the memory 237. For brevity, that structure will not be repeated here.

The input/output device 243 can include one or more input devices and/or one or more output devices. Example output devices may include, but are not limited to, a display device such as a liquid-crystal display (LCD), light-emitting diode (LED) display, etc.; and an audio reproduction device including a DAC, amplifier, and/or an output component such as speaker system, a headset and/or ear-buds, etc. Example input devices can include, but are not limited to, a touch screen component (e.g., capacitive) associated with a display device, console buttons, software-emulated buttons, a microphone, a trackpad, a trackball, an multi-feature knob or stem including one or more switches and/or sensing components, a steering wheel button, etc.

As depicted in FIG. 2, a given instance of the ad manager 109 can include one or more of a communication module 202, a user identification module 204, a user data enrichment module 205, a context module 206, an ad determination module 208, a bookmark module 210, an ad retrieving module 212, an action module 214 and a user interface module 216. These components of the ad manager 109 may be communicatively coupled via the bus 220.

The communication module 202 can be software and/or logic for handling communications between the ad manager 109 and other components of the computing device 200 and/or system 100. In some embodiments, the communication module 202 can be a set of instructions executable by the processor 235 to provide the structure, acts, and/or functionality described herein for this module. In some embodiments, the communication module 202 can be stored in the memory 237 of the computing device 200 and can be accessible and executable by the processor 235. The communication module 202 may be adapted for cooperation and communication with the processor 235 and other components of the computing device 200.

The communication module 202 can send and receive data, via the communication unit 241, to and from one or more of the client device 115, the server 101 and the mobile computing system 135 depending upon where that instance of the ad manager 109 may be stored. For example, the communication module 202 can receive, via the communication unit 241, ad content from the ad server 120 and send the ad content to the ad determination module 208. In another example, the communication module 202 can receive data from one module of the ad manager 109 operable on one device of the system 100 (e.g., the mobile computing system 135) and send the data to another module of the ad manager 109 or another application (e.g., an application 107, an ad server application, etc.) operable on another device of the system 100 (e.g., the server 101, the ad server 120), signaling that component to perform various acts, such as presenting ads and/or other information to a user, requesting various information from the user, requesting retrieval of various ads from the ad inventory 119 by the server 101, the ad server 120, etc. Numerous other scenarios are also contemplated and encompassed by the scope of this disclosure.

In some embodiments, the communication module 202 can receive data describing a bookmark from the bookmark module 210 and store the data in the bookmark store 159 (located locally and/or remotely). In some embodiments, the communication module 202 can retrieve various data from the content buffer 250, the program library 169, the ad inventory 119, the bookmark store 159, the template repository 149, the user data repository 139, and/or the place data repository 129 and provide it the component of the system 100 requesting it. For instance, the communication module 202 can send the retrieved data to other components of the ad manager 109. As a further example, the communication module 202 can retrieve place data from the place data repository 129, and send the place data to the ad determination module 208 and/or the ad retrieving module 212.

The user identification module 204 can be software and/or logic for identifying a user. In some embodiments, the user identification module 204 can be a set of instructions executable by the processor 235 to provide the structure, acts, and/or functionality described herein for this module. In some embodiments, the user identification module 204 can be stored in the memory 237 of the computing device 200 and can be accessible and executable by the processor 235. The user identification module 204 may be adapted for cooperation and communication with the processor 235 and other components of the computing device 200.

In some embodiments, the user identification module 204 can receive identification input data associated with a user from one or more sensors 140. For example, the user can input a biometric trait to a sensor 140 coupled to the mobile computing system 135, causing the sensor 140 to send the biometric trait to the user identification module 204. Example identification input data can include, but is not limited to, a user name and a password, biometric data (e.g., fingerprint data, voice data, facial data, retinal data, etc.), other identification data provided by a device that is a proxy for the user (e.g., a card, a handheld device, etc.), presence of the user's mobile device, unlocking a vehicle using a key such as an ignition key or a wireless key, turning engine on in a vehicle using a key, etc.

The user identification module 204 can retrieve verified user identification data associated with the user from the user data repository 139. The user identification module 204 can determine whether the identification input data matches the verified identification data. For example, the user identification module 204 can determine whether a biometric trait inputted by the user matches a corresponding verified biometric trait of the user stored in the user data repository 139. If the identification input data matches the verified identification data, the user identification module 204 can determine that the user is verified, and retrieve a user profile associated with the user from the user data repository 139. Other verification mechanisms based on other input types are also possible. The user profile may include a user identifier (ID) identifying the user. The user identification module 204 can signal to the other components of the ad manager 109 whether the user has been successfully identified, as if so, provide data identifying the user. For example, the user identification module 204 can send the user ID to other components of the ad manager 109 so that the other components of the ad manager 109 can retrieve data associated with the user using the user ID. If the identification input data does not match the verified identification data, the user identification module 204 can determine that the verification of the user fails. At that point, the user identification module 204 may again attempt to verify the user or another user, or operate in a default, non-personalized state until the user is verified or enrolled into the system 100 (e.g., using a conventional user enrollment process).

The user data enrichment module 205 can be software and/or logic for enriching user data associated with a user. In some embodiments, the user data enrichment module 205 can be a set of instructions executable by the processor 235 to provide the structure, acts, and/or functionality described herein for this module. In some embodiments, the user data enrichment module 205 can be stored in the memory 237 of the computing device 200 and can be accessible and executable by the processor 235. The user data enrichment module 205 may be adapted for cooperation and communication with the processor 235 and other components of the computing device 200.

In some embodiments, the user data enrichment module 205 can receive user data from the user data repository 139, various sensors 140, the mobile computing system 135 and/or the client device 115, other components of the system 100, etc., and enrich the user data using machine learning techniques. In some embodiments, the user data enrichment module 206 may track a user's behavior and determine additional likes, interests, and/or other aspects, based on various aspects of that behavior. For example, the user data enrichment module 205 can receive user data describing restaurants visited by the user, and learn that the user likes Italian food since the user visits Italian restaurants with a higher frequency than other types of restaurants. The user data can be enriched to include the learning result describing that the user likes Italian food. In a further example, the user data enrichment module 206 may monitor the content consumed by the user via the digital content application 107b, such as ads, bookmarks, music, video, radio programs, etc., and may determine what ads, bookmarks, music, video, and/or radio programs (and/or types thereof) the user likes based on the frequency the user consumes that content/type of content.

Example machine learning techniques can include, but are not limited to, artificial neural networks, Bayesian networks and/or decision tree learning, etc. In some embodiments, the user data enrichment module 205 can store the enriched user data in the user data repository 139 as part of the user data. In some additional embodiments, the user data enrichment module 205 can send the enriched user data to the ad determination module 208 as part of the user data associated with the user.

The context module 206 can be software and/or logic for determining contextual data associated with a user. In some embodiments, the context module 206 can be a set of instructions executable by the processor 235 to provide the structure, acts, and/or functionality described herein for this module. In some embodiments, the context module 206 can be stored in the memory 237 of the computing device 200 and can be accessible and executable by the processor 235. The context module 206 may be adapted for cooperation and communication with the processor 235 and other components of the computing device 200.

The context module 206 can aggregate vehicle data from a vehicle data collection system 302. The vehicle data collection system 302 is described with reference to at least FIG. 3A. Vehicle data can be data related to a vehicle, as described elsewhere herein. Example vehicle data can include, but is not limited to, sensor data collected by various sensors 140 installed in the vehicle, a vehicle type (e.g., gasoline, electric, hybrid), a vehicle model, navigation data, time/date data, car area network (CAN) data, etc. Other example vehicle data is possible. In some embodiments, the context module 206 can additionally or alternatively aggregate navigation data and time/date data from the navigation application 107a operable on the mobile computing system 135 and/or the client device 115. Navigation data can include location data, route data, alternative route data, date/time data, other related data, etc. As a further example, navigation data can include geographic coordinates describing a current position of the vehicle, a current route, a start point of a current trip, one or more waypoints, a destination of the current trip, an estimated time of arrival (ETA), the current time/date, historical trip logs (e.g., start points, end points, routes, durations, times of departure, times of arrival, etc., related to historical trips). Time/date data can include the time and date, whether a given day is a holiday or not, etc.

The context module 206 can aggregate the vehicle data, the navigation data and the time/date data to generate contextual data associated with the user. The contextual data associated with the user can include data describing a travel context related to the user. In some embodiments, a travel context may include data describing whom the user is with, where the user is going, what the user is doing and/or intending to do, the user's driving and/or traveling habits, etc. For example, the contextual data can describe that the user is commuting from home to work since: (1) the start point of the current trip is the user's home; (2) the time/date data indicates it is 8:00 AM on a Monday; and (3) historical trip data indicates the user usually commutes to work between 7:45 AM and 8:30 AM on weekdays. In another example, the contextual data can describe that the user is driving to a mall with two other passengers on board since: (1) the destination is set to be the mall; and (2) the sensors 140 can detect that three people are sitting in the vehicle. Other contextual data may also be included. In some embodiments, the contextual data can include the vehicle data, the navigation data, and the time/date data. In some embodiments, the contextual data can include trip data related to the user (e.g., current trip data describing a current trip taken by the user, future trip data describing a future trip planned by the user, and/or historical trip data describing historical trips taken by the user).

In some embodiments, the context module 206 can store the contextual data associated with the user in the user data repository 139. In some embodiments, the context module 206 can send the contextual data to the ad determination module 208.

The ad determination module 208 can be software and/or logic for determining an ad for a user. In some embodiments, the ad determination module 208 can be a set of instructions executable by the processor 235 to provide the structure, acts, and/or functionality described herein for this module. In some embodiments, the ad determination module 208 can be stored in the memory 237 of the computing device 200 and can be accessible and executable by the processor 235. The ad determination module 208 may be adapted for cooperation and communication with the processor 235 and other components of the computing device 200.

The ad determination module 208 can receive user identifying information (e.g., a user ID) from the user identification module 204. The ad determination module 208 can use the user ID to retrieve user data associated with the user (e.g., a user profile) from the user data repository 139. The ad determination module 208 can receive contextual data associated with the user from the context module 206 and/or the user data repository 139. The ad determination module 208 can determine an ad for the user based on the user data and/or the contextual data. By way of example, assume the contextual data can indicate that the user is driving to a destination. The ad determination module 208 can determine an ad for the user describing a deal in a store near the destination. In a further example, assume the user data may indicate that the user likes a particular product brand. The ad determination module 208 can determine an ad related to the particular product brand for the user. It should be understood that, like all example embodiments provided herein, numerous other variations are also possible, some of which are described elsewhere herein.

In some embodiments, the contextual data can include trip data describing a current trip taken by the user, where the trip data can include a start point, a destination, and/or a route from the start point to the destination. The ad determination module 208 can cross-reference with the place data repository 129 to identify one or more places (e.g., stores, restaurants, hotels, etc.) associated with the current trip. For example, the ad determination module 208 can retrieve place data describing one or more places associated with the current trip from the place data repository 129. In a further example, the ad determination module 208 can determine one or more places at or near the start point, one or more places at or near the destination, and/or one or more places along the trip route. The ad determination module 208 can identify ads associated with the places. For example, the ad determination module 208 can select an ad matching a place from the ad inventory 119. In a further example, assume a place such as a restaurant is near the user's destination. The ad determination module 208 can determine an ad describing a deal for dining in the restaurant for the user.

In some embodiments, the ad determination module 208 can identify one or more ads associated with one or more physical and/or virtual locations (e.g., stores, attractions, events, websites, applications, etc.) based on the place data, the user data, and/or the contextual data. For example, assume a place such as a department store is along the user's current trip route and the user data indicates the user likes to ski. The ad determination module 208 can determine an ad for the user describing a coupon for purchasing skiing equipment in the department store. In another example, assume the place is a sports website, or a sports app for a smartphone related to a sports radio program the user frequently listens to while driving. The ad determination module 208 can determine an ad for the user describing free virtual content available using the website or app if a certain code is entered. In a further example, assume the place is a virtual concert ticket website accessible via the network 105 and the user frequently listens to songs by the band Coldplay while driving. The ad determination module 208 can determine an ad to purchase tickets to an upcoming Coldplay concert in the area using the Internet concert ticket service.

The ad determination module 208 can retrieve ad content representing an ad selected from the ad inventory 119. The ad determination module 208 can send the ad content to the digital content application 107b for presenting the ad content to the user. In some embodiments, the digital content application 107b may be playing various digital content (e.g., music, video, radio program, podcast, etc.) and digital content application 107b may insert the ad content into the digital content to present the ad to the user(s) in the vehicle. In various embodiments, the digital content application 107b may pause or mute the presentation of the digital content to present ad content, superimpose the ad content over the digital content (e.g., while lowering the volume level of the digital content so the ad content is clearly received); etc. In some embodiments, the digital content application 107b trigger the provisioning of an ad by sending a request to the ad determination module 208 for an ad, and the ad determination module 208 may determine the ad content to provide using the acts, processes, and/or methods discussed herein.

In some embodiments, the ad determination module 208 can generate and provide a control signal to the digital content application 107b. The control signal can control the insertion of the ad content into the digital content. In some examples, the control signal may indicate to superimpose the ad content over the digital content so that the digital content can be played in background while the ad content is played for the user. For example, assume the user is currently listening to a song. The control signal may instruct the digital content application 107b to superimpose an audio portion of the ad on the song being played, causing the digital content application 107b to play the audio portion of the ad using a speaker system in a vehicle while playing the song as background music. The digital content application 107b may also display a visual portion of the ad on the head unit of the vehicle or on the client device 115. In some examples, the control signal may indicate to play the ad content during a break of the digital content. For example, the control signal may indicate to play the ad content after a song is over. In the absence of a control signal, the digital content application 107b may determine how the ad should be presented (e.g., based on a predetermined setting). For instance, the digital content application 107b could insert the ad between various segments of the digital content.

In some embodiments, the ad determination module 208 can include an ad retriever module 342 and an ad server module 344, which are described with reference to FIG. 3B. In some embodiments, the ad determination module 208 can include an ad data fetcher 362 and an ad renderer 364, which are described with reference to FIG. 3C.

The bookmark module 210 can be software and/or logic for bookmarking an ad. In some embodiments, the bookmark module 210 can be a set of instructions executable by the processor 235 to provide the structure, acts, and/or functionality described herein for this module. In some embodiments, the bookmark module 210 can be stored in the memory 237 of the computing device 200 and can be accessible and executable by the processor 235. The bookmark module 210 may be adapted for cooperation and communication with the processor 235 and other components of the computing device 200.

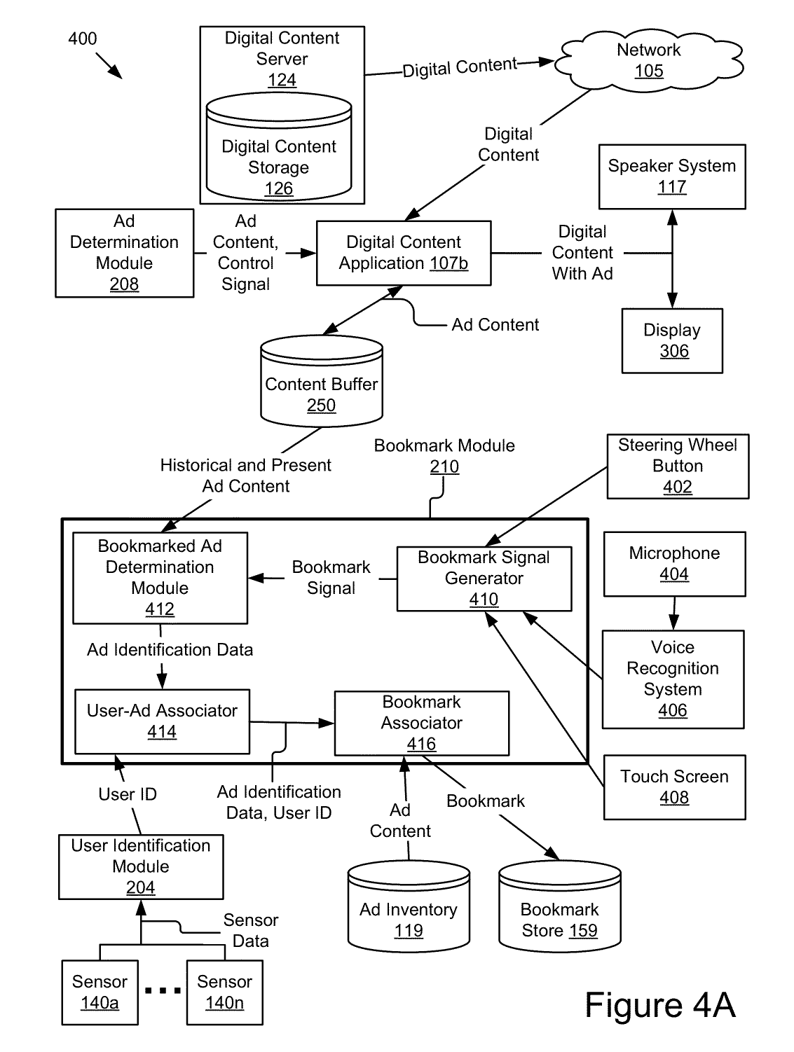

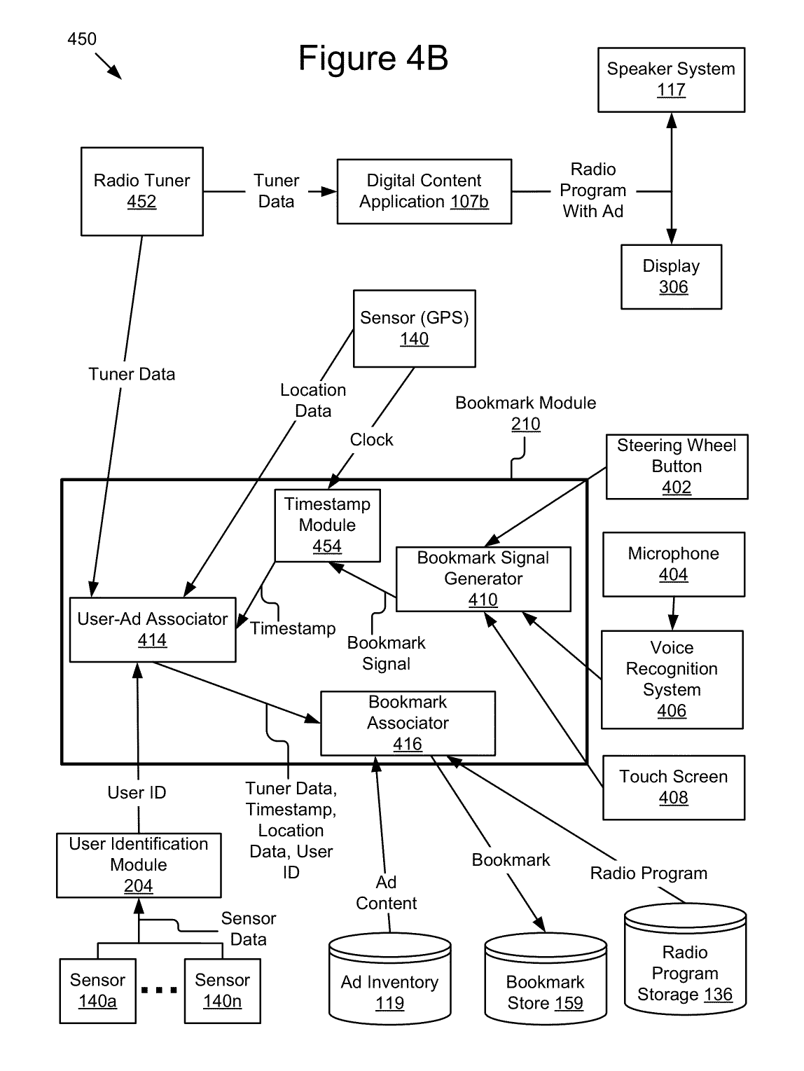

A user can bookmark an ad for later access. For example, a user may not have time and/or capacity to listen to an audio ad being played while he or she is driving, or may be unable to memorize useful information (such as a contact phone number, an address, a name, etc.) from the ad, especially when the driving situation is difficult or stressful, such as when merging into a lane, exiting from a highway exit, etc. In another example, a user may refrain from viewing a visual ad while driving to avoid being distracted by the visual ad. In either example, the user can bookmark the ad for later access by issuing a bookmark command. The user may issue the command by using a control provided by the mobile computing system 135 (e.g., a steering wheel button, a software button, a voice command, etc.). While bookmarking an ad, in some embodiments, the user may provide a memo data describing the user's impressions or comments about the ad. The user may input the memo data using one or more of the controls provided by the mobile computing system 135 (e.g., hardware or software buttons, voice controls, etc.), and the bookmark module 210 can include the memo data in the bookmark stored in the bookmark store 159, and then later access the memo data when retrieving the ad via the ad retrieving module 212. In some embodiments, the memo data may include a voice memo input by the user using a voice recognition system (e.g., see 406 in FIG. 4A) of the mobile computing system 135, and the bookmark module 210 may receive and store the voice memo in association with the bookmark.

The bookmark module 210 can receive input data from the user requesting that an ad being presented to the user be bookmarked. For example, the bookmark module 210 may receive an input signal from control of the vehicle requesting the ad be bookmarked. The bookmark module 210 can bookmark the ad for the user responsive to receiving the input signal. The bookmark module 210 is described in more detail herein, such as with reference to at least FIGS. 4A and 4B.

The ad retrieving module 212 can be software and/or logic for retrieving a bookmarked ad for a user. In some embodiments, the ad retrieving module 212 can be a set of instructions executable by the processor 235 to provide the structure, acts, and/or functionality described herein for this module. In some embodiments, the ad retrieving module 212 can be stored in the memory 237 of the computing device 200 and can be accessible and executable by the processor 235. The ad retrieving module 212 may be adapted for cooperation and communication with the processor 235 and other components of the computing device 200.

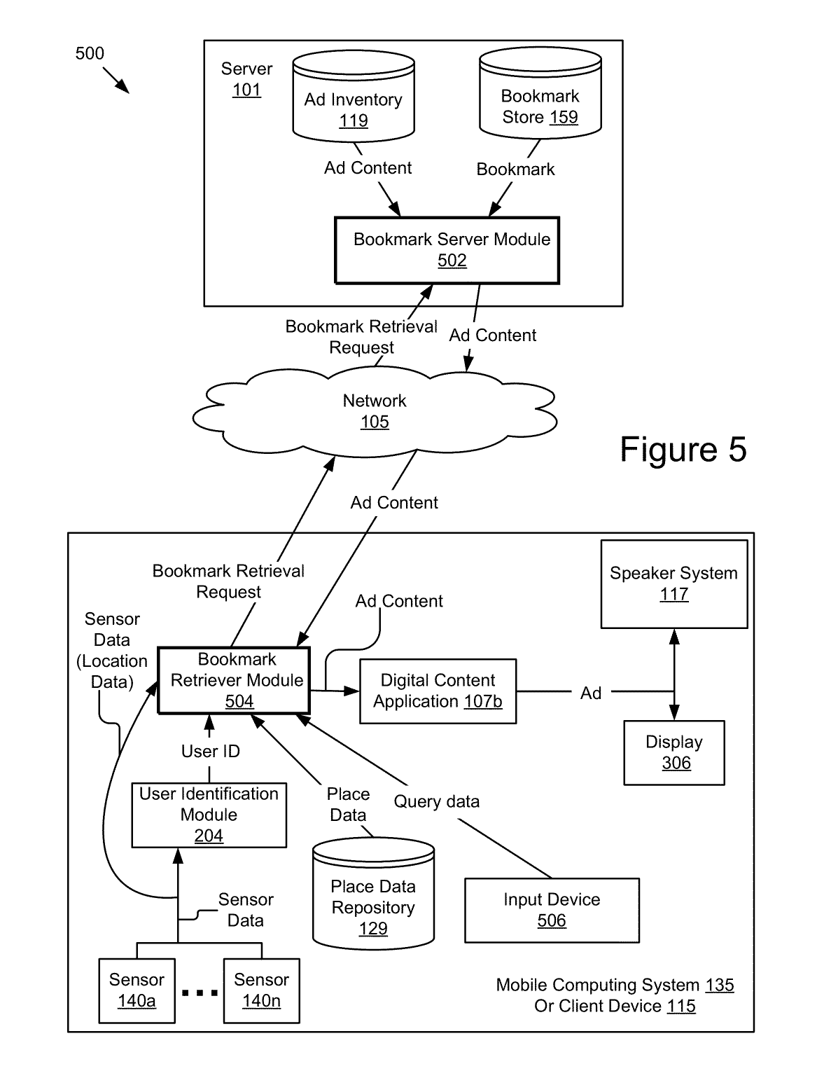

A user can access his or her bookmarked ads using a client device 115 (e.g., a smartphone, tablet, laptop, etc.) or via a mobile computing system 135 of a vehicle. The ad retrieving module 212 can receive a user's request for accessing bookmarked ads from the client device 115 and/or the mobile computing system 135. The ad retrieving module 212 can retrieve bookmarks associated with a user ID identifying the user from the bookmark store 159, where each bookmark can describe an association between the user ID and an ad ID identifying a bookmarked ad. The bookmark may also include other information, such as memo data, as discussed elsewhere herein. The ad retrieving module 212 can retrieve the bookmarked ads identified in the bookmarks from the ad inventory 119, and present the bookmarked ads to the user. For example, the ad retrieving module 212 can generate an ad retrieval request based on input data from the user, retrieve one or more bookmarked ads matching the ad retrieval request, and present the one or more bookmarked ads to the user, as described in more detail elsewhere herein, such as with reference to at least FIG. 5.

The action module 214 can be software and/or logic for facilitating performance of an action for a user. In some embodiments, the action module 214 can be a set of instructions executable by the processor 235 to provide the structure, acts, and/or functionality described herein for this module. In some embodiments, the action module 214 can be stored in the memory 237 of the computing device 200 and can be accessible and executable by the processor 235. The action module 214 may be adapted for cooperation and communication with the processor 235 and other components of the computing device 200.

In some embodiments, while an ad is being presented to a user using the speaker system 117 and/or the display 306, the user can issue an action command to perform an action associated with the ad. The types of actions that can be performed are discussed in further detail elsewhere herein. The user may issue the command via one or more controls of the vehicle (e.g., by pressing a steering wheel button, pressing a soft button, issuing a voice command, etc.).

In some embodiments, the action module 214 can receive input data requesting to perform an action associated with an ad (e.g., corresponding to a feature of the ad) from the user, and instruct one or more applications 107n to perform the action. For example, assume an ad is being presented to a user using an infotainment system of a vehicle (e.g., via the digital content application 107a) while the user is driving the vehicle. The ad can describe a deal in a restaurant that offers a cuisine the user is interested in and may provide an address in association with a selectable option configured to provide directions to the restaurant via the navigation application 107a. The user can issue a voice command to select to option. The microphone 404 (e.g., see FIG. 4A) can receive the user's voice command and send the voice command to the voice recognition system 406, which can interpret the voice command to be an action command to navigate to the restaurant. The voice recognition system 406 can send the action command to the action module 214. The action module 214 can instruct the navigation application 107a to automatically set a destination or waypoint for the restaurant (e.g., using data from the ad, such as the address), causing the navigation application 107a to provide turn-by-turn directions to the restaurant. The action module 214 is described in more detail herein, such as with reference to at least FIG. 6.

The user interface module 216 can be software and/or logic for generating graphical data for providing user interfaces to users. In some embodiments, the user interface module 216 can be a set of instructions executable by the processor 235 to provide the structure, acts, and/or functionality described herein for this module. In some embodiments, the user interface module 216 can be stored in the memory 237 of the computing device 200 and can be accessible and executable by the processor 235. The user interface module 216 may be adapted for cooperation and communication with the processor 235 and other components of the computing device 200.

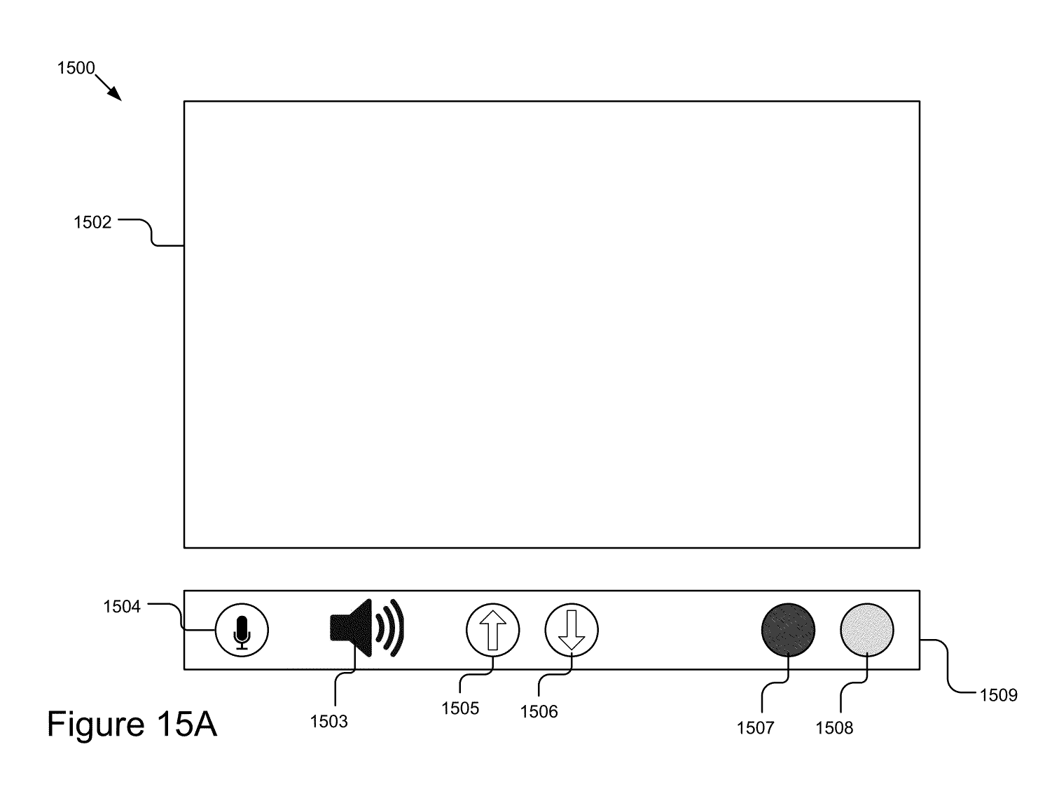

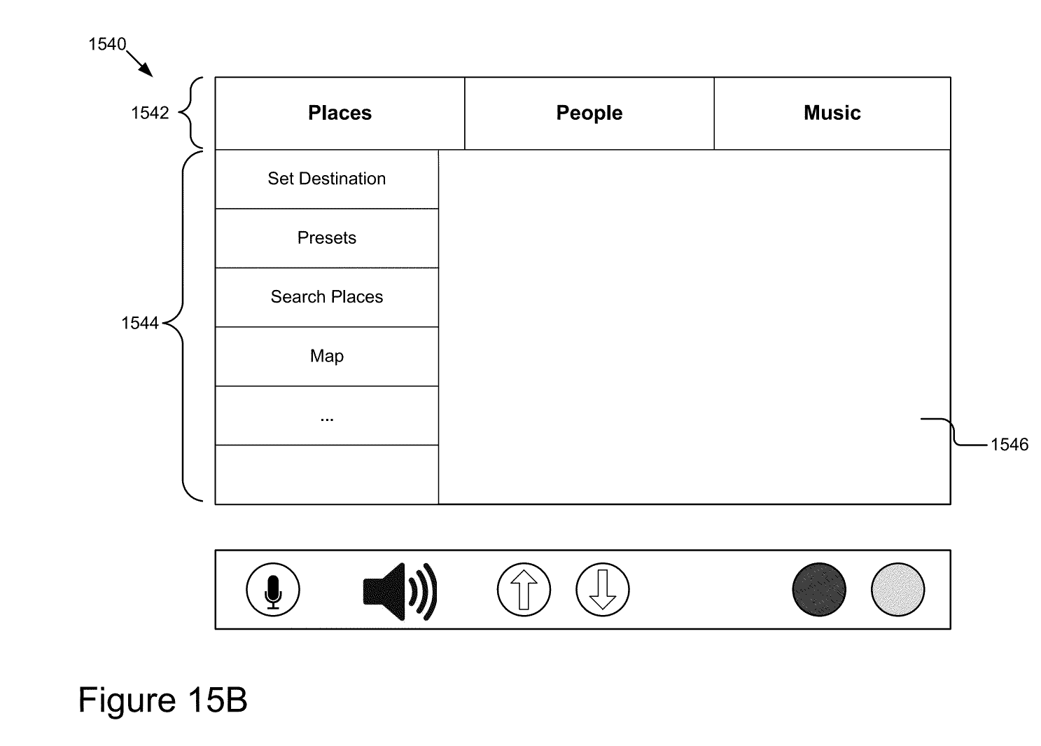

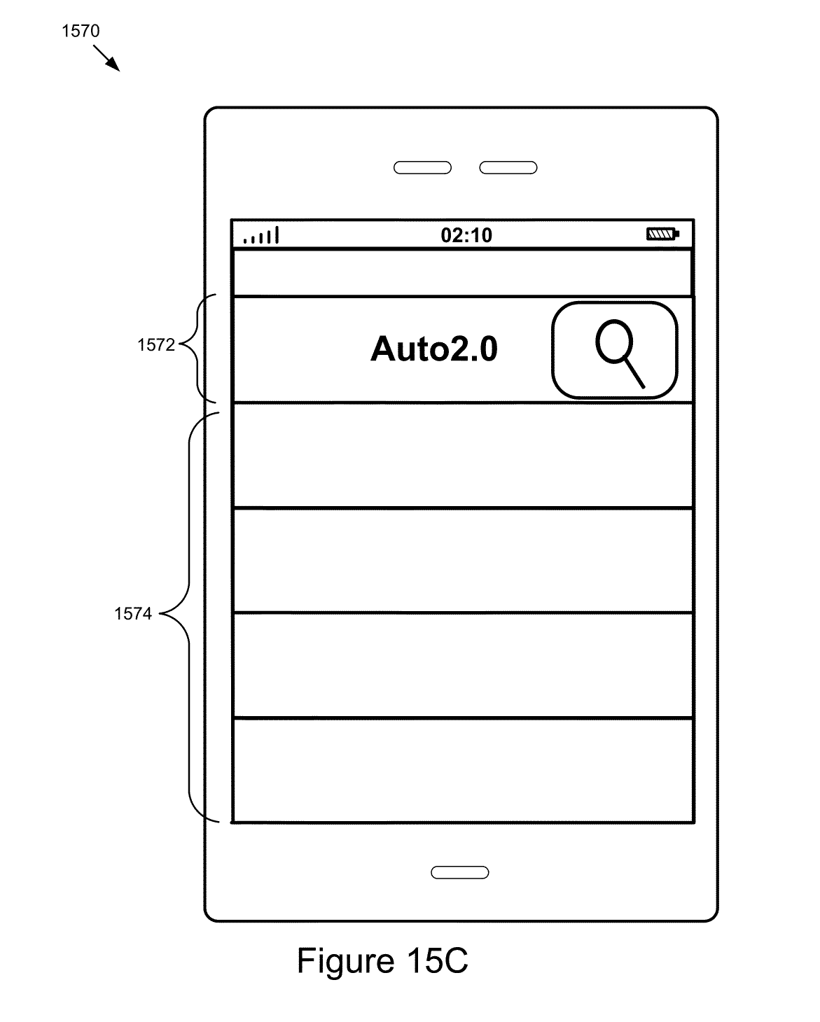

In some embodiments, the user interface module 216 can generate graphical data for providing user interfaces presenting ads, bookmarks, user profile information, settings, or other information stored and/or processed by the system 100. Example user interfaces are illustrated with reference to at least FIGS. 15A-19F. It should be understood that the user interface module 216 may generate graphical data for providing other user interfaces to users.

### Example Interactions Between Different Components

FIGS. 3A-3C are block diagrams 300, 340 and 360 illustrating various example interactions between the ad determination module 208 and other components of the system 100. Referring to FIG. 3A, the user identification module 204 can receive sensor data from sensors 140a . . . 140n and identify a user based on the sensor data. For example, when a user enters a vehicle, one or more sensors 140 can detect presence of the user, and send sensor data indicating presence and/or identity of the user to the user identification module 204. For example, a sensor 140 (e.g., a Bluetooth sensor) may detect presence of the user's mobile phone and send sensor data indicating presence of the user's mobile phone to the user identification module 204. In another example, a sensor 140 may detect presence of the user's wireless key and send sensor data indicating presence of the user's wireless key to the user identification module 204. The user identification module 204 can determine a user ID for the identified user from the user data repository 139, and send the user ID to the ad determination module 208.

The vehicle data collection system 302 can aggregate vehicle data related to the user's vehicle, and send the vehicle data to the context module 206. The navigation application 107a can provide navigation data and/or time/date data to the context module 206. For example, the navigation application 107a can provide navigation data to the context module 206. The context module 206 can generate contextual data for the user based on the vehicle data, the navigation data, and/or the time/date data. Additionally or alternatively, the context module 206 may generate the contextual data based on user data, as discussed elsewhere herein. The context module 206 can send the contextual data to the ad determination module 208.

The user data enrichment module 205 can retrieve the user data from the user data repository 139, enrich the user data using machine learning techniques, and store the enriched user data as part of the user data in the user data repository 139. The ad determination module 208 can receive the user ID from the user identification module 204 and/or the contextual data from the context module 206. The ad determination module 208 can use the user ID to retrieve user data from the user data repository 139. The ad determination module 208 can query the place data repository for one or more places corresponding to the contextual data and/or the user data. The ad determination module 208 can determine an ad for the user based on the user data, the contextual data, and or the place data.

In some embodiments, the contextual data can include trip data describing a previous, current, or future trip associated with the user. The ad determination module 208 can retrieve place data from the place data repository 129 and identify one or more places associated with the trip (e.g., places near the trip start point, near the trip destination, along the trip route) from the place data. The ad determination module 208 can query the ad inventory 119 for ads matching the one or more places, and receive one or more ads in response to the query. In some examples, the ad determination module 208 may receive more than one ad matching the one or more places, and the ad determination module 208 can select which ad to use based on one or more criteria, such as relevance to the user, how often the ad has been used, how current the ad is, proximity to the user's location, etc. The ad determination module 208 may determine these factors based on the ad content, the user data, and/or the contextual data. For example, the ad determination module 208 can determine an ad most closely matching the user's interests and/or demographic from the multiple ads.

The ad determination module 208 can retrieve ad content describing the determined ad for the user from the ad inventory 119. The ad determination module 208 can send the ad content to the digital content application 107b for presentation. In some implementations, the ad determination module 208 can generate and provide a control signal to the digital content application 107b for managing how to insert the ad into the digital content currently being played to the user. In some implementations, the ad may be provided to digital content application 107b in response to an ad request sent to the ad determination module 208 by the digital content application 107b.

The digital content application 107b can receive digital content from the digital content server 124 via the network 105. In some examples, the digital content application 107b can retrieve digital content (e.g., as a file, as a data stream, etc.) from the mobile computing system 135 and/or the client device 115. The digital content application 107b can present the digital content to the user using the speaker system 117 and/or a display 306 (e.g., a head unit in a vehicle, a touch screen, etc.). The digital content application 107b can receive the ad content and/or the control signal from the ad determination module 208, and insert the ad content into the digital content based on the control signal. In some examples, the ad content can be inserted into breaks in the digital content (e.g., breaks between two songs). In some examples, the ad content can be superimposed on the digital content. In some examples, the digital content may be paused or muted and the ad content may be played in its stead. The digital content application 107b can present the digital content and ad content to the user using the speaker system 117 and/or the display 306.

FIG. 3B includes some components similar to those depicted in FIG. 3A, and description for the similar components will not be repeated here with reference to this figure. In FIG. 3B, the ad determination module 208 can be implemented using a client-server structure. The ad determination module 208 can include (1) an ad retriever module 342 stored in the mobile computing system 135 and/or the client device 115 and (2) an ad server module 344 stored in the server 101. The ad retriever module 342 and the ad server module 344 can communicate with each other via the network 105. Splitting the ad determination module 208 into the ad retriever module 342 and the ad server module 344 is beneficial since, for example, ads delivered from the server 101 to the mobile computing system 135 and/or the client device 115 may be more up-to-date, include time-sensitive deals, etc.

The ad retriever module 342 can include software and/or logic executable by a processor 235 of the computing device 200 to retrieve an ad from the server 101 via the network 105. The ad retriever module 342 can receive a user ID identifying a user from the user identification module 204 and/or contextual data associated with the user and/or the vehicle from the context module 206. The ad retriever module 342 can send the user ID and/or the contextual data to the ad server module 344 for retrieving an ad for the user.

The ad server module 344 can include software and/or logic executable by a processor 235 of the computing device 200 to determine an ad for a user. The ad server module 344 can receive a user ID and/or contextual data associated with a user from the ad retriever module 342 via the network 105. The ad server module 344 can use the user ID to retrieve user data from the user data repository 139. The ad server module 344 can determine an ad for the user based on the place data, user data, and/or the contextual data.

In some embodiments, the contextual data can include trip data describing a previous, current, or future trip associated with the user. The ad server module 344 can retrieve place data from the place data repository 129 and identify one or more places associated with the trip (e.g., places near the trip start point, near the trip destination, along the trip route) from the place data. The ad server module 344 can query the ad inventory 119 for ads matching the one or more places, and receive one or more ads in response to the query. In some examples, the ad server module 344 may receive more than one ad matching the one or more places, and the ad server module 344 can select which ad to use based on one or more criteria, such as relevance to the user, how often the ad has been used, how current the ad is, proximity to the user's location, etc. The ad server module 344 may determine these factors based on the ad content, the user data, and/or the contextual data. For example, the ad determination module 208 can determine an ad most closely matching the user's interests and/or demographic from the multiple ads.

The ad server module 344 can retrieve ad content corresponding to the identified ad and send the ad content to the ad retriever module 342. The ad retriever module 342 can receive the ad content from the ad server module 344 via the network 105. The ad retriever module 342 can send the ad content to the digital content application 107b for presentation. In some embodiments, the ad content may be presented in association with digital content provided that content is being played, as discussed elsewhere herein. In some embodiments, the ad retriever module 342 can generate a control signal for inserting the ad into digital content being played to the user, and send the control signal to the digital content application 107b in association with the ad content.

FIG. 3C includes various components that are the same as or similar to those depicted in FIG. 3A, and description for these components will not be repeated here with reference to this figure. In FIG. 3C, the ad determination module 208 can include an ad data fetcher 362 and an ad renderer 364. The ad data fetcher 362 and the ad renderer 364 can cooperate to generate an ad for a user on the fly.

The ad data fetcher 362 can include software and/or logic executable by a processor 235 of the computing device 200 to fetch ad data. The ad data fetcher 362 can receive a user ID identifying a user from the user identification module 204 and/or contextual data from the context module 206. The ad data fetcher 362 can use the user ID to retrieve user data from the user data repository 139. The ad data fetcher 362 can determine ad data for the user based on the user data and/or the contextual data. Ad data can be structured data describing an ad. In some examples, the ad data can be raw data and/or metadata including information for generating an ad. In a further example, ad data for generating an audio ad related to a restaurant can include ad textual data describing a name of the restaurant, an address, phone number, and web address of the restaurant, a description of the restaurant, the cuisine(s) the restaurant serves, prices, menu items, and/or other descriptive data, etc.; and ad data for generating a visual ad related to the restaurant can include the ad textual data, images, video frames, and/or other descriptive data, etc. As described herein, in some embodiments, the ad textual data (e.g., raw data and/or metadata, etc.) can be converted to an audio ad or a visual ad by the ad renderer 364 using an ad synthesis template.

In some embodiments, the contextual data can include trip data describing a previous, current, or future trip associated with the user. The ad data fetcher 362 can retrieve place data from the place data repository 129 and identify one or more places associated with the trip (e.g., places near the trip start point, near the trip destination, along the trip route) from the place data. The ad data fetcher 362 can query the ad inventory 119 for ads matching the one or more places, and receive one or more ads in response to the query. In some examples, the ad data fetcher 362 may receive more than one ad matching the one or more places, and the ad data fetcher 362 can select which ad to use based on one or more criteria, such as relevance to the user, how often the ad has been used, how current the ad is, proximity to the user's location, etc. The ad data fetcher 362 may determine these factors based on the ad content, the user data, and/or the contextual data. For example, the ad data fetcher 362 can determine an ad most closely matching the user's interests and/or demographic from the multiple ads.

The ad data fetcher 362 can retrieve ad data for the user from the ad inventory 119 and send the ad data to the ad renderer 364. In some embodiments, the ad data fetcher 362 can determine a user history including an ad access history associated with the user from the user data repository 139, and send the user history to the ad renderer 364.

The ad renderer 364 can include software and/or logic executable by a processor 235 of the computing device 200 to generate an ad using an ad synthesis template. The ad renderer 364 can receive the ad data (e.g., ad textual data) and/or the user history including an ad access history from the ad data fetcher 362. The ad renderer 364 can retrieve an ad synthesis template from the template repository 149 to use to generate the ad. In some embodiments, the ad renderer 364 may select the ad synthesis template based on the user's ad access history. For example, if the user's ad access history indicates 50% of the ads accessed by the user were generated from a particular ad synthesis template, the ad renderer 364 can retrieve the particular ad synthesis template from the template repository 149 for generating a new ad for the user.

The ad renderer 364 can generate the ad for the user based on the ad textual data and the ad synthesis template. In some embodiments, the ad renderer 364 can fill various fields in the ad synthesis template using the corresponding ad textual data, and generate an ad narration from the filled ad synthesis template. For example, to generate an ad for a restaurant, the ad renderer 364 can fill in a name field in the ad synthesis template using a name of the restaurant, a description of the restaurant, an address field using an address of the restaurant, a price field using a price range set by the restaurant, etc. The ad renderer 364 can convert the ad narration into an audio ad, a visual ad, and/or an ad including an audio portion and a visual portion. The ad renderer 364 may include additional ad data when rendering a visual ad, such as graphics, images, video frames, and/or other pictorial data. For example, the ad renderer 364 can generate a banner ad for a restaurant displaying a name, a logo, an address, and deal information for the restaurant using an ad narration, where the ad narration is formed by an ad synthesis template filled with ad textual data related to the restaurant. In some embodiments, the ad renderer 364 can generate a control signal for controlling the presentation of the ad. The ad renderer 364 can send the control signal and/or ad content describing the generated ad to the digital content application 107b, causing the digital content application 107b to present the ad to the user using the speaker system 117 and/or the display 306. In some embodiments, the ad content may be provided in response to a request for it from the digital content application 107b.

FIGS. 4A and 4B are block diagrams 400 and 450 illustrating various interactions between an example bookmark module 210 and other components of the example system. Referring to FIG. 4A, the digital content application 107b can receive digital content from the digital content server 124 via the network 105 and ad content for a user from the ad determination module 208. The digital content application 107b can present the ad content along with the digital content to the user using the speaker system 117 and/or the display 306.

The digital content application 107b can temporarily store the ad content played to the user in the content buffer 250. In some embodiments, the content buffer 250 can store historical ad content describing a plurality of ads played to the user recently. In some additional embodiments, the content buffer 250 can also store present ad content describing an ad currently or recently presented to the user. It is beneficial to include a content buffer 250 in the system since, for example, the content buffer 250 can temporarily store one or more recent ads played to the user so that the user can bookmark an ad even after presentation of the ad is complete. Use of a content buffer 250 can also substantially reduce and/or eliminate lag/latency associated with retrieving and providing the ad to the digital content application 107b for presentation.

As illustrated in FIG. 4A, the bookmark module 210 can include a bookmark signal generator 410, a bookmarked ad determination module 412, a user-ad associator 414 and a bookmark associator 416.

The bookmark signal generator 410 can include software and/or logic executable by a processor 235 of the computing device 200 to generate a bookmark signal based on input data from a user. In some embodiments, a user can request to bookmark an ad using a control (e.g., by pressing a steering wheel button 402 in a vehicle; pressing a software button displayed on a touch screen 408 of the infotainment system in the vehicle; pressing a software button on a touch screen 408 of a client device 115 such as a cell phone; issuing a voice command via a microphone 404 (causing the microphone 404 to send the voice command to a voice recognition system 406 included in and/or operable by the mobile computing system 135 and/or the client device 115); etc.). As a further example, in some embodiments, the voice recognition system 406 can interpret the voice command as a bookmark command for bookmarking an ad, and send the bookmark command to the bookmark signal generator 410.

In some embodiments, the bookmark signal generator 410 can receive an input from one or more of the steering wheel button 402, the voice recognition system 406, and the touch screen 408, and determine an occurrence of a bookmark action based on the input(s). The bookmark signal generator 410 can generate a bookmark signal indicating the occurrence of the bookmark action, and send the bookmark signal to the bookmarked ad determination module 412.

The bookmarked ad determination module 412 can include software and/or logic executable by a processor 235 of the computing device 200 to determine an ad to be bookmarked by a user. The bookmarked ad determination module 412 can receive the bookmark signal from the bookmark signal generator 410. Responsive to the bookmark signal, the bookmarked ad determination module 412 can retrieve ad content from the content buffer 250 and determine an ad to be bookmarked from the ad content. For example, the bookmarked ad determination module 412 can retrieve ad content describing one or more ads that were recently played to the user from the content buffer 250, and select the most recently presented ad as the ad to be bookmarked (from the one or more ads accessible from the content buffer 250). In another example, the bookmark signal can include a timestamp indicating a time when the user pressed a steering wheel button 402, and the bookmarked ad determination module 412 can determine the ad to be bookmarked as the ad from the content buffer having a presentation time matching the timestamp. In another example, the bookmarked ad determination module 412 can retrieve ad content describing an ad currently being played from the content buffer 250 and determine the ad currently being played as the ad to be bookmarked. Other variations are also possible and contemplated.

The bookmarked ad determination module 412 can generate ad identification data for identifying the ad to be bookmarked. Example ad identification data can include, but is not limited to, an ad ID, an audio snippet of an audio ad that can be used as a fingerprint to identify the ad, a quick response (QR) code of a visual ad, etc. The bookmarked ad determination module 412 can send the ad identification data to the user-ad associator 414.

The user-ad associator 414 can include software and/or logic executable by a processor 235 of the computing device 200 to associate a user ID with an ad to be bookmarked. The user-ad associator 414 can receive the ad identification data for identifying the ad to be bookmarked from the bookmarked ad determination module 412. The user-ad associator 414 can receive a user ID identifying the user from the user identification module 204. The user-ad associator 414 can associate the user ID with the ad identification data, and send data describing an association between the user ID and the ad identification data to the bookmark associator 416.

The bookmark associator 416 can include software and/or logic executable by a processor 235 of the computing device 200 to generate a bookmark for a user. The bookmark associator 416 can receive data describing an association between a user ID and ad identification data identifying an ad to be bookmarked from the user-ad associator 414. The bookmark associator 416 can generate a bookmark associating the ad content stored and accessible from the ad inventory 119 using the ad identification data and the user ID. For example, the bookmark associator 416 can generate a bookmark describing an association between the user ID and an ad ID of the ad, as well as any other related information, such the memo data. In some embodiments, when generating the bookmark, the bookmark associator 416 may query the ad inventory 119 for the ad content to verify that the ad content exists and/or is valid. The bookmark associator 416 can store the bookmark in the bookmark store 159.

In some embodiments, the bookmark module 210 can be implemented using a client-server structure. For example, the bookmark signal generator 410, the bookmarked ad determination module 412 and the user-ad associator 414 can be stored in the mobile computing system 135 such as a vehicle, and the bookmark associator 416 can be stored in the server 101, although other configurations are possible and contemplated. The user-ad associator 414 can receive a user ID identifying the user from the user identification module 204, which can determine the user's identity including the user ID based on data received from one or more sensors 140a . . . 140n, and/or identification information input by a user using an input device. The user-ad associator 414 can send data describing an association between the user ID and the ad identification data from the mobile computing system 135 to the bookmark associator 416 in the server 101 via the network 105. The bookmark associator 416 can store the bookmark in a bookmark store 159 comprised within the server 101. The user can access the bookmark stored in the server 101 using the client device 115 and/or the mobile computing system 135 via the network 105.

Referring to FIG. 4B, an ad to be bookmarked by a user can be a broadcast radio ad such as an ad played on FM radio, AM radio, HD radio or satellite radio, etc. In some examples, a user can use a radio tuner 452 to select a radio channel to listen to. The radio tuner 452 can be an electronic tuner included in the mobile computing system 135. The radio tuner 452 can generate tuner data describing a radio channel selected by the user, and send the tuner data to a radio (e.g., AM, FM, Satellite radio, etc.) or the digital content application 107b (depending on the configuration of the vehicle's entertainment system). The radio may be included in and coupled to the other components of the mobile computing system 135, including the speaker system 117. The radio tuner 452 may also send the tuner data to the user-ad associator 414. In some embodiments, the tuner data can include a frequency representing a channel selected by the user (e.g., a FM frequency, an AM frequency, a satellite frequency, etc.) and/or additional information received from the broadcast station (e.g., content metadata from radio data systems (RDS)).

The radio or the digital content application 107b can receive the tuner data describing a selected radio channel from the radio tuner 452 and, based thereon, receive a radio program (e.g., FM radio program) associated with the selected radio channel via airwaves, a satellite network, the Internet, etc. The radio program can include broadcast ads and the radio or the digital content application 107b can play the ads as part of playing the radio program using the speaker system 117 and/or the display 306. A user can bookmark a broadcast radio ad that is played as part of the radio program using a control, such as by pressing a steering wheel button 402, pressing a software button on a touch screen 408, issuing a voice command via the microphone 404, etc.

As illustrated in FIG. 4B, in some embodiments the bookmark module 210 can include a bookmark signal generator 410, a timestamp module 454, a user-ad associator 414, and a bookmark associator 416.

The bookmark signal generator 410 can receive one or more inputs from one or more controls, such as the steering wheel button 402, the voice recognition system 406, and/or the touch screen 408. The bookmark signal generator 410 can generate a bookmark signal describing an occurrence of a bookmark action based on the one or more inputs, and send the bookmark signal to the timestamp module 454.

The timestamp module 454 can include software and/or logic executable by a processor 235 of the computing device 200 to generate a timestamp. The timestamp module 454 can receive clock data from a sensor 140 such as a GPS. The clock data may include data describing the time of the day when the bookmark signal is received from the bookmark signal generator 410. For example, the clock data may include data describing the date/time when the steering wheel button 402 a soft button in the touch screen 408 is pressed by the user. The clock data can be time/date data from a synchronized internal clock. The timestamp module 454 can generate a timestamp based on the clock data, and send the timestamp to the user-ad associator 414.

The user-ad associator 414 can receive the tuner data from the radio tuner 452, location data describing a current location of the user from the sensor 140, such as a GPS or another location-determining component, and the timestamp from the timestamp module 454. In some embodiments, the location data can describe a current location of the user's vehicle or a current location of the user's mobile phone. The user-ad associator 414 can receive a user ID identifying the user from the user identification module 204, which can determine the user's identity including the user ID based on data received from one or more sensors 140a . . . 140n, and/or identification information input by a user using an input device. The user-ad associator 414 can associate the tuner data, the timestamp and the location data with the user ID, and send data describing an association among the tuner data, the timestamp, the location data, and the user ID to the bookmark associator 416.

The bookmark associator 416 can receive data describing the association among the tuner data, the timestamp, the location data, and the user ID from the user-ad associator 414. The bookmark associator 416 can determine the radio station to which the radio or the digital content application 107b is tuned using the tuner data and/or the location data. For example, the bookmark associator 416 can determine a radio station as being an FM radio station in a particular city based on the tuner data and the location data. The bookmark associator 416 can query the radio program storage 316 to identify which radio program associated with the radio station is was broadcast at the time indicated by the timestamp, and more particularly identify the ad played at the time indicated by the timestamp. The bookmark associator 416 can associate the user ID with the identified ad, and generate a bookmark describing an association between the user ID and the identified ad. For example, the bookmark can describe an association between the user ID and an ad ID of the ad. The bookmark associator 416 can store the bookmark in the bookmark store 159.

FIG. 5 is a block diagram 500 illustrating various interactions between an example bookmark server module 502, an example bookmark retriever module 504, and other components of the example system. In some embodiments, the ad retrieving module 212 can be implemented using a server-client structure, and include the bookmark server module 502 stored in the server 101 and the bookmark retriever module 504 stored in the mobile computing system 135 or the client device 115.

The bookmark retriever module 504 can include software and/or logic executable by a processor 235 of the computing device 200 to generate a bookmark retrieval request. In some embodiments, the bookmark retriever module 504 can receive a request from a user for retrieving one or more bookmarked ads. For example, the bookmark retriever module 504 can receive a request for retrieving bookmarked ads from an input device 506 (e.g., a touch screen 408). The bookmark retriever module 504 can receive a user ID identifying the user from the user identification module 204, which can determine the user's identity including the user ID based on data received from one or more sensors 140a . . . 140n, and/or identification information input by a user using an input device. The bookmark retriever module 504 can generate a bookmark retrieval request for retrieving ads bookmarked by the user from the server 101 via the network 105. The bookmark retrieval request can include the user ID.

In some embodiments, the bookmark retriever module 504 can receive sensor data including location data from a sensor 140 (e.g., a GPS sensor). The location data can describe a current location of the client device 115 such as the user's cell phone or a current location of the mobile computing system 135 of the user's vehicle. The location data can represent a current location of that device or system. The bookmark retriever module 504 can generate a bookmark retrieval request including the user ID and the location data. In some additional embodiments, the bookmark retriever module 504 can identify one or more places corresponding to the location data. For example, the bookmark retriever module 504 can cross-reference the location data with the place data repository 129 to identify one or more places at or near a place, destination, waypoint, starting point, a route, etc., associated with the location data. The bookmark retriever module 504 can generate a bookmark retrieval request including the user ID, the location data, and the one or more identified places.

In some embodiments, the bookmark retriever module 504 can receive query data from a user via an input device 506 (e.g., a software keyboard). In some examples, the query data can include search text including a keyword or a partially-inputted keyword. The bookmark retriever module 504 can generate a bookmark retrieval request including the user ID and the search text. In some examples, the query data can include a category selected by the user. Example categories can include, but are not limited to, sports, restaurants, hotels, stores, businesses, etc. The bookmark retriever module 504 can generate a bookmark retrieval request including the user ID and the category.

The bookmark retriever module 504 can send the bookmark retrieval request to the bookmark server module 502 via the network 105. In response, the bookmark retriever module 504 can receive ad content describing bookmarked ads that match the bookmark retrieval request from the bookmark server module 502 via the network 105. The bookmark retriever module 504 can send the ad content to the digital content application 107b, causing the digital content application 107b to present the bookmarked ads to the user using the speaker system 117 and/or the display 306. In some embodiments, the bookmarked ads can be presented to the user in a reverse chronological order, so that the ads can be displayed from the most recently bookmarked ad to the oldest bookmarked ad. In some embodiments, the bookmarked ads can be presented to the user based on a list of categories. In some embodiments, the bookmarked ads can be presented to the user based on the user's location and/or places near the user's location. Other variations are also possible.

The bookmark server module 502 can include software and/or logic executable by a processor 235 of the computing device 200 to retrieve bookmarked ads based on a bookmark retrieval request. The bookmark server module 502 can receive a bookmark retrieval request from the bookmark retriever module 504 via the network 105. In some embodiments, the bookmark retrieval request can include a user ID. The bookmark server module 502 can retrieve bookmarks associated with the user ID from the bookmark store 159, identify ads referenced in the bookmarks and retrieve ad content describing the bookmarked ads from the ad inventory 119. The bookmark server module 502 can send the bookmarked ads to the bookmark retriever module 504 via the network 105 for processing and/or presentation to the user. In some embodiments, the bookmark server module 502, bookmark retriever module 504, or another component may sort the bookmarks based on one or more criteria, including geographic proximity, relevance, date bookmarked, interestingness, name, or another criteria.

In some embodiments, the bookmark retrieval request can include a user ID and location data identifying a location associated with the user. The bookmark server module 502 can retrieve a set of bookmarks associated with the user ID from the bookmark store 159 referencing a corresponding set of ads by ad ID. Using the set of ad IDs and the location data, the bookmark server module 502 can query the ad inventory 119 for one or more bookmarked ads matching a location described the location data. By way of illustration, the one or more bookmarked ads retrieved can include one or more coupons valid for use at the location identified by the location data. The bookmark server module 502 can send data describing one or more bookmarked ads retrieved by the query to the bookmark retriever module 504.

In some embodiments, the bookmark retrieval request can include a user ID and one or more places associated with a location described by the location data. The bookmark server module 502 can retrieve a set of bookmarks associated with the user ID from the bookmark store 159 referencing a corresponding set of ads by ad ID. Using the set of ad IDs and the one or more places, the bookmark server module 502 can query the ad inventory 119 for one or more bookmarked ads matching the one or more places included in the location data. For example, the one or more bookmarked ads matching the places can include one or more deals valid for use in those places. The bookmark server module 502 can send data describing the one or more bookmarked ads matching the one or more places to the bookmark retriever module 504.

In some embodiments, the bookmark retrieval request can include a user ID and search text. The bookmark server module 502 can retrieve a set of bookmarks associated with the user ID from the bookmark store 159 referencing a corresponding set of ads by ad ID. Using the set of ad IDs, the bookmark server module 502 can query the ad inventory 119 for one or more bookmarked ads matching the search text and send data describing the one or more bookmarked ads to the bookmark retriever module 504.

In some embodiments, the bookmark retrieval request can include a user ID and a category. The bookmark server module 502 can retrieve a set of bookmarks associated with the user ID from the bookmark store 159 referencing a corresponding set of ads by ad ID. Using the set of ad IDs, the bookmark server module 502 can query the ad inventory 119 for one or more bookmarked ads matching the category and send data describing the one or more bookmarked ads to the bookmark retriever module 504.

FIG. 6 is a block diagram 600 illustrating various interactions between an action module 214 and other components of the example system. In some embodiments, the action module 214 can include an action signal generator 602, an actionable ad determination module 604, an action detection module 606, an action program loader 608, and an execution module 610.

The action signal generator 602 can include software and/or logic executable by a processor 235 of the computing device 200 to generate an action signal. In some embodiments, a user can provide input requesting an action associated with an ad be performed using an input device (e.g., by pressing a steering wheel button 402 in a vehicle, pressing a software button on a touch screen 408 of the infotainment system in the vehicle, pressing a soft button on a touch screen 408 of a client device 115 such as a cell phone, issuing a voice command via the microphone 404, etc.), which can send the input to the action signal generator 602.

In some embodiments, the action signal generator 602 can receive one or more inputs from one or more of the steering wheel button 402, the voice recognition system 406 and the touch screen 408, and determine an action command to perform an action associated with an ad based on the input(s). The action signal generator 602 can generate an action signal based on the action command requesting action associated with an ad be performed, and send the action signal to the actionable ad determination module 604 and/or the action detection module 606.

The actionable ad determination module 604 can include software and/or logic executable by a processor 235 of the computing device 200 to determine an ad associated with the action to be performed. The actionable ad determination module 604 can receive the action signal from the action signal generator 602. Responsive to receiving the action signal, the actionable ad determination module 604 can retrieve ad content from the content buffer 250, and determine the ad that is associated with an action to be performed based on the ad content. For example, the actionable ad determination module 604 can determine the most recent ad stored in the content buffer 250 as the ad associated with the action to be performed. In another example, the actionable ad determination module 604 can retrieve ad content from the content buffer 250 describing an ad currently being played or recently having been played, and can determine that ad as the ad associated with the action to be performed. The actionable ad determination module 604 can generate ad identification data identifying the ad, and send the ad identification data to the action program loader 608.

The action detection module 606 can include software and/or logic executable by a processor 235 of the computing device 200 to detect an action to be performed. The action detection module 606 can receive an action signal from the action signal generator 602, and identify the action to be performed based on the action signal. The action detection module 606 can generate action data describing the identified action, and send the action data to the action program loader 608.

For example, assume pressing a software button on a touch screen 408 can request setting an address associated with an ad as a new travel destination. The action signal generator 602 can generate an action signal based on the received signal from the touch screen 408. The generated action signal can include data requesting an address associated with an ad as a new travel destination be set. The action detection module 606 can identify the action to be performed as setting an address associated with an ad as a new travel destination based on the action signal. In another example, the action signal generator 602 can generate an action signal based on a press signal from a steering wheel button 402. The press signal can requests to establish a call with a phone number associated with an ad. The action detection module 606 can identify the action to be performed as establishing the call with a phone number associated with an ad based on the action signal.

The action program loader 608 can include software and/or logic executable by a processor 235 of the computing device 200 to generate action instruction(s) for performing an action. The action program loader 608 can receive ad identification data from the actionable ad determination module 604 and the action data from the action detection module 606. The action program loader 608 can retrieve ad content describing the ad identified by the ad identification data from the ad inventory 119. The action program loader 608 can retrieve program data from the program library 169 describing a program for performing an action identified by the action data. In some examples, the retrieved program can be a standard program including one or more standard procedures for carrying out an action.

The action program loader 608 can generate action instruction(s) for performing the action associated with the ad based on the program and the ad content describing the ad. For example, the action program loader 608 can generate action instruction(s) customizing the program based on the ad content. In a further example, assume the action to be performed is to set up a call with a phone number associated with the ad, and the program is a call program for setting up a call. The action program loader 608 can configure instruction(s) instructing the program to establish a call using the phone number associated with the ad. In another example, assume the action to be performed is to set an address associated with the ad as a new destination, and the program is a navigation application 107a. The action program loader 608 can configure instruction(s) instructing the navigation application 107a to set the address associated with the ad as a destination and provide turn-by-turn directions to that address. The action program loader 608 can send the action instruction(s) to the execution module 610.

The execution module 610 can include software and/or logic executable by a processor 235 of the computing device 200 to execute action instruction(s). The execution module 610 can receive a user ID identifying the user from the user identification module 204 and the action instructions from the action program loader 608. The execution module 610 can execute the action instruction(s) to carry out the action for the user using one or more applications 107. For example, assume the action instruction(s) include instructions for setting up a call with a phone number associated with the ad. The execution module 610 can execute the action instructions by instructing a call application to automatically establish a call with the phone number associated with the ad, and the application may respond accordingly. In another example, assume the action instructions can include instructions for setting an address associated with the ad as a new destination. The execution module 610 can execute the action instructions instructing the navigation application 107a to automatically set a new destination as the address associated with the ad and provide navigation instructions to the user, and the application may respond accordingly.

In some embodiments, all components of the action module 214 can be stored in a single device or system such as the client device 115, the server 101, or the mobile computing system 135. In some embodiments, components of the action module 214 can be distributed across one or more of the client device 115, the server 101, the ad server 120, and the mobile computing system 135. For example, the action signal generator 602 and the action detection module 606 can be stored in the client device 115, and the actionable ad determination module 604, the action program loader 608, and the execution module 610 can be stored in the mobile computing system 135. In this example, the user can issue a command to perform an action associated with an ad using the client device 115 and the action to be performed can be identified in the client device 115. The client device 115 can send the identified action to the mobile computing system 135 for performance of the action. In some embodiments, the action instructions for carrying out the action can be executed in the mobile computing system 135 such as a vehicle using in-vehicle applications 107.

### Methods

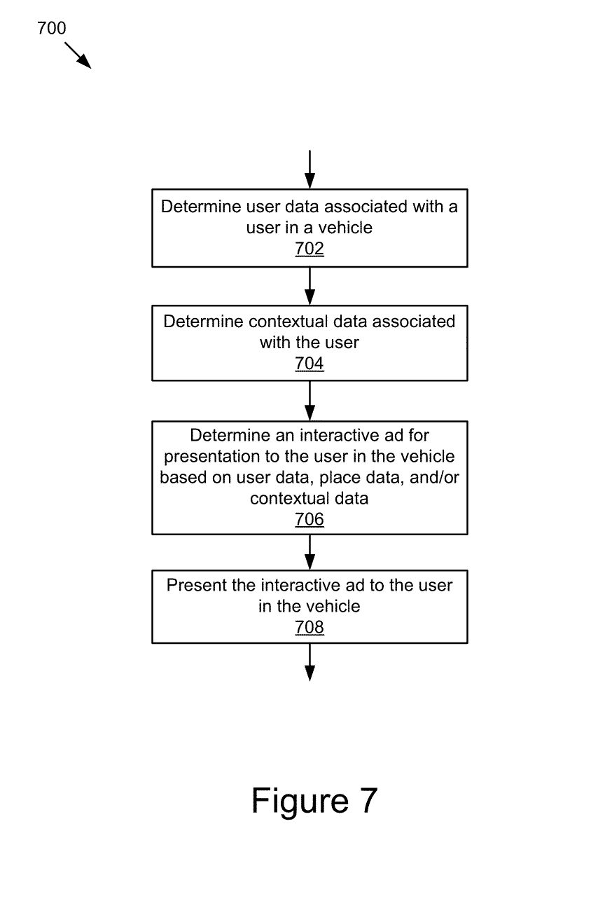

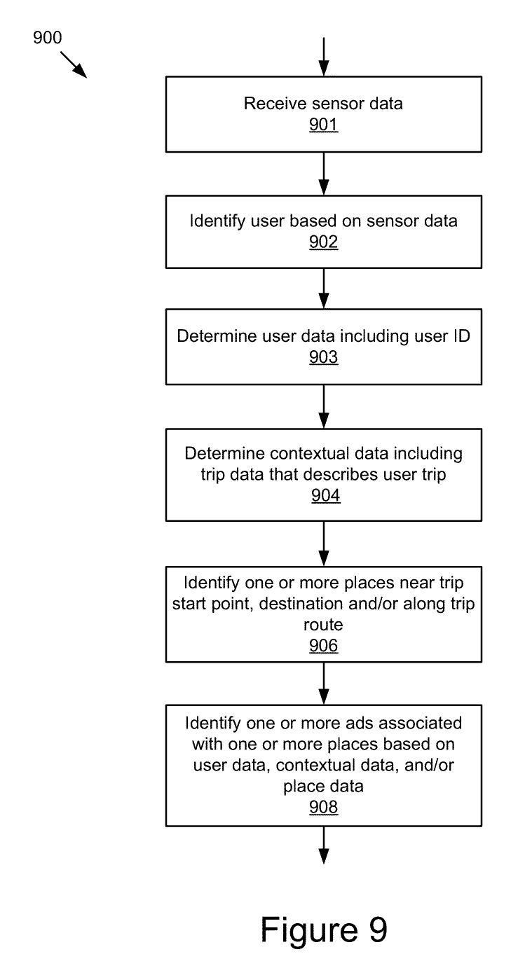

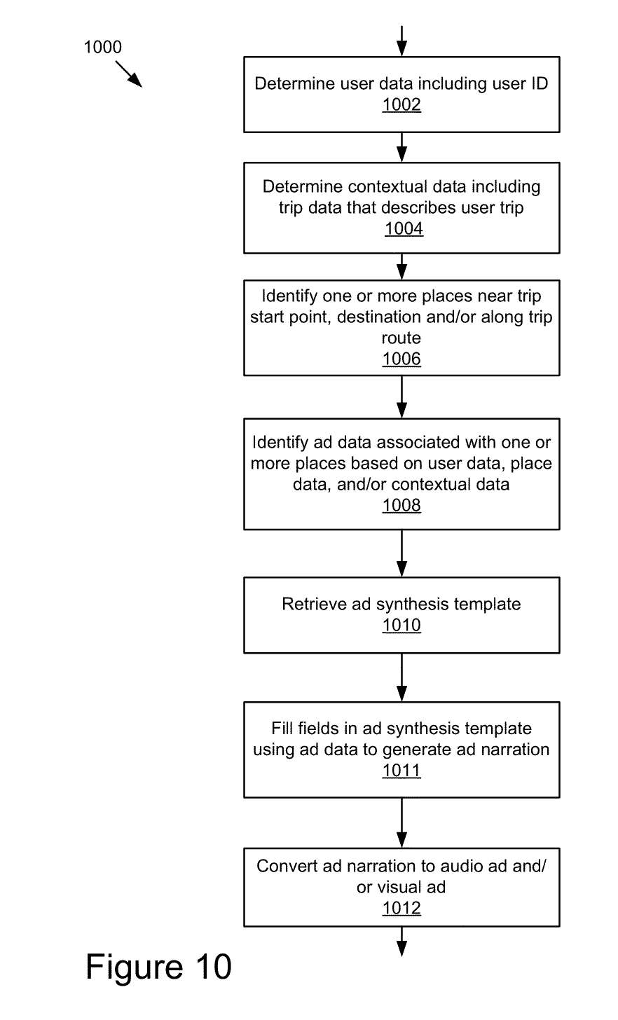

FIG. 7 is a flowchart of an example method 700 for delivering an interactive ad to a user in a vehicle. The user identification module 204 can determine 702 user data associated with a user in a vehicle. For example, the user identification module 204 can determine a user profile associated with a user sitting in a vehicle. The user can be a driver or a passenger in the vehicle. The context module 206 can determine 704 contextual data associated with the user. The ad determination module 208 can determine 706 an interactive ad for presentation to the user in the vehicle based on the user data and/or the contextual data. Example methods for determining an interactive ad are discussed elsewhere herein, such as with reference to at least FIGS. 9 and 10. The digital content application 107b can present 708 the interactive ad to the user in the vehicle via a screen located in a console of the vehicle, to the user sitting in a vehicle on a client device 115 associated with the user, etc.

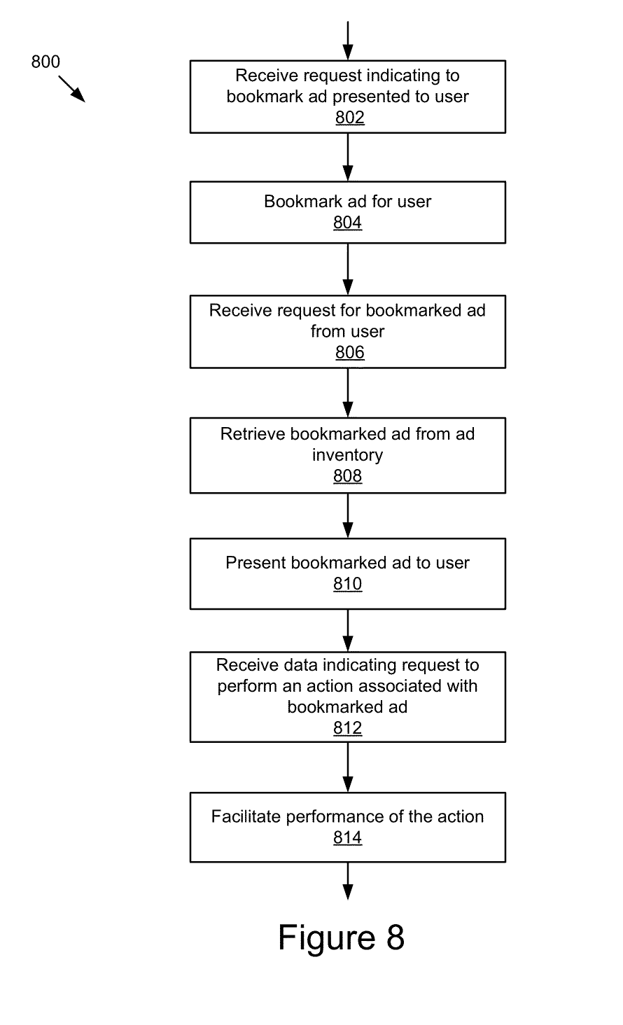

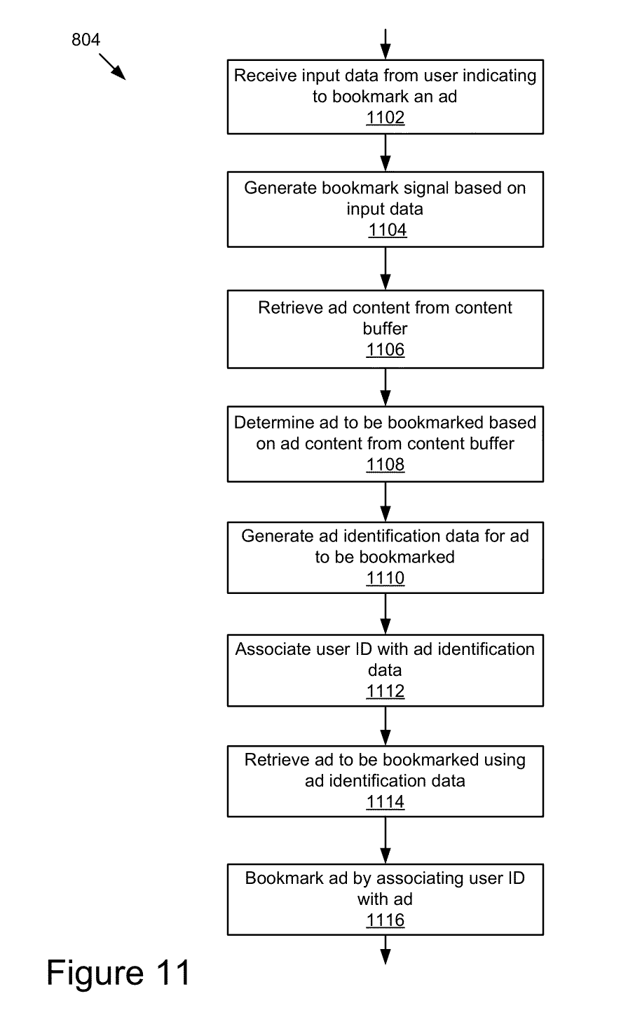

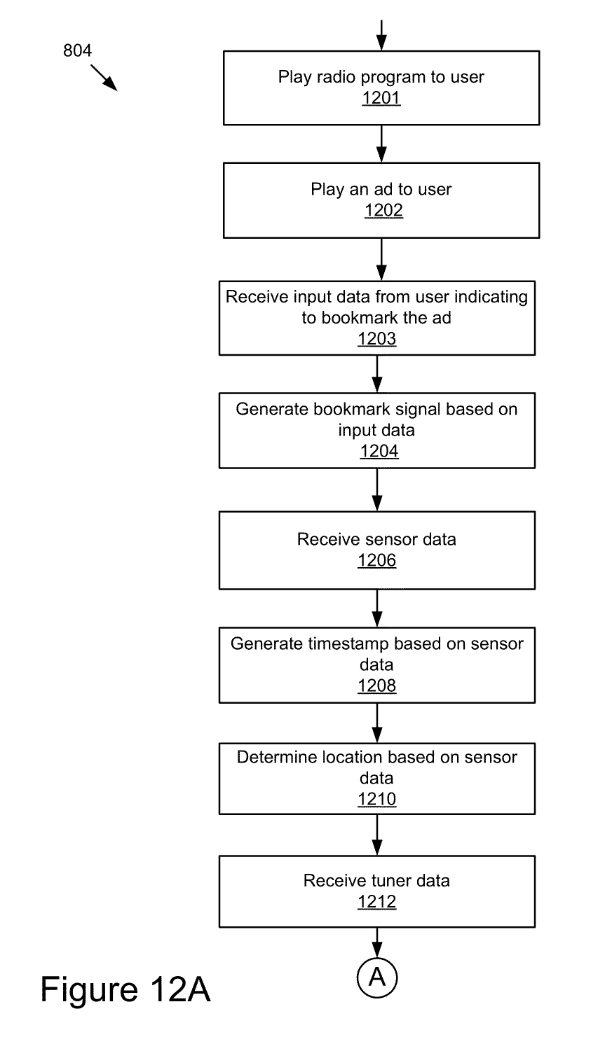

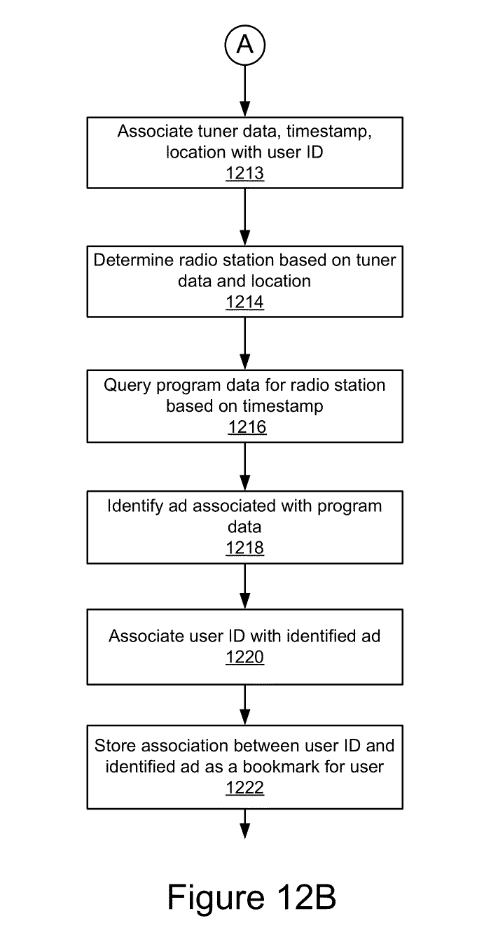

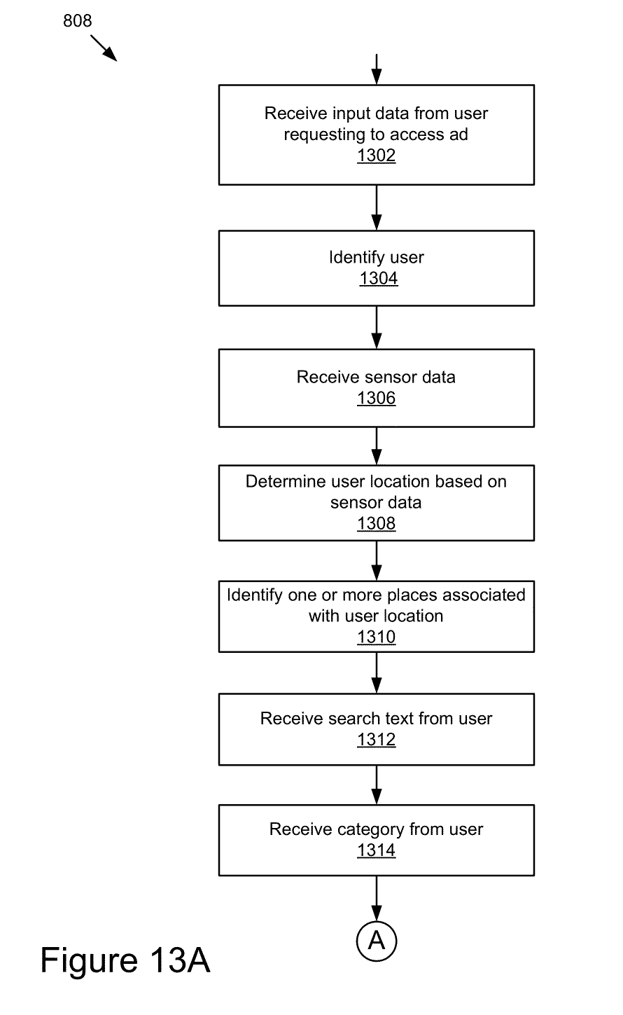

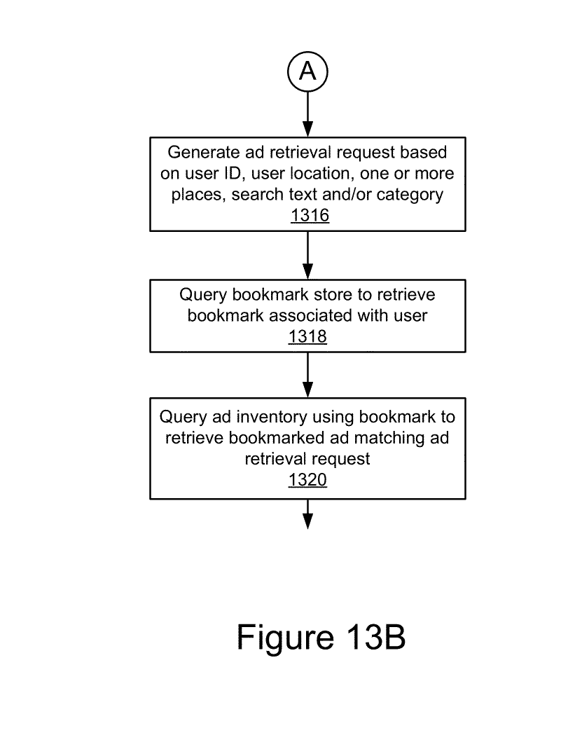

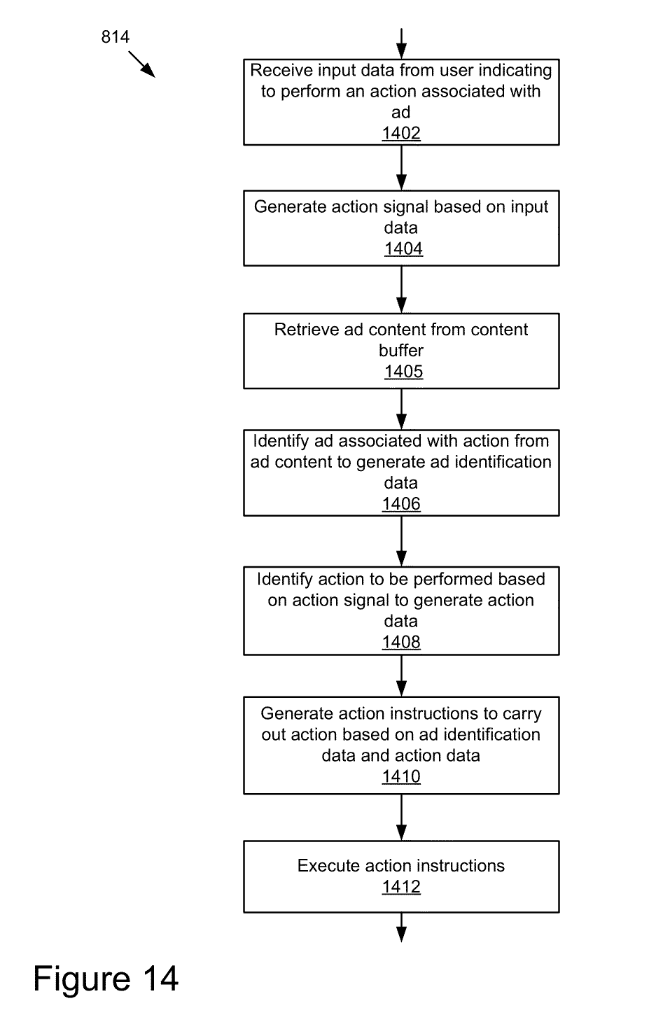

FIG. 8 is a flowchart of an example method 800 for interacting with an interactive ad. The communication module 202 can receive 802 a request from a user requesting to bookmark an ad presented to the user. The bookmark module 210 can bookmark 804 the ad for the user. Example methods for bookmarking the ad are discussed elsewhere herein, such as with reference to at least FIGS. 11-12B. After the ad has been bookmarked, the user can access the bookmarked ad using a client device 115, the mobile computing system 135, etc. The communication module 202 can receive 806 a request for retrieving the bookmarked ad from the user. The ad retrieving module 212 can retrieve 808 the bookmarked ad from the ad inventory 119. Example methods for retrieving the bookmarked ad are discussed elsewhere herein, such as with reference to at least FIGS. 13A and 13B. The digital content application 107b can present 810 the bookmarked ad to the user. The communication module 202 can receive 812 data requesting to perform an action associated with the bookmarked ad from the user. The action module 214 can facilitate 814 performance of the action for the user, as discussed elsewhere herein. Example methods for facilitating performance of an action are discussed elsewhere herein, such as with reference to at least FIG. 14.

FIG. 9 is a flowchart of an example method 900 for determining an ad for a user. The communication module 202 can receive 901 sensor data from one or more sensors 140. The user identification module 204 can identify 902 a user based on the sensor data and/or other identifying data. The user identification module 204 can determine 903 user data associated with the user. The user data can include a user ID identifying the user. The context module 206 can determine 904 contextual data including trip data describing a trip taken/being taken/to be taken by the user. The ad determination module 208 can identify 906 one or more places near a start point, a destination and/or along a travel route of the current trip. The ad determination module 208 can identify 908 one or more ads associated with the one or more places based on the place data, the user data, and/or the contextual data. For example, the ad determination module 208 can identify one or more ads describing one or more deals being offered by the one or more places.

FIG. 10 is a flowchart of an example method 1000 for determining an ad for a user. The user identification module 204 can determine 1002 user data including a user ID identifying a user. The context module 206 can determine 1004 contextual data including trip data that can describe a trip associated with a user. The ad determination module 208 can identify 1006 one or more places near a start point, a destination, along a route of the trip, etc. The ad determination module 208 can identify 1008 ad textual data associated with the one or more places based on the user data and/or the contextual data. The communication module 202 can retrieve 1010 an ad synthesis template from the template repository 149. The ad determination module 208 can fill 1011 fields in the ad synthesis template using the ad textual data to generate an ad narration. The ad determination module 208 can convert 1012 the ad narration to an audio ad, a visual ad, and/or an ad with both audio data and visual data.

FIG. 11 is a flowchart of an example method 804 for bookmarking an ad for a user. The bookmark signal generator 410 can receive 1102 input data from a user requesting to bookmark an ad. The bookmark signal generator 410 can generate 1104 a bookmark signal based on the input data. The bookmarked ad determination module 412 can retrieve 1106 ad content from the content buffer 250. The bookmarked ad determination module 412 can determine 1108 an ad to be bookmarked based on the ad content from the content buffer 250. The bookmarked ad determination module 412 can generate 1110 ad identification data for identifying the ad to be bookmarked. The user-ad associator 414 can associate 1112 a user ID identifying the user with the ad identification data. The bookmark associator 416 can in some cases retrieve 1114 the ad to be bookmarked from the ad inventory 119 using the ad identification data (e.g. to verify the ad). The bookmark associator 416 can bookmark 1116 the ad for the user by associating the user ID with the ad.

FIGS. 12A and 12B are flowcharts of an example method 804 for bookmarking an ad for a user. Referring to FIG. 12A, a user can select a radio station to listen to using a radio tuner 452. A radio or the digital content application 107b can play 1201a radio program broadcasted by the radio station for the user. The radio or the digital content application 107b can play 1202 an ad as part of the radio program. The bookmark signal generator 410 can receive 1203 input data from the user requesting to bookmark the ad and generate 1204 a bookmark signal based on the input data. The timestamp module 454 can receive 1206 sensor data from one or more sensors 140, and generate 1208 a timestamp based on the sensor data. The user-ad associator 414 can receive sensor data including location data from one or more sensors 140 or another location-determining component. The user-ad associator 414 can determine 1210 a location associated with the user based on the sensor data. The user-ad associator 414 can receive 1212 tuner data describing the radio station from the radio tuner 452.

Referring to FIG. 12B, the user-ad associator 414 can associate 1213 the tuner data, the timestamp, and/or the location with the user ID. The bookmark associator 416 can determine 1214 the radio station based on the tuner data and/or the location. For example, the bookmark associator 416 can determine the radio station as a local FM radio station in a particular city based on the tuner data and the location. The bookmark associator 416 can query 1216 program data stored in the radio program storage 316 to identify which radio program associated with the radio station is was broadcast at the time indicated by the timestamp, and more particularly identify 1218 the ad played at the time indicated by the timestamp. The bookmark associator 416 can associate 1220 the user ID with the identified ad. The bookmark associator 416 can store 1222 the association between the user ID and the identified ad as a bookmark for the user.

FIGS. 13A and 13B are flowcharts of an example method 808 for accessing an advertisement bookmarked by a user. Referring to FIG. 13A, the bookmark retriever module 504 can receive 1302 input data from a user requesting to access ads. The user identification module 204 can identify 1304 the user. The bookmark retriever module 504 can receive 1306 sensor data including location data from one or more sensors 140. The bookmark retriever module 504 can determine 1308 the user location based on the sensor data. The bookmark retriever module 504 can identify 1310 one or more places associated with the user location from the place data repository 129. In some embodiments, the bookmark retriever module 504 can receive 1312 search criterion/criteria from the user. In some embodiments, the bookmark retriever module 504 can receive 1314 a category inputted by the user.

Referring to FIG. 13B, the bookmark retriever module 504 can generate 1316 an ad retrieval request based on one or more of the user ID, the user location, the one or more places, the search text, and the category. The bookmark server module 502 can query 1318 the bookmark store 159 to retrieve bookmarks associated with the user ID. The bookmark server module 502 can query 1320 the ad inventory 119 using the bookmarks and one or more criteria from the ad retrieval request from the ad inventory 119 for matching set of ads.

FIG. 14 is a flowchart of an example method 814 for facilitating performance of an action associated with an ad. The action signal generator 602 can receive 1402 input data from a user requesting to perform an action associated with an ad. The action signal generator 602 can generate 1404 an action signal based on the input data. The actionable ad determination module 604 can retrieve 1405 ad content from the content buffer 250. The actionable ad determination module 604 can identify 1406 the ad associated with the action based on the ad content and generate ad identification data for identifying the ad. The action detection module 606 can identify 1408 the action to be performed based on the action signal and generate action data describing the action to be performed. The action program loader 608 can generate 1410 action instructions to carry out the action based on the ad identification data and the action data. The execution module 610 can execute 1412 the action instructions to perform the action using one or more applications 107.

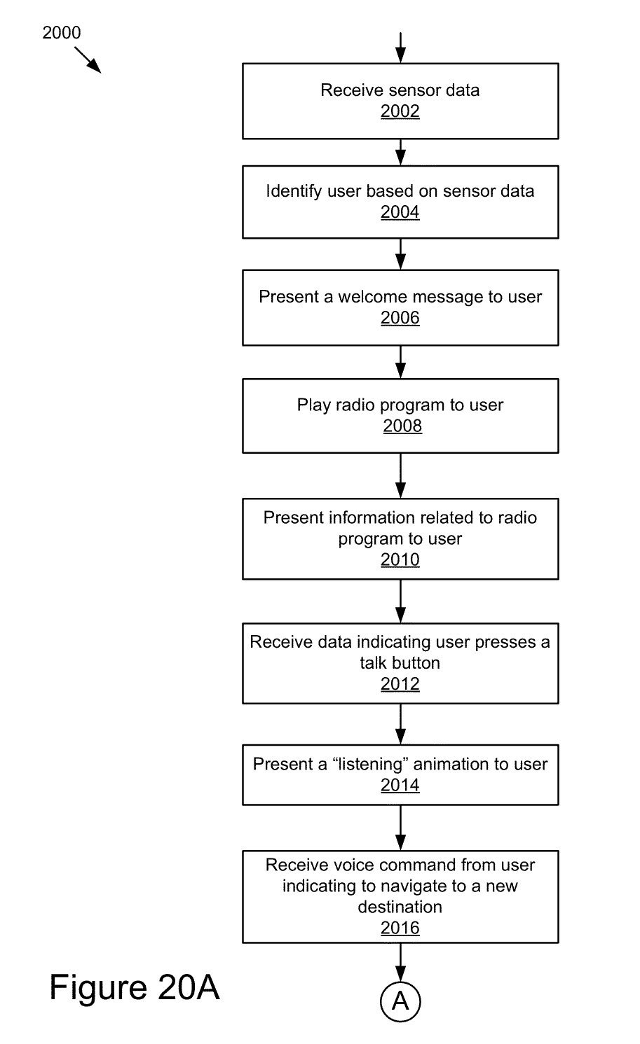

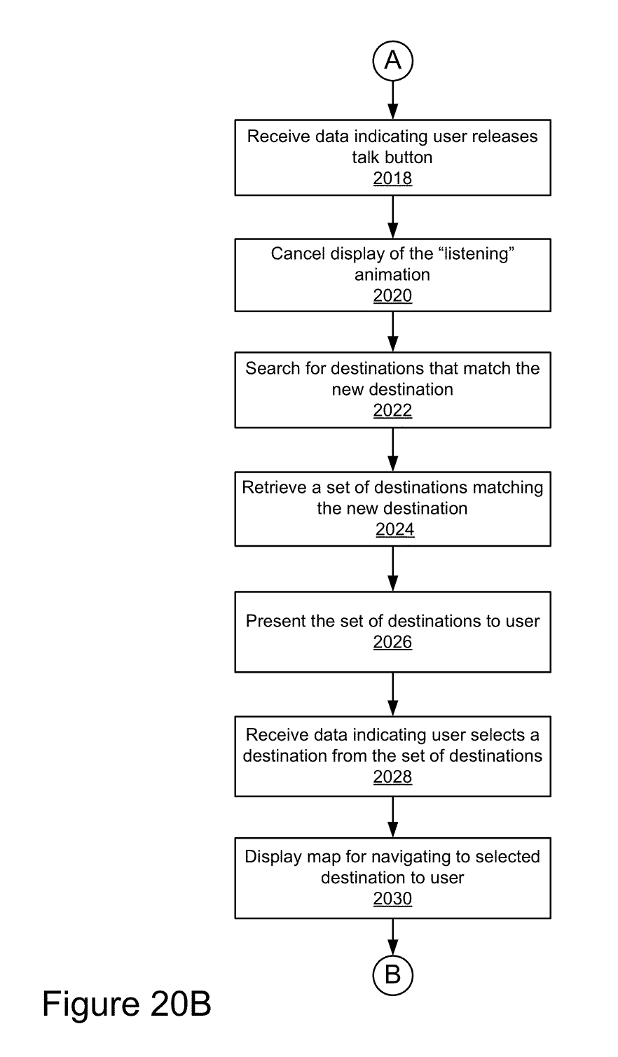

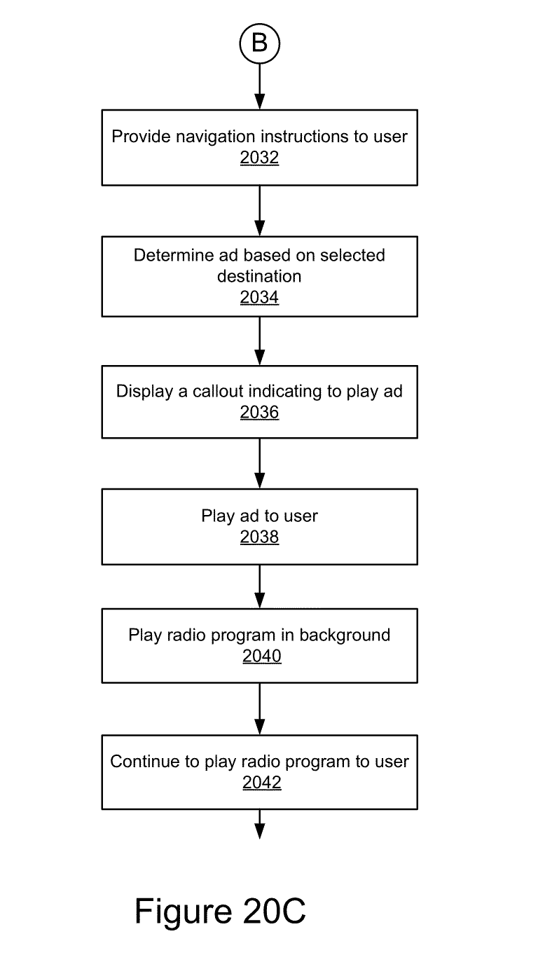

FIGS. 20A-20C are flowcharts of an example method 2000 for providing a targeted ad impression in a vehicle. Referring to FIG. 20A, the ad manager 109 can receive 2002 sensor data from one or more sensors 140. The ad manager 109 can 2004 identify a user based on the sensor data. The ad manager 109 can present 2006 a welcome message to the user on a display device 306. The digital content application 107b can play 2008 a radio program to the user using the speaker system 117. The digital content application 107b can present 2010 information related to the radio program to the user on the display device 306. The ad manager 109 can receive 2012 data indicating the user has pressed a talk button. The ad manager 109 can present 2014 a “listening” animation to the user on the display device 306. The voice recognition system 406 can receive 2016 a voice command from the user via the microphone 404, where the voice command can request navigating to a new destination.

Referring to FIG. 20B, the ad manager 109 can receive 2018 data indicating the has user released the talk button. In response to this, or in response to a predetermined period of silence after the voice command, the ad manager 109 can cancel 2020 the display of the “listening” animation on the display device 306. The voice recognition system 406 can interpret the voice command and send the interpreted command to the ad manger 109 to carry out a corresponding action. In some embodiments, the ad manager 109 can instruct an application 107n, such as a search or navigation application, to search 2022 for destinations that match the new destination provided by the user. That application can retrieve 2024 a set of destinations matching the new destination from a local storage, the server 101, a map server (not shown), etc., and can present 2026 the set of destinations to the user using a user interface. The application can receive 2028 data selecting a destination from the set of destinations and the application can display 2030 a map for navigating to the selected destination to the user via a display device and/or provide 2032 navigation instructions to the user for navigating to the selected destination, as depicted in FIG. 20C.

The user can start to navigate the vehicle to the selected destination. The ad manager 109 can determine 2034 an ad for the user based on the selected destination. For example, the ad manager 109 can determine an ad describing a deal related to the selected destination for the user. The ad manager 109 can display 2036 a callout indicating to play the ad. The digital content application 107b can play 2038 the ad to the user using the speaker system 117 and/or the display device 306. Meanwhile, the digital content application 107b can play 2040 the radio program in the background, but the radio program, pause the radio program, etc. The user can continue to navigate to the selected destination. After playing the ad, the digital content application 107b can continue 2042 to play the radio program to the user.

### Graphic Representations

FIGS. 15A-15C are graphic representations 1500, 1540 and 1570 illustrating various example user interfaces presented to users. Referring to FIG. 15A, the example user interface can include a console and/or head unit screen 1502 and a control panel 1509 including with software and/or hardware buttons 1503-1508. The control panel may, in some embodiments, be mounted on the console, the steering wheel, or another component of the vehicle. The button 1504 can represent a push-to-talk button that can initiate a speech command to the voice recognition system 406 of a vehicle. When the push-to-talk button 1504 is pressed down, a “listening” pop-up can be shown in the head-unit screen 1502. The button 1503 can represent a button for adjusting the volume. The button 1505 can represent a button for navigating to a previous item. The button 1506 can represent a button for navigating to a next item. The button 1507 can represent a “cancel/no/decline” button. The button 1507 can be used to decline saving an ad or to cancel an already saved ad. The button 1508 can represent an “OK/yes/affirmative” button. A user can use the button 1508 to select an item or save an ad.

Referring to FIG. 15B, the example user interface can include a top-level menu 1542, a sub-menu 1544, and a display space 1546 for displaying content. The top-level menu 1542 can include three or more menu items, such as places, people, and music. If a menu item in the top-level menu 1542 or the sub-menu 1544 is selected, the selected menu item can be highlighted in the user interface. If the “people” item is selected, the display space 1546 may display a people screen showing contacts of the user. In some embodiments, the display of the people screen can be optional. If the “music” item is selected, the display space 1546 can show a music screen displaying that, for example, Terrestrial, satellite, or Internet radio is being played. If the “places” menu is selected, the display space 1547 can show a place screen illustrating points of interest (POIs), maps, navigation options, a place search result, etc.

Referring to FIG. 15C, the example user interface can include a navigation bar 1572 with a search option and an app space 1574 for showing a list of items such as a list of bookmarked ads, ad content of an ad, etc.

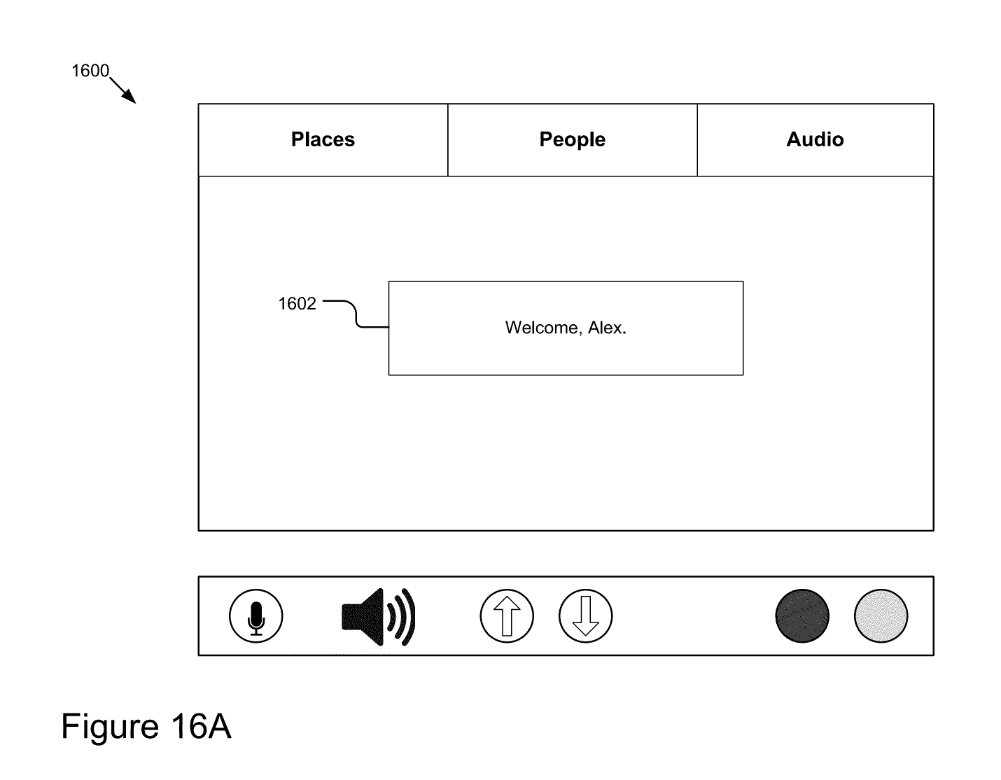

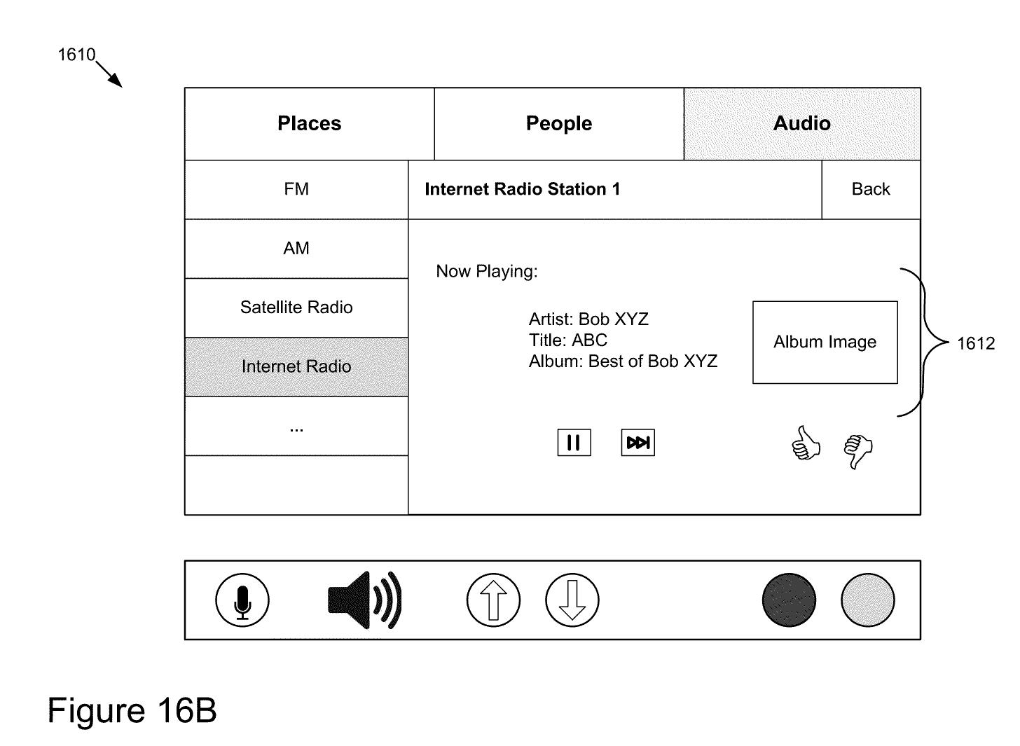

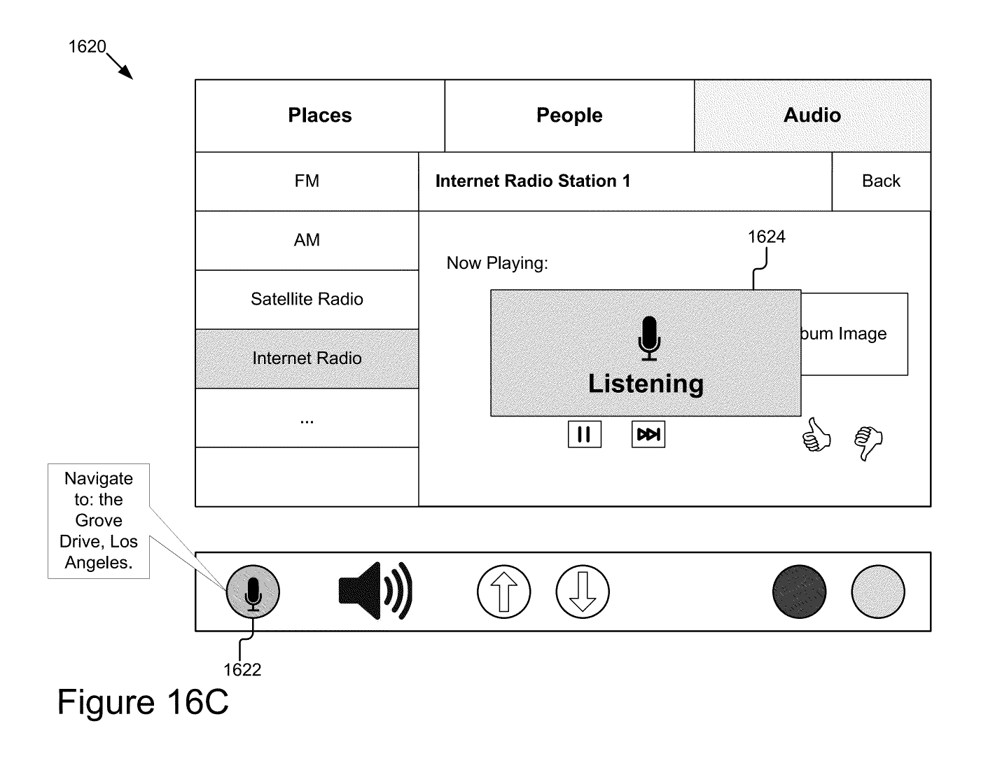

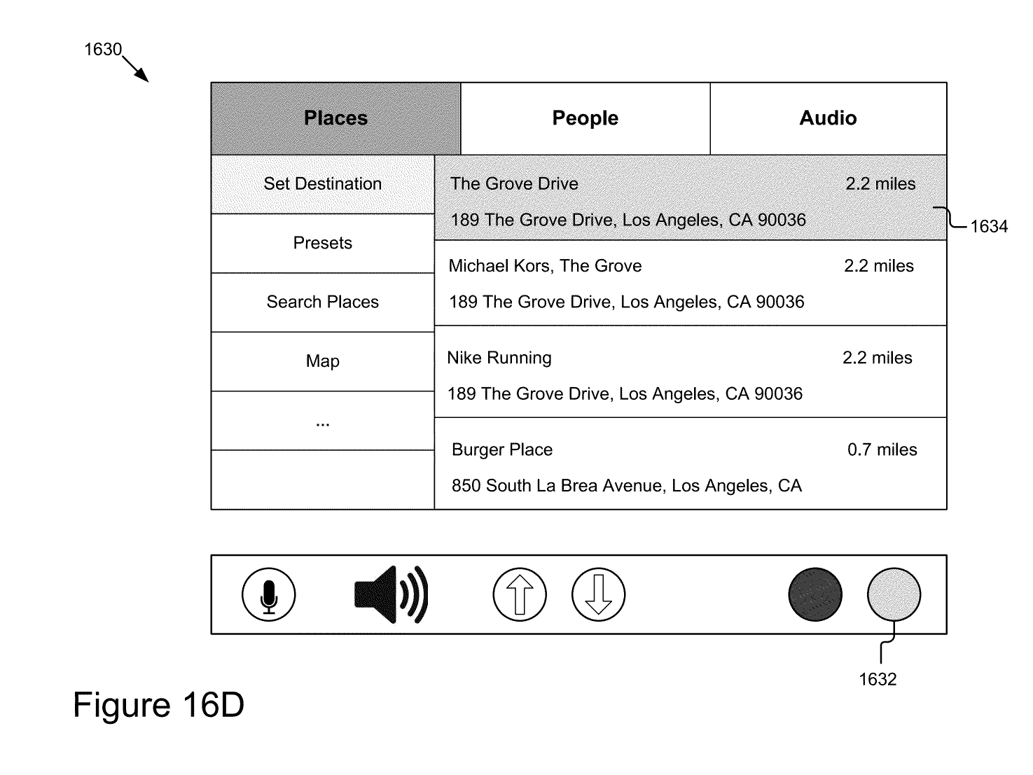

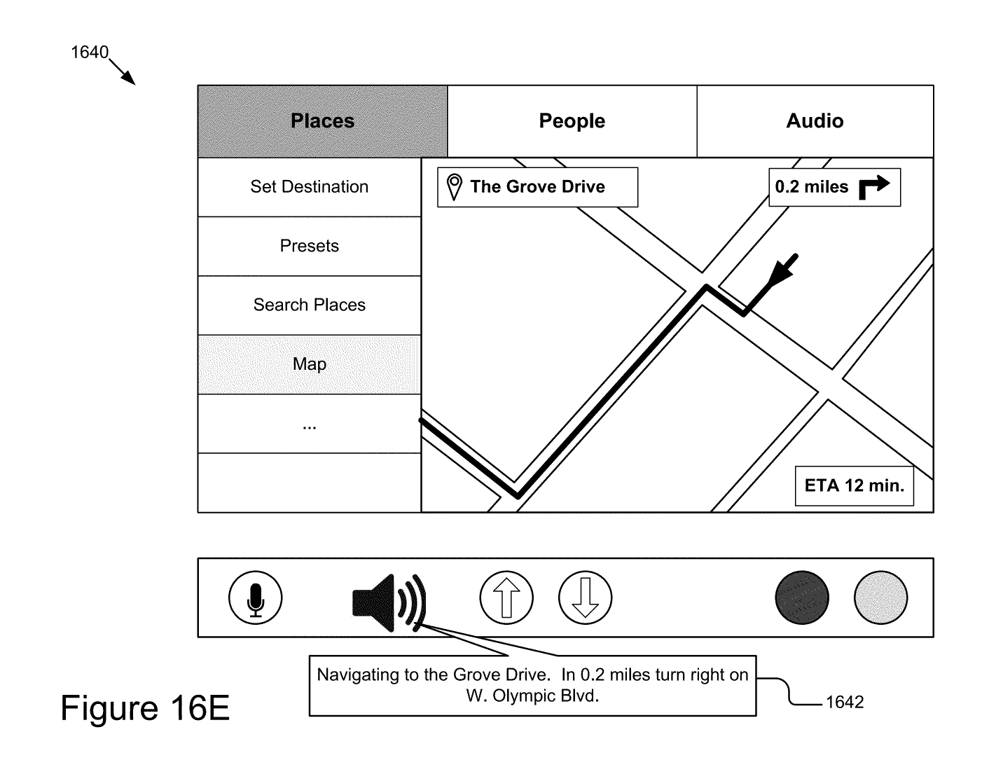

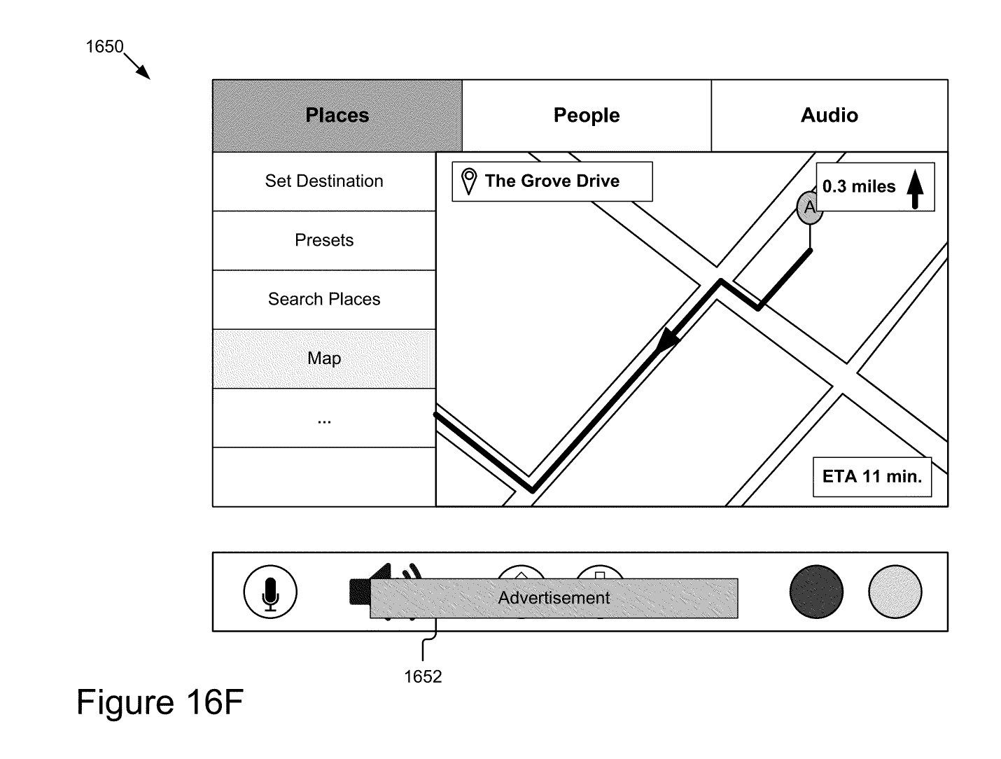

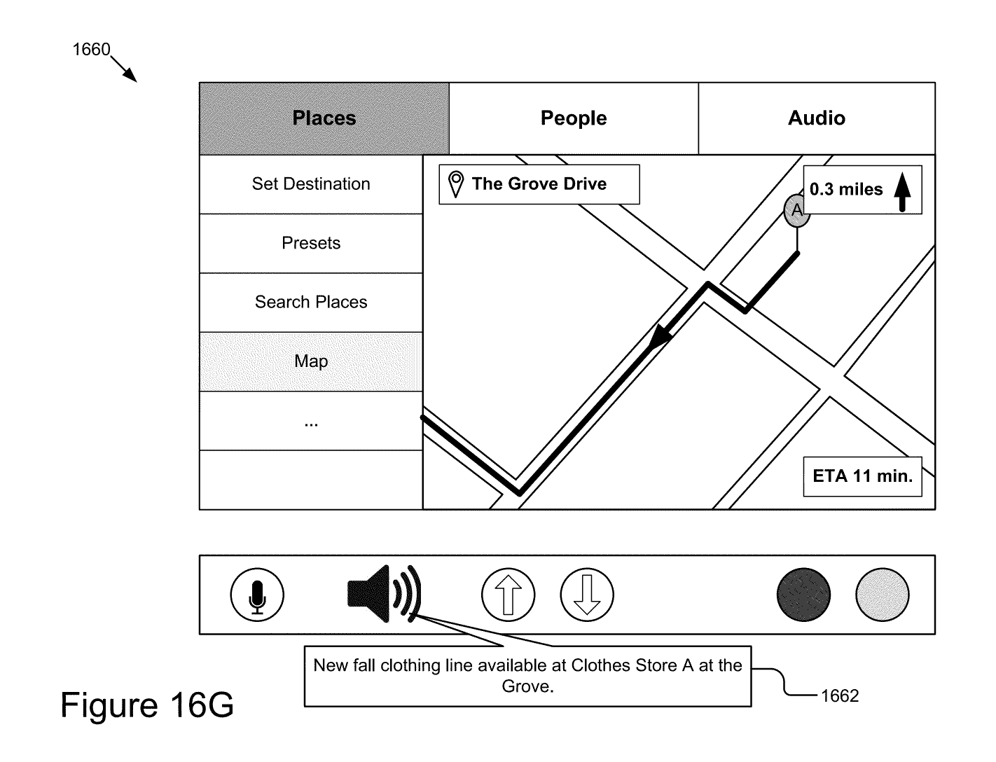

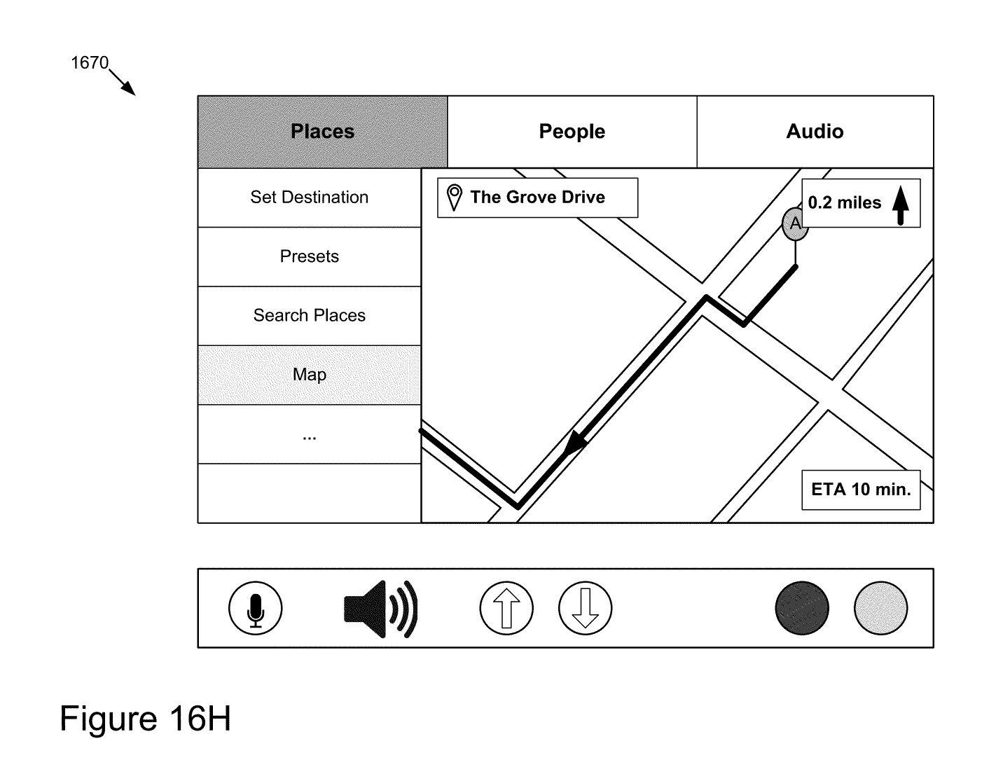

FIGS. 16A-16H, 17A-17H, 18A-18F, and 19A-19F are graphic representations depicting various example user interfaces illustrating various example use cases. FIGS. 16A-16H are graphic representations 1600, 1610, 1620, 1630, 1640, 1650, 1660 and 1670 illustrating an example use case for providing a targeted ad impression in a vehicle. Referring to FIG. 16A, a user can get into a vehicle and turn the ignition on. For example, a user Alex can get into his vehicle on a weekend morning and drive his vehicle to go for shopping. The ad manager 109 can present a welcome message 1602 to the user. Referring to FIG. 16B, the ad manager 109 can instruct the digital content application 107b to automatically play Internet radio for the user based on the user's audio listening history in the vehicle (e.g., based on a previous state, a setting, etc.). The digital content application 107b can display information 1612 describing music broadcasted in Internet radio in the user interface.

Turning to FIG. 16C, the user can press the button 1622 and/or state a certain keyword or phrase (e.g., “hey car”) to issue a voice command. The ad manager 109 can instruct the digital content application 107b to display an animation 1624 indicating the voice recognition system 406 is ready to receive the voice command. The user can speak “navigate to the Grove Drive, Los Angeles”. The user can release the button 1622 or pause after issuing the voice command, and voice recognition system 406 may cancel the animation. Turning to FIG. 16D, the ad manager 109 can the instruct an application 107, such as the navigation application 107a, to search for items matching the user's speech command, and retrieve a search result matching the user's speech command from the navigation application 107a. The search result can include a list of destinations matching the Grove Drive, Los Angeles. The navigation application 107a can rank the list of destinations based on a degree of match between each destination and the voice command. A first destination 1634 can be highlighted as an active selection in the list. For example, the first destination 1634 is ready to be selected by pressing a button 1632. The user can select the first destination 1634 by pressing the button 1632, and the navigation application 107a may navigate to the first destination 1634 as illustrated in FIG. 16E.

FIG. 16E illustrates a map providing turn-by-turn navigation to the Grove Drive. The navigation application 107a can play audio navigation instructions 1642 using the speaker system 117. Meanwhile, music from Internet radio may continue playing. The user continues to travel to the Grove Drive. Referring to FIG. 16F, a message 1652 can be displayed to the user, indicating an ad will be played. For example, a callout “advertisement” can be displayed in the steering wheel panel as music from Internet radio fades out. Referring to FIG. 16G, the ad manager 109 can determine an ad 1662 associated with the destination “Grove Drive” for the user. For example, the ad can be a deal at a store located at the destination. After, while, or before the message 1652 disappears from the steering wheel panel, the ad 1662 can be played to the user. In some cases, a next song can begin playing in the background. In other cases, the next song may be delayed until the ad is over. The user can continue to drive to the destination “Grove Drive” as illustrated in FIG. 16H.

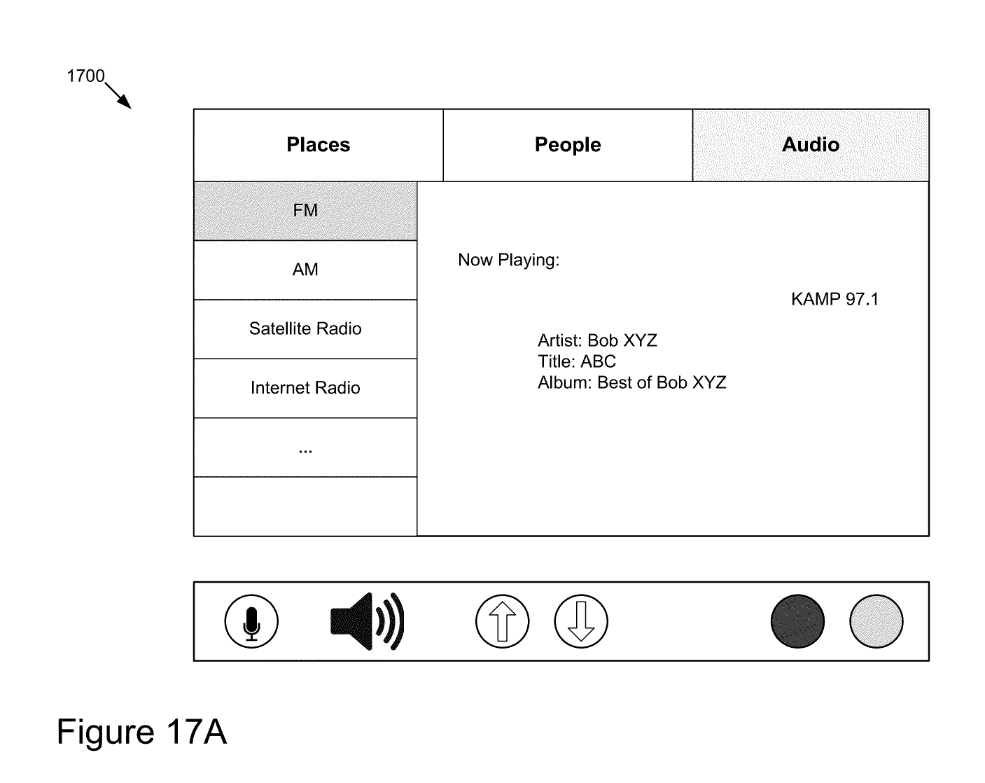

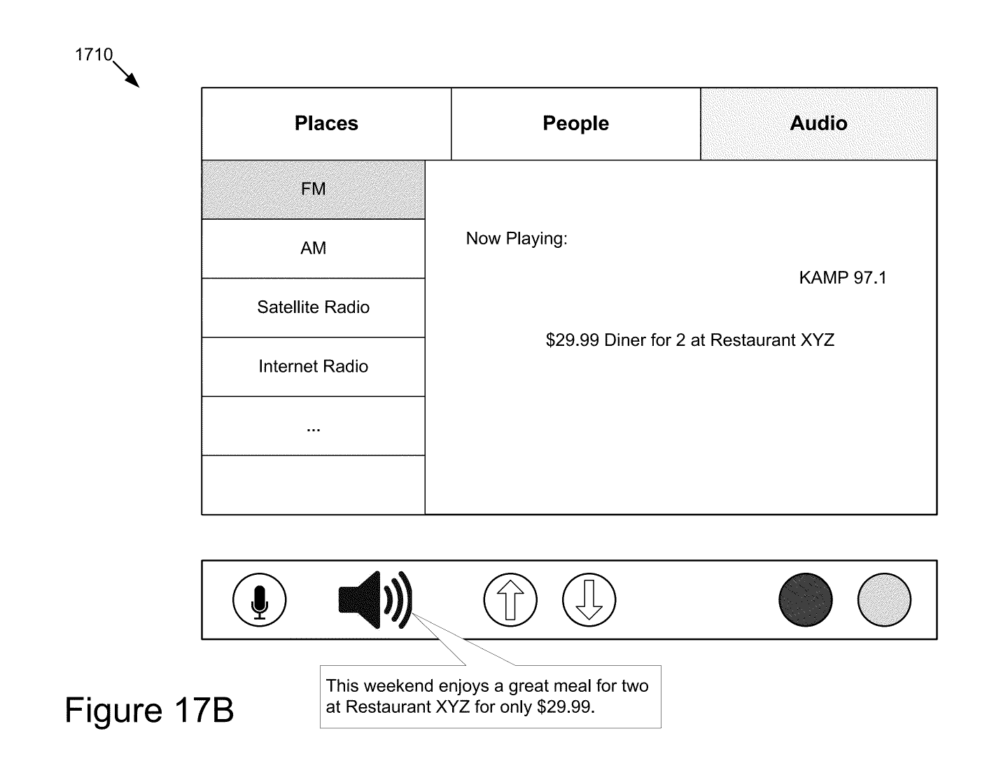

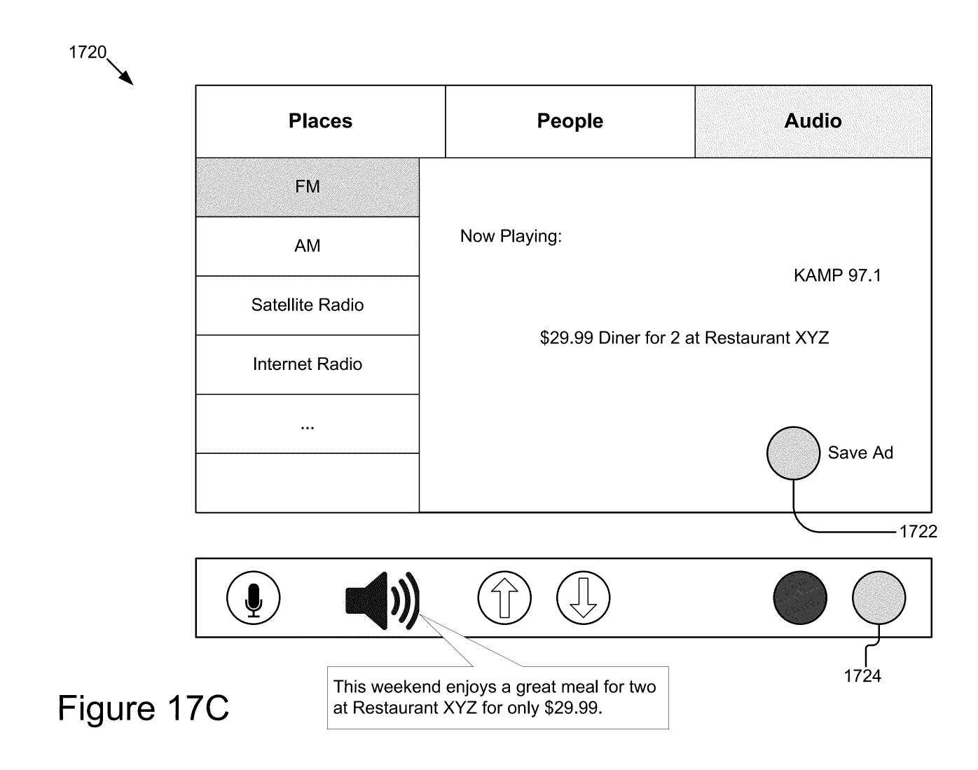

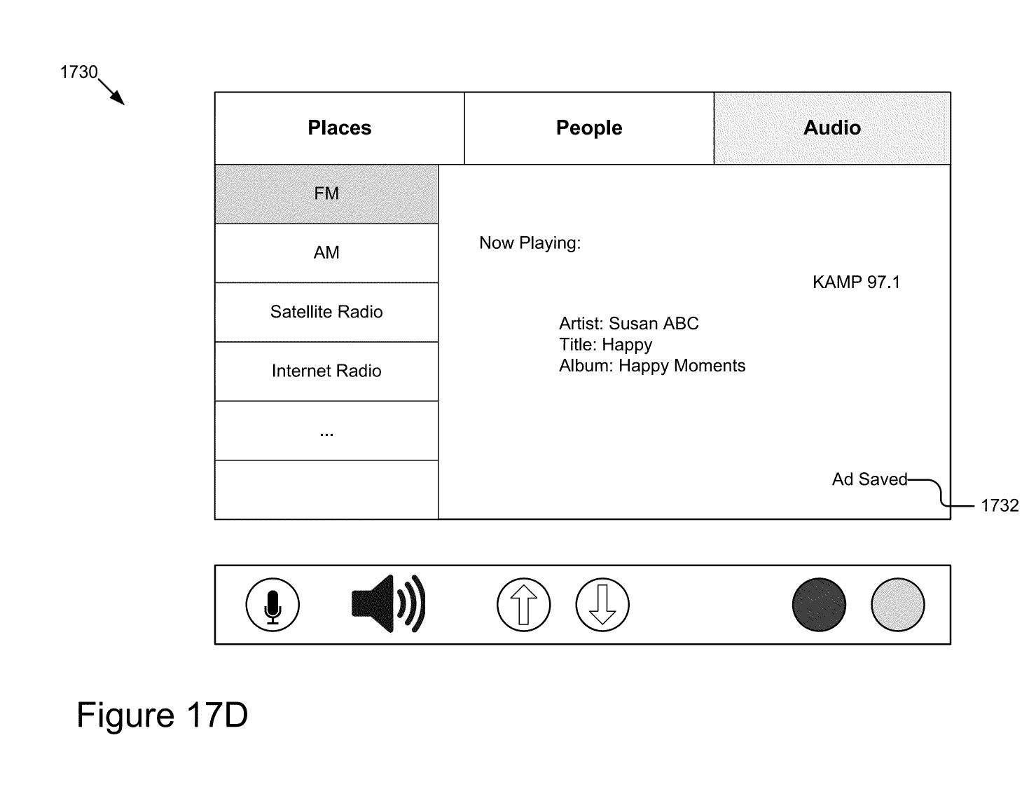

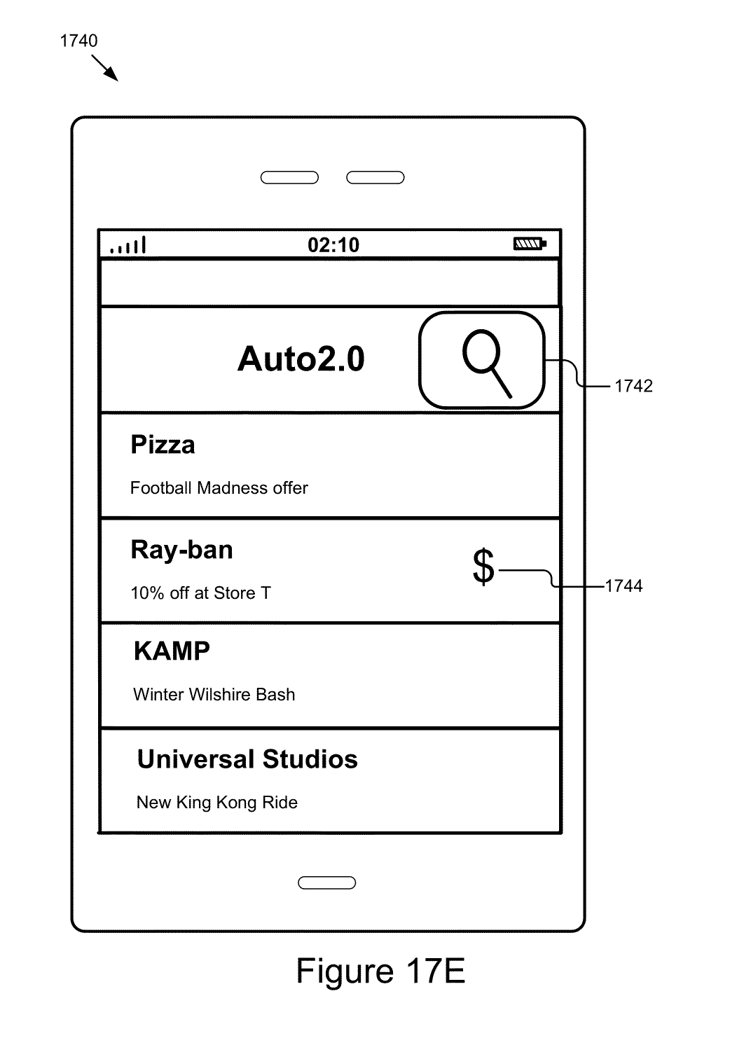

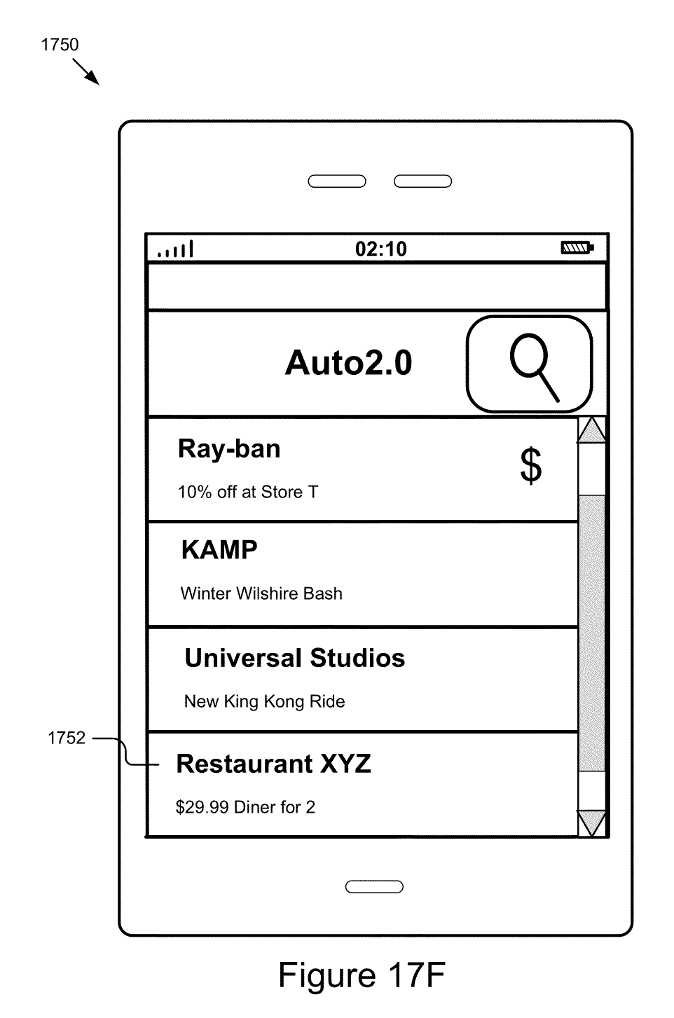

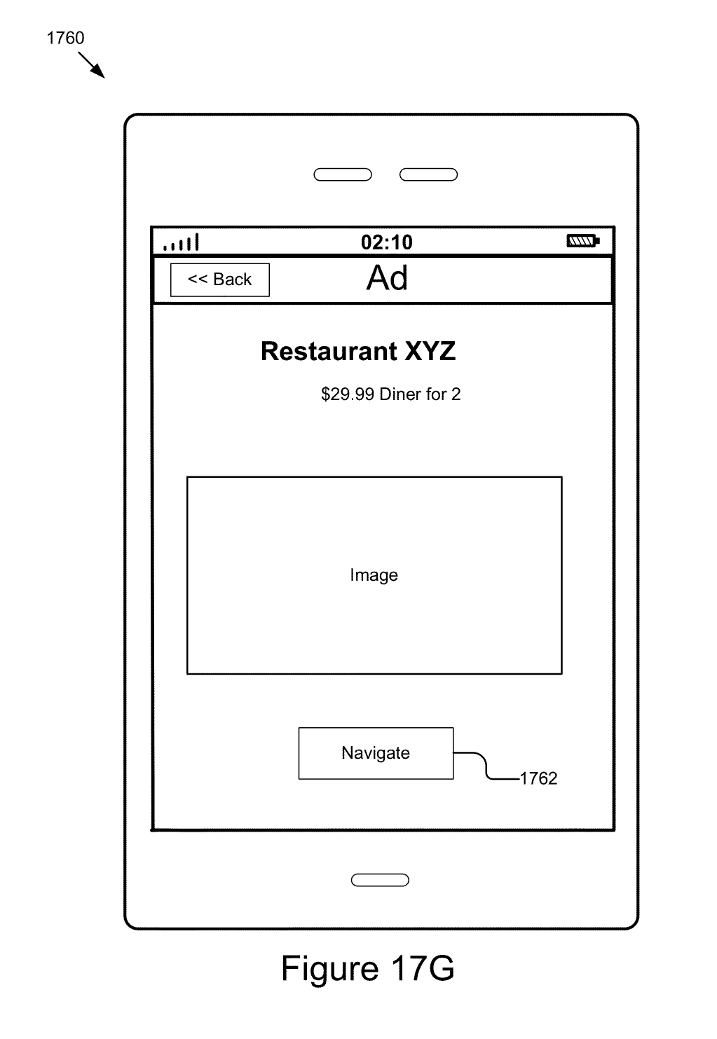

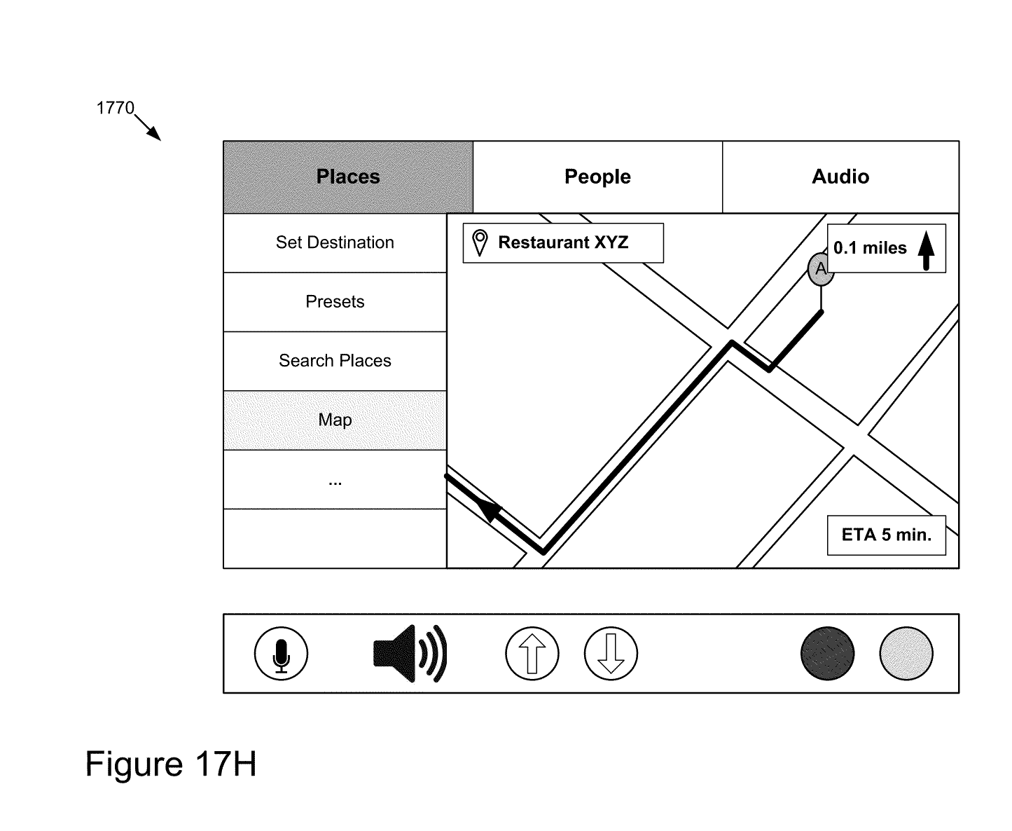

FIGS. 17A-17H are graphic representations 1700, 1710, 1720, 1730, 1740, 1750, 1760 and 1770 illustrating an example use case for engaging with a radio ad. Referring to FIG. 17A, a user is listening to music on a FM radio station on the way back home from work. The example user interface can present information related to a song being played to the user. Referring to FIG. 17B, the ad manager 109 can determine an ad (e.g., an ad for a restaurant) for the user. After the song is over, the ad manager 109 can present the ad to the user as shown in FIG. 17B. For example, the audio portion of the ad can be played to the user using the speaker system 117 and the visual portion of the ad can be displayed in the head unit of the vehicle.

FIG. 17C illustrates a message 1722 including an option to save the ad. The user can save the ad for later access by selecting the option 1722 and/or the button 1724. If the user presses the option 1722 and/or button 1724, the ad can be saved or bookmarked for the user. A message 1732 indicating the ad is saved can be displayed to the user as illustrated in FIG. 17D. The digital content application 107b can continue to play a next song to the user during and/or after the ad is saved.

The user can access the saved ad at any time using his/her client device 115 and/or the mobile computing system 135. FIG. 17E illustrates a user interface listing part of ads saved or bookmarked by the user. The ads can be listed according to the times when the ads were saved, with the most recently saved ad on the top of the list. The user can search for an ad using a button 1742. A “$” symbol 1744 can represent a deal or a coupon.

Referring to FIG. 17F, the user can scroll down the screen of the client device 115 and retrieve a bookmarked ad 1752 (e.g., an ad for a restaurant). The user can select the ad 1752. Ad content forming the ad 1752 can be presented to the user as shown in FIG. 17G. The ad content can include text data, image data audio, video data, and/or user-selectable features/actions, etc. For instance, the user can select a “navigate” button 1762 for setting an address associated with the ad (e.g., a nearest address of the restaurant) as a new destination in the navigation application 107a. As shown in FIG. 17H, the navigation application 107a can provide turn-by-turn instructions to the user for navigating to the address associated with the ad.

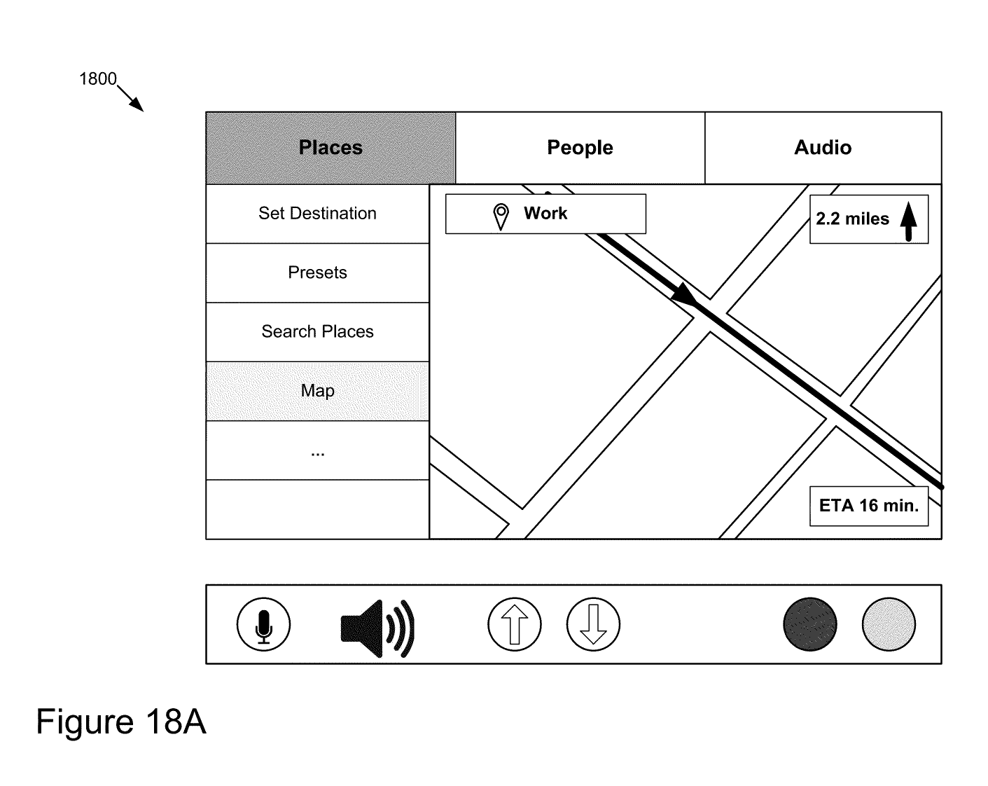

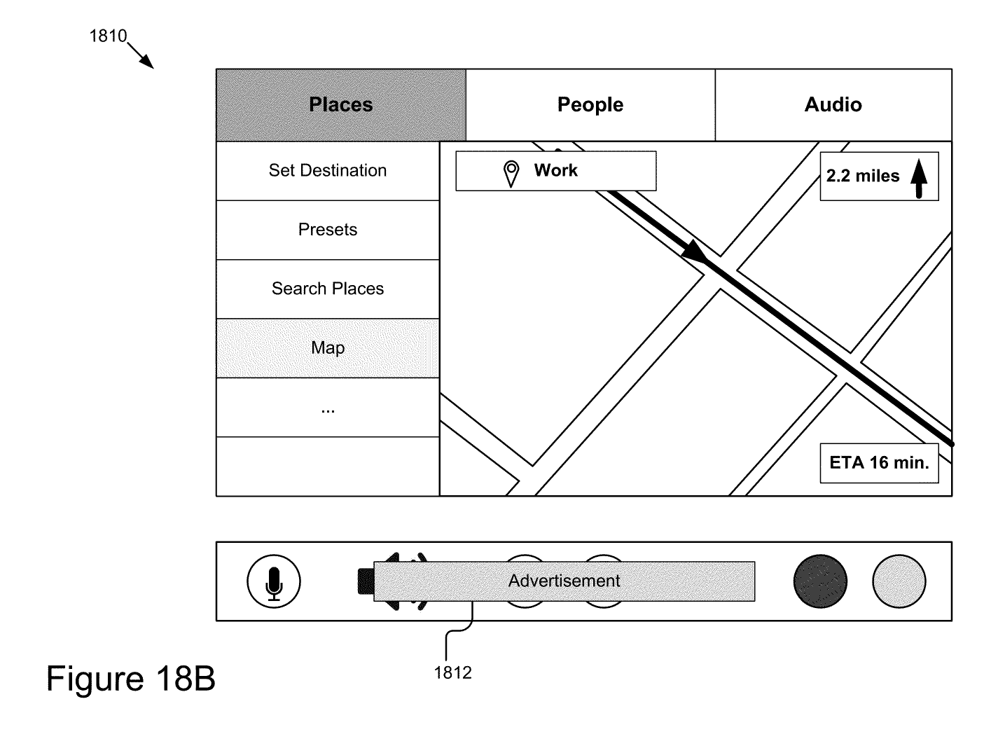

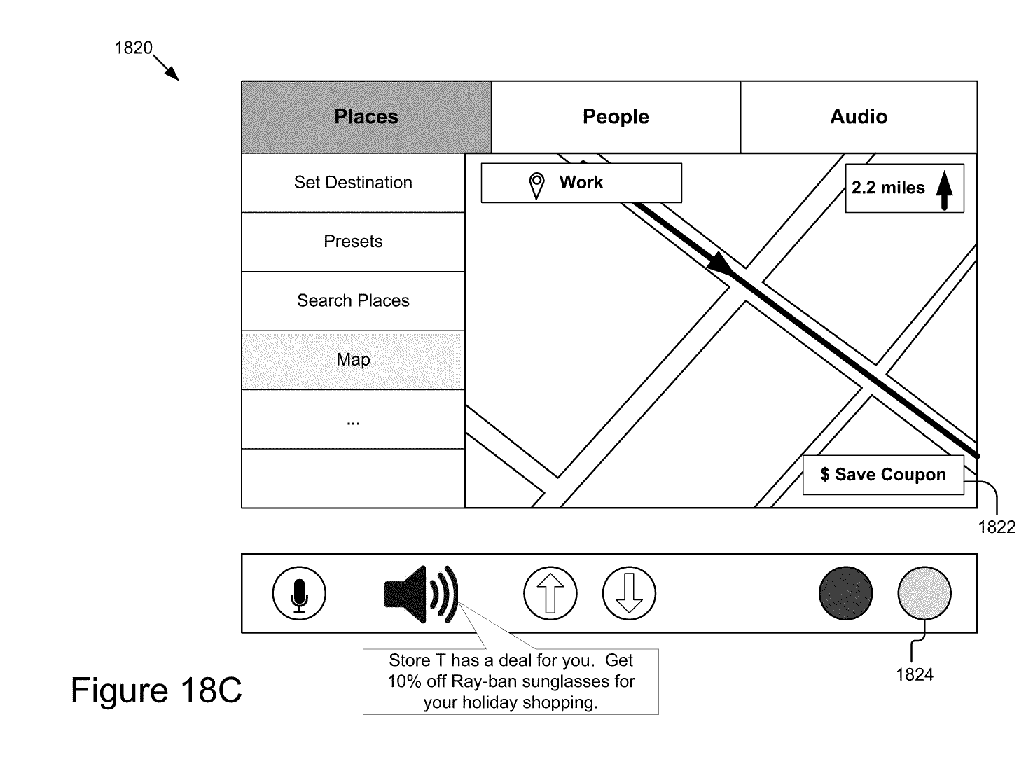

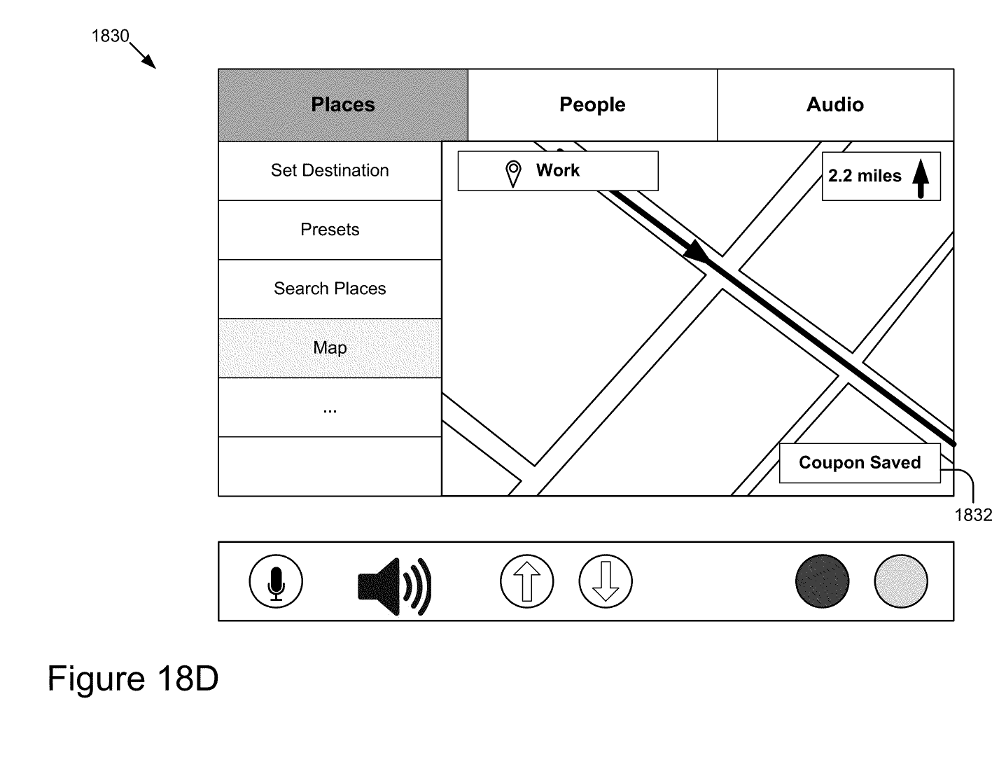

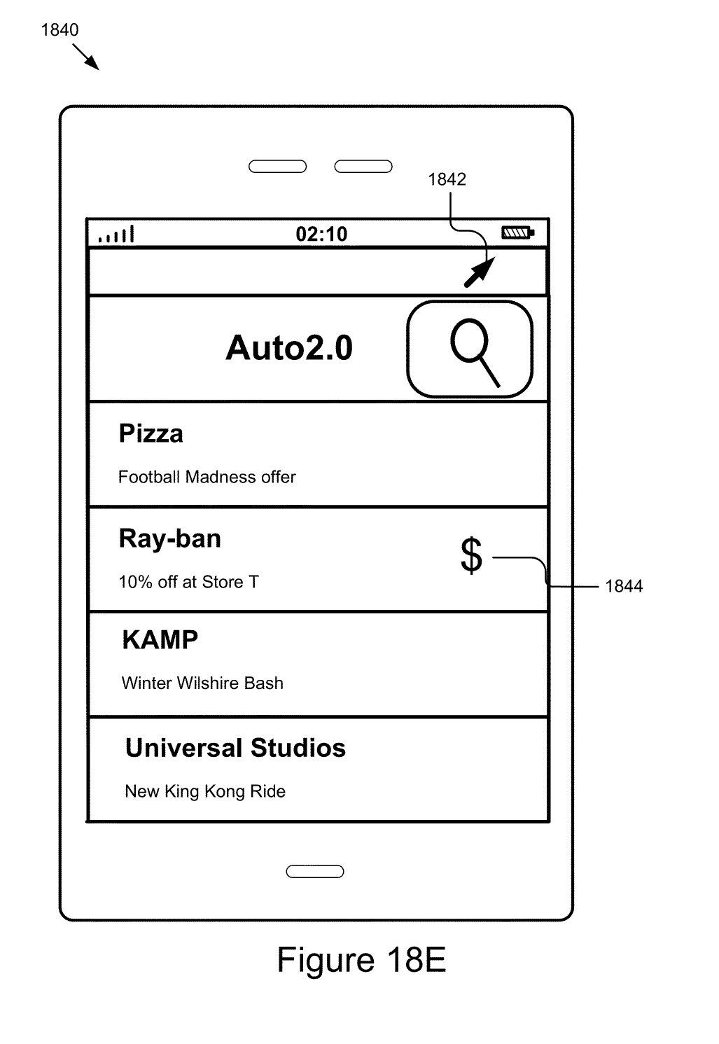

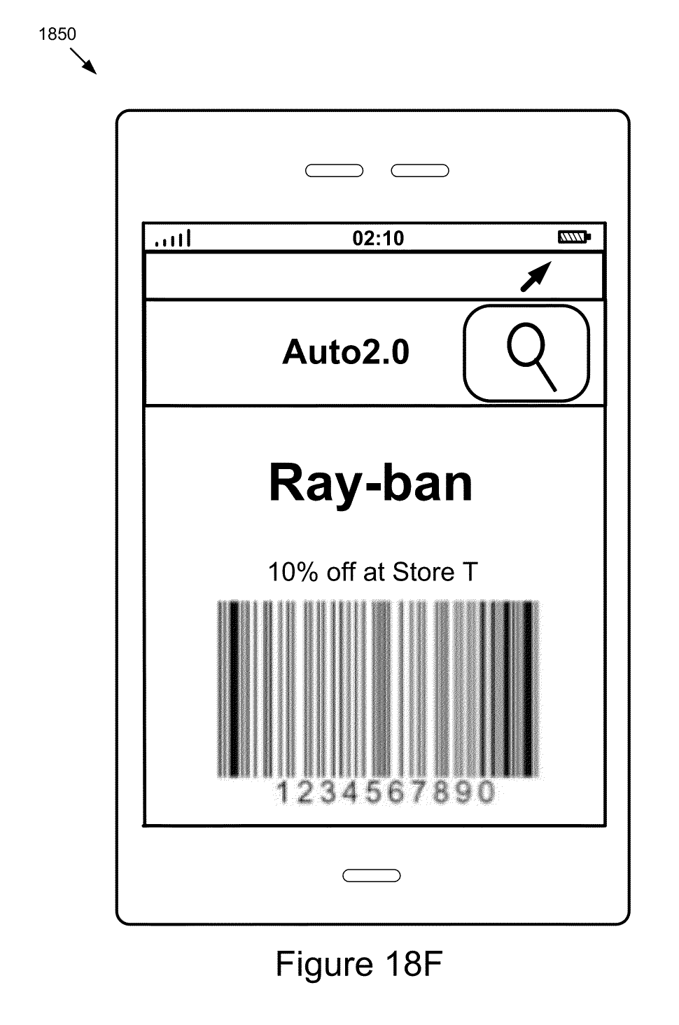

FIGS. 18A-18F are graphic representations 1800, 1810, 1820, 1830, 1840 and 1850 illustrating an example use case for providing a targeted coupon to a user. Referring to FIG. 18A, the navigation application 107a can estimate that a user is driving from home to work and display a map from home to work in a head unit of the user's vehicle. Meanwhile, the digital content application 107b can play music from Internet radio station using the infotainment system of the vehicle.

Referring to FIG. 18B, the ad manager 109 can instruct the digital content application 107b to present a message 1812 that an ad will play after the song is over. The ad manager 109 can determine an ad for the user based on user data associated with the user such as gender, age and other demographic information. For example, the ad manager 109 can determine an ad including a coupon for a store T since the user shopped at the store T five days ago, is in a demographic that frequents the store, etc.

Referring to FIG. 18C, the ad including a coupon for the store T can be played to the user using the speaker system 117. A message 1822 indicating an option to save the ad can be displayed in the head unit. The user can press a button 1824 to save the ad for later access. Referring to FIG. 18D, a message 1832 indicating the ad is saved can be displayed in the head unit for a particular period of time after the user saves the ad. A next song can be played to the user, and the user can continue to travel to work. The location of the vehicle keeps changing as the user travels to work.

At a later time, such as during a weekend, the user may travel to the store T to go shopping. Upon arrival at the store T, the user can use the client device 115 to access ads saved in the past. Referring to FIG. 18E, upon the user's access to the saved ads, the ad manager 109 can initially present a default list of saved ads to the user.

The client device 115 may be location aware and automatically determine the bookmarked ad(s) corresponding to the user's location (the store T). For instance, referring to FIG. 18F, the ad manager 109 can automatically identify the saved ad related to the store T based on the user's current location. The ad manager 109 can automatically present the saved ad to the user on the client device 115. A coupon such as a bar code, a QR code, etc., for availing the offer can automatically show up in the client device 115. The ad manager 109 can also automatically update the ad to include the latest coupons and/or deals related to the store T when presenting the ad to the user. The user can use the coupons included in the ad at the checkout of the store T.

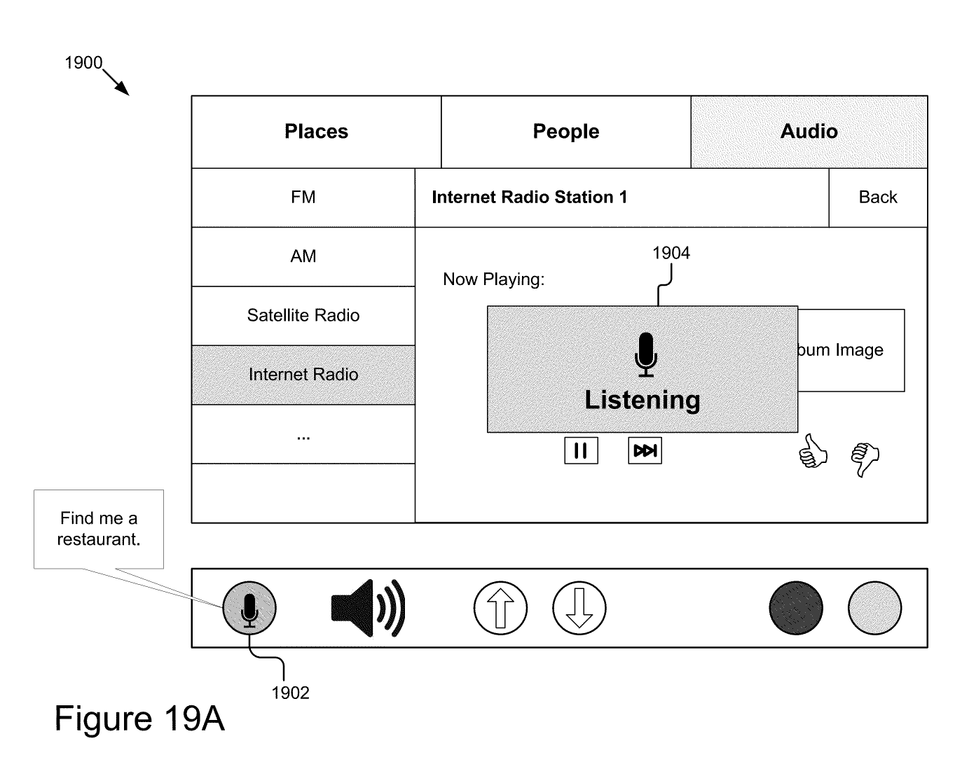

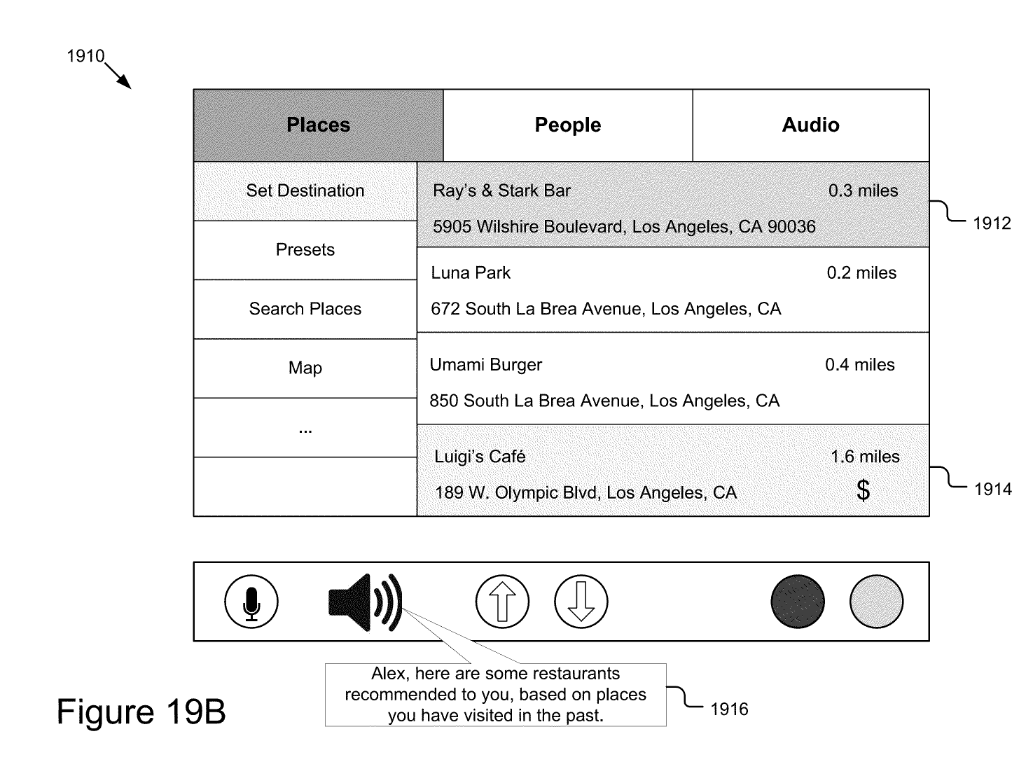

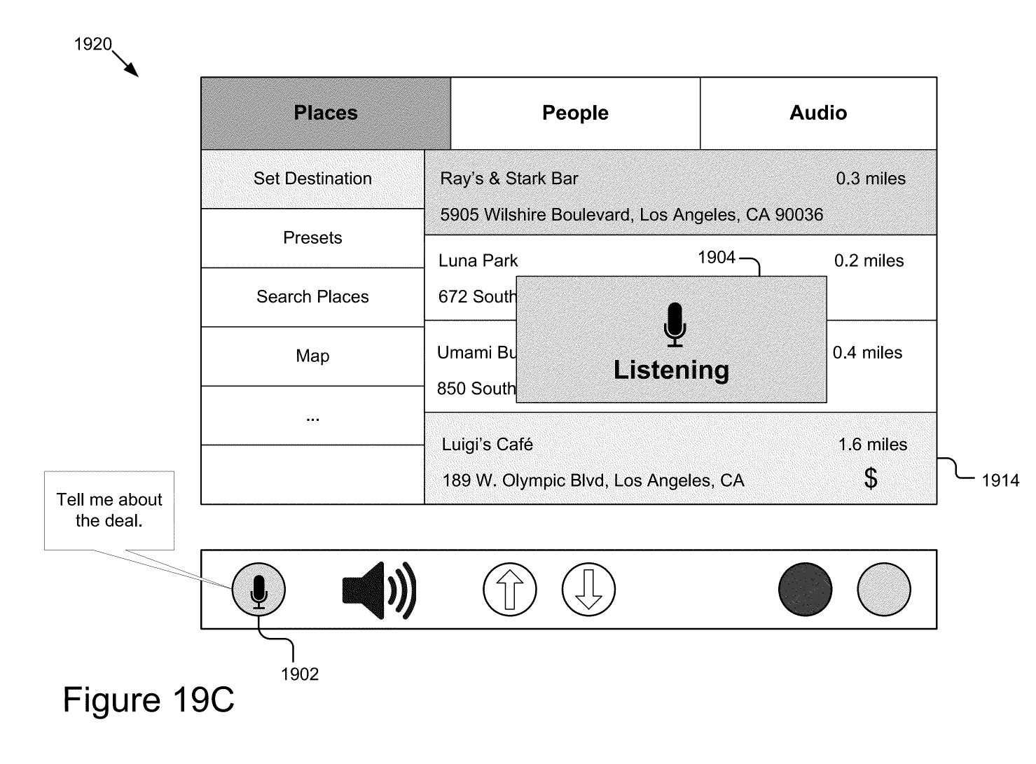

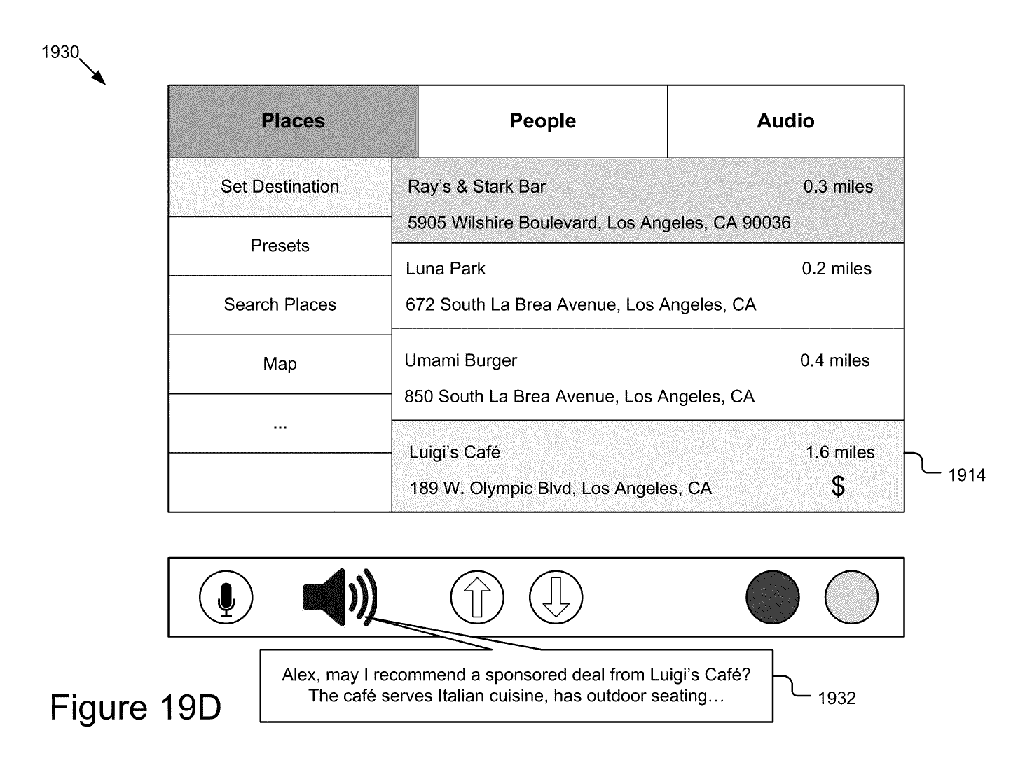

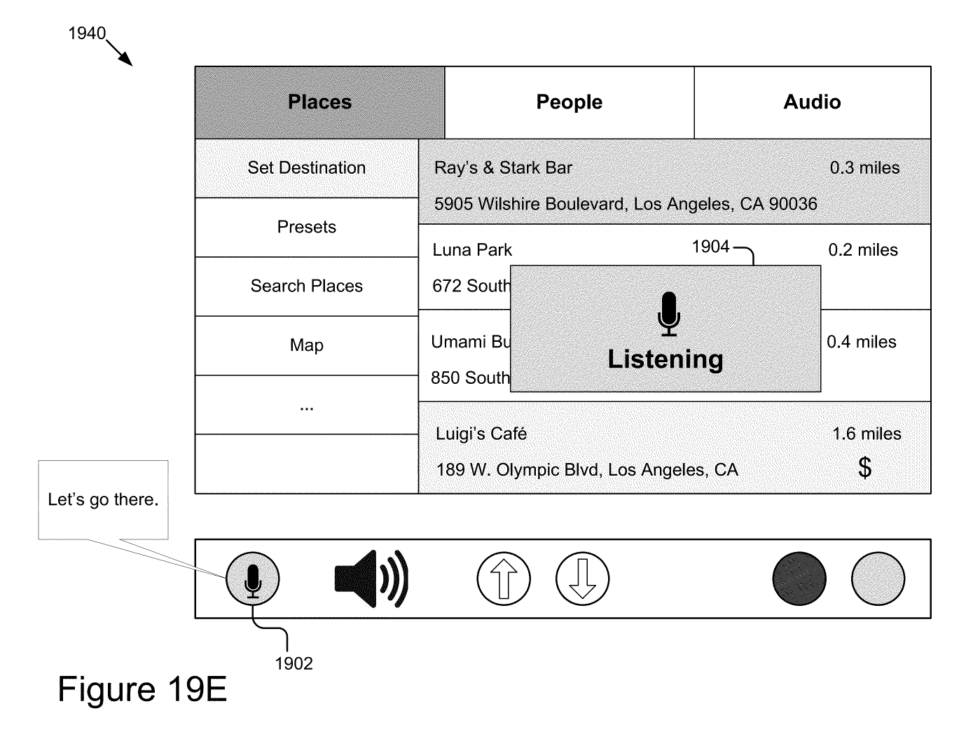

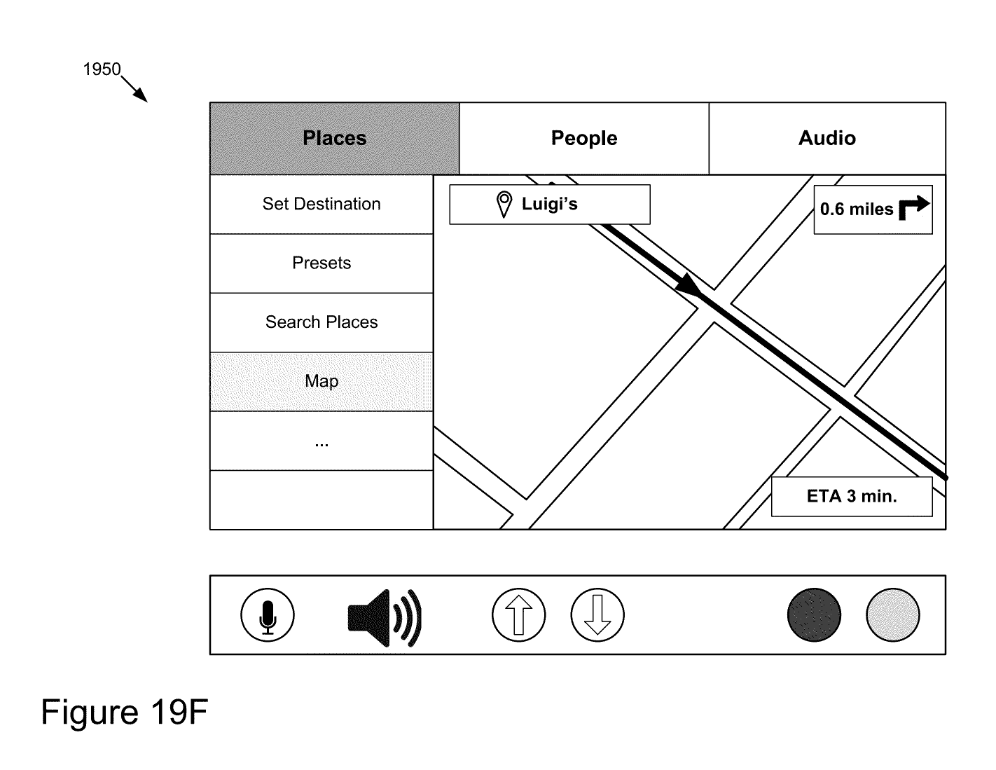

FIGS. 19A-19F are graphic representations 1900, 1910, 1920, 1930, 1940 and 1950 illustrating an example use case for performing an action associated with an ad. Referring to FIG. 19A, a user can press a button 1902 to issue a voice command. The voice recognition system 406 can present a “listening” animation 1904 on a head unit of the user's vehicle. The user can speak “find me a restaurant”. The “listening” animation 1904 may disappear when the user releases the button 1902 or ceases speaking

Referring to FIG. 19B, the voice recognition system 406 can instruct an application 107n such as a navigation application to search for restaurants near the user's location. The navigation application can generate a search result including a list of recommended restaurants. The list of recommended restaurants can be generated based on user data associated with the user (e.g., user behavior, user history, etc.). The navigation application can present the search result via a console display of the vehicle. A first item 1912 can be highlighted as an active selection in the list. A second item “Luigi's café” 1914 can be highlighted to represent a sponsored deal, as determined by the ad manger. The ad manager 109 can play an audio message 1916 to the user using the speaker system 117 in association with the sponsored deal (e.g., automatically, upon user request, etc.)

Referring to FIG. 19C, the user can press the button 1902 to issue a voice command. The voice recognition system 406 can present the “listening” animation 1904 on the console display. The user can speak “tell me about the deal”. The “listening” animation 1904 may disappear after the user releases the button 1902 or after the user stops speaking Referring to FIG. 19D, the ad manager 109 can instruct the digital content application 107b to play deal information 1932 about the deal 1914 to the user using the speaker system 117. After listening to the deal information 1932, the user can press the button 1902 to issue a voice command “let's go there” to navigate to the restaurant “Luigi's café” as illustrated in FIG. 19E. Turning to FIG. 19F, the ad manager 109 can instruct the navigation application 107a to provide navigation instructions to the restaurant “Luigi's café”.

In the above description, for purposes of explanation, numerous specific details are set forth in order to provide a thorough understanding of the specification. It will be apparent, however, to one skilled in the art that the disclosure can be practiced without these specific details. In other embodiments, structures and devices are shown in block diagram form in order to avoid obscuring the description. For example, the present embodiment is described in one embodiment below primarily with reference to user interfaces and particular hardware. However, the present embodiment applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment of the description. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present embodiment of the specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware embodiment, an entirely software embodiment or an embodiment containing both hardware and software elements. In a preferred embodiment, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A computer-implemented method comprising:
determining user data associated with a user;
determining contextual data associated with the user;
determining an interactive advertisement for presentation to the user in a vehicle based on the user data and the contextual data; and
presenting the interactive advertisement to the user in the vehicle.

2. The method of claim 1, wherein the contextual data includes trip data describing a trip taken by the user, and determining the interactive advertisement comprises:
identifying a place associated with the trip; and
identifying, based on the user data and the contextual data, the interactive advertisement associated with the place from an advertisement inventory.

3. The method of claim 1, wherein determining the interactive advertisement comprises:
identifying advertisement textual data based on the user data and the contextual data;
retrieving an advertisement synthesis template; and
creating the interactive advertisement based on the advertisement textual data and the advertisement synthesis template.

4. The method of claim 3, wherein the contextual data includes trip data describing a trip taken by the user, and identifying the advertisement textual data comprises:
identifying a place associated with the trip; and
identifying the advertisement textual data associated with the place based on the user data and the contextual data.

5. The method of claim 3, wherein the advertisement synthesis template includes an audio advertisement synthesis template or a visual advertisement synthesis template.

6. The method of claim 1, further comprising:
receiving a request requesting to bookmark the interactive advertisement; and
bookmarking the interactive advertisement for the user.

7. The method of claim 6, wherein bookmarking the interactive advertisement comprises:
retrieving advertisement content from a content buffer;
determining the interactive advertisement to be bookmarked from the advertisement content;
generating advertisement identification data that identifies the interactive advertisement;
associating the advertisement identification data with a user identifier identifying the user;
retrieving the interactive advertisement to be bookmarked from an advertisement inventory using the ad identification data; and
bookmarking the interactive advertisement by associating an identifier of the interactive advertisement with the user identifier.

8. The method of claim 6, wherein bookmarking the interactive advertisement comprises:
receiving sensor data from one or more sensors;
generating a timestamp based on the sensor data;
determining a location associated with the user based on the sensor data;
receiving tuner data from a radio tuner;
determining a radio station based on the tuner data and the location;
determining program data for the radio station, the program data describing a radio program matching the timestamp;
identifying the interactive advertisement associated with the program data;
associating the identified advertisement with a user identifier identifying the user; and
generating a bookmark that describes an association between the identified advertisement and the user identifier.

9. The method of claim 6, further comprising:
receiving a request requesting to retrieve the bookmarked advertisement; and
retrieving the bookmarked advertisement for the user.

10. The method of claim 9, wherein retrieving the bookmarked advertisement comprises:
generating an advertisement retrieval request;
querying an advertisement inventory using the advertisement retrieval request; and
retrieving the bookmarked advertisement that matches the advertisement retrieval request from the advertisement inventory.

11. The method of claim 1, further comprising:
receiving a request requesting to perform an action associated with the interactive advertisement; and
performing the action responsive to receiving the request.

12. A computer program product comprising a computer usable medium including a computer readable program, wherein the computer readable program when executed on a computer causes the computer to:
determine user data associated with a user;
determine contextual data associated with the user;
determine an interactive advertisement for presentation to the user in a vehicle based on the user data and the contextual data; and
present the interactive advertisement to the user in the vehicle.

13. The computer program product of claim 12, wherein the contextual data includes trip data describing a trip taken by the user, and determining the interactive advertisement comprises:
identifying a place associated with the trip; and
identifying, based on the user data and the contextual data, the interactive advertisement associated with the place from an advertisement inventory.

14. The computer program product of claim 12, wherein determining the interactive advertisement comprises:
identifying advertisement textual data based on the user data and the contextual data;
retrieving an advertisement synthesis template; and
creating the interactive advertisement based on the advertisement textual data and the advertisement synthesis template.

15. The computer program product of claim 14, wherein the contextual data includes trip data describing a trip taken by the user, and identifying the advertisement textual data comprises:
identifying a place associated with the trip; and
identifying the advertisement textual data associated with the place based on the user data and the contextual data.

16. The computer program product of claim 14, wherein the advertisement synthesis template includes an audio advertisement synthesis template or a visual advertisement synthesis template.

17. The computer program product of claim 12, wherein the computer readable program when executed on the computer causes the computer to also:
receive a request requesting to bookmark the interactive advertisement; and
bookmark the interactive advertisement for the user.

18. The computer program product of claim 17, wherein bookmarking the interactive advertisement comprises:
retrieving advertisement content from a content buffer;
determining the interactive advertisement to be bookmarked from the advertisement content;
generating advertisement identification data that identifies the interactive advertisement;
associating the advertisement identification data with a user identifier identifying the user;
retrieving the interactive advertisement to be bookmarked from an advertisement inventory using the ad identification data; and
bookmarking the interactive advertisement by associating an identifier of the interactive advertisement with the user identifier.

19. The computer program product of claim 17, wherein bookmarking the interactive advertisement comprises:
receiving sensor data from one or more sensors;
generating a timestamp based on the sensor data;
determining a location associated with the user based on the sensor data;
receiving tuner data from a radio tuner;
determining a radio station based on the tuner data and the location;
determining program data for the radio station, the program data describing a radio program matching the timestamp;
identifying the interactive advertisement associated with the program data;
associating the identified advertisement with a user identifier identifying the user; and
generating a bookmark that describes an association between the identified advertisement and the user identifier.

20. The computer program product of claim 17, wherein the computer readable program when executed on the computer causes the computer to also:
receive a request requesting to retrieve the bookmarked advertisement; and
retrieve the bookmarked advertisement for the user.

21. The computer program product of claim 20, wherein retrieving the bookmarked advertisement comprises:
generating an advertisement retrieval request;
querying an advertisement inventory using the advertisement retrieval request; and
retrieving the bookmarked advertisement that matches the advertisement retrieval request from the advertisement inventory.

22. The computer program product of claim 12, wherein the computer readable program when executed on the computer causes the computer to also:
receive a request requesting to perform an action associated with the interactive advertisement; and
perform the action responsive to receiving the request.

23. A system comprising:
a processor; and
a memory storing instructions that, when executed, cause the system to:
determine user data associated with a user;
determine contextual data associated with the user;
determine an interactive advertisement for presentation to the user in a vehicle based on the user data and the contextual data; and
present the interactive advertisement to the user in the vehicle.

24. The system of claim 23, wherein the contextual data includes trip data describing a trip taken by the user, and the instructions when executed cause the system to determine the interactive advertisement by:
identifying a place associated with the trip; and
identifying, based on the user data and the contextual data, the interactive advertisement associated with the place from an advertisement inventory.

25. The system of claim 23, wherein the instructions when executed cause the system to determine the interactive advertisement by:
identifying advertisement textual data based on the user data and the contextual data;
retrieving an advertisement synthesis template; and
creating the interactive advertisement based on the advertisement textual data and the advertisement synthesis template.

26. The system of claim 25, wherein the contextual data includes trip data describing a trip taken by the user, and the instructions when executed cause the system to identify the advertisement textual data by:
identifying a place associated with the trip; and
identifying the advertisement textual data associated with the place based on the user data and the contextual data.

27. The system of claim 25, wherein the advertisement synthesis template includes an audio advertisement synthesis template or a visual advertisement synthesis template.

28. The system of claim 23, wherein the instructions when executed cause the system to also:
receive a request requesting to bookmark the interactive advertisement; and
bookmark the interactive advertisement for the user.

29. The system of claim 28, wherein the instructions when executed cause the system to bookmark the interactive advertisement by:
retrieving advertisement content from a content buffer;
determining the interactive advertisement to be bookmarked from the advertisement content;
generating advertisement identification data that identifies the interactive advertisement;
associating the advertisement identification data with a user identifier identifying the user;
retrieving the interactive advertisement to be bookmarked from an advertisement inventory using the ad identification data; and
bookmarking the interactive advertisement by associating an identifier of the interactive advertisement with the user identifier.

30. The system of claim 28, wherein the instructions when executed cause the system to bookmark the interactive advertisement by:
receiving sensor data from one or more sensors;
generating a timestamp based on the sensor data;
determining a location associated with the user based on the sensor data;
receiving tuner data from a radio tuner;
determining a radio station based on the tuner data and the location;
determining program data for the radio station, the program data describing a radio program matching the timestamp;
identifying the interactive advertisement associated with the program data;
associating the identified advertisement with a user identifier identifying the user; and
generating a bookmark that describes an association between the identified advertisement and the user identifier.

31. The system of claim 28, wherein the instructions when executed cause the system to also:
receive a request requesting to retrieve the bookmarked advertisement; and
retrieve the bookmarked advertisement for the user.

32. The system of claim 31, wherein the instructions when executed cause the system to retrieve the bookmarked advertisement by:
generating an advertisement retrieval request;
querying an advertisement inventory using the advertisement retrieval request; and
retrieving the bookmarked advertisement that matches the advertisement retrieval request from the advertisement inventory.

33. The system of claim 23, wherein the instructions when executed cause the system to also:
receive a request requesting to perform an action associated with the interactive advertisement; and
perform the action responsive to receiving the request.
